(19) United States
(12) Patent Application Publication
(10) Pub. No.: US 2007/0167537 A1
(43) Pub. Date: Jul. 19, 2007

(54) Ink for ink jet, a method for produing ink for ink jet, ink set for ink jet, and ink jet recording method

(75) Inventors: Toshiki Taguchi, Shizuoka (JP); Naotaka Wachi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD., Kanagawa (JP)

(21) Appl. No.: 10/583,361

(22) PCT Filed: Dec. 16, 2004
(86) PCT No.: PCT/JP04/19278

§ 371 Date: Jun. 19, 2006

(30) Foreign Application Priority Data
Dec. 19, 2003 (JP) 2003-423135

(51) Int. Cl. C09D 11/00

(52) U.S. Cl. 523/160

(57) ABSTRACT

As an ink for ink jet, containing at least a water-soluble dye having an anionic dissociable group, water and a water-soluble organic solvent, an ink including a cationic polymer capable of forming an ion pair with the anionic dissociable group is used. The cationic polymer is a water-soluble polymer, and at least one of cations is preferably derived from a nitrogen atom, and it is preferable to mix the cationic polymer and the water-soluble dye having the anionic desociable group in advance in water and to prepare an ink after eliminating the resulting salt.

### TECHNICAL FIELD

The present invention relates to an ink for ink jet, an ink set for ink jet and an ink jet recording method, having an excellent image durability under a high humidity condition or in a condition wetted with water.

### BACKGROUND ART

Together with the recent pervasiveness of computers, ink jet printers are widely utilized for printing on a paper, a film, a cloth and the like not only in offices but also at homes.

In the ink jet recording method, there are known a method of applying a pressure by a piezoelectric element thereby discharging a liquid droplet, a method of generating a bubble by heat thereby discharging a liquid droplet, a method utilizing ultrasonic wave, and a method of discharging a liquid droplet by attraction with an electrostatic force. For such ink jet recording, there is employed an aqueous ink, an oily ink or a solid (fusible) ink. Among these, aqueous ink is used principally in consideration of manufacture, handling, smell, safety etc.

A colorant to be employed in such ink for ink jet is required to have a high solubility in a solvent, a high density in recording, a satisfactory hue, an excellent fastness to light, heat, air, water and chemicals, a satisfactory fixing property to an image receiving material without blotting, an excellent storability in a state of ink, no toxicity, a high purity, and inexpensive availability. It is however extremely difficult to find a colorant meeting these requirements at a high level. It is however extremely difficult to find a colorant meeting all these requirements at a satisfactory level. Various dyes and pigments have already been proposed for use in ink jet and are already used in practice, but in fact a colorant satisfying all these requirements have not been found. In already known dyes and pigments such as those represented by color index (C.I.) numbers, it is difficult to obtain a hue required for the ink for ink jet recording and a fastness at the same time. Dyes having a satisfactory hue and a fastness have been investigated and developed as a satisfactory colorant for ink jet recording. However, a water-soluble dye always has a water soluble substituent.

Such ink, when printed on paper and in case wetted with water alter the image formation, causes a blotting and spreading of dye.

Also, as a property of dyes, an insufficient resistance to ozone has been a problem.

### DISCLOSURE OF THE INVENTION

An object to be attained by the present invention is to provide an ink for ink jet, a method for producing an ink for ink jet, an ink set for ink jet, and an ink jet recording method, showing an excellent ozone resistance and not easily causing a blotting when wetted with water after a printing on a plain paper.

The objects of the present invention can be attained by an ink for ink jet, a method for producing an ink for ink jet, an ink set for ink jet, and an ink jet recording method described in following items (1)-(9):

(1) An ink for ink jet comprising: a water-soluble dye having an anionic dissociable group; at least one of water and a water-soluble organic solvent; and at least one kind of cationic polymer capable of forming an ion pair with the anionic dissociable group.

(2) An ink for ink jet as described in (2), wherein the cationic polymer is a water-soluble polymer.

(3) A method for producing an ink for ink jet, the method comprising: mixing in advance: a water-soluble dye having an anionic dissociable group; and at least one cationic polymer capable of forming an ion pair with the anionic dissociable group, in water, to form a resulting salt; and preparing the ink after desalting the resulting salt.

(4) An ink for ink jet as described in (1) or (2), wherein the ink is provided by: mixing in advance: said at least one kind of cationic polymer; and the water-soluble dye having the anionic dissociable group, in water, to form a resulting salt; and preparing the ink after desalting the resulting salt.

(5) An ink for ink jet as described in any one of (1), (2) and (4), wherein said at least one kind of cationic polymer has a cation derived from a nitrogen atom.

(6) An ink for ink jet as described in any one of (1), (2), (4) and (5), wherein the water-soluble dye comprises at least one of compounds represented by general formulas (1) to (4):
(A₁₁-N═N—B₁₁)ₙ-L general formula (1)

in the general formula (1), A₁₁ and B₁₁ each independently represents a heterocyclic group that may be substituted; n represents 1 or 2; L represents a substituent bonded in an arbitrary position with one of A₁₁ and B₁₁, and represents a hydrogen atom in case n=1, a single bond or a divalent connecting group in case n=2;

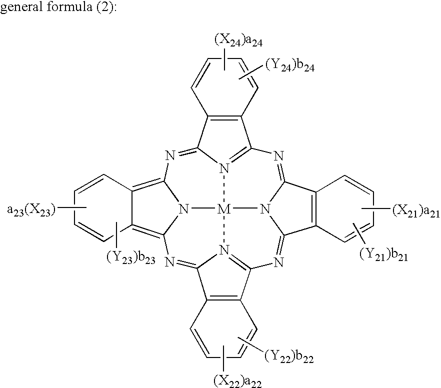

In the general formula (2), X₂₁, X₂₂, X₂₃ and X₂₄ each independently represents —SO-Z₂, —SO₂-Z₂, —SO₂NR₂₁R₂₂, a sulfo group, —CONR₂₁R₂₂, or —COOR₂₁; Z₂ each independently represents a substituted or non-substituted alkyl group, a substituted or non-substituted cycloalkyl group, a substituted or non-substituted alkenyl group, a substituted or non-substituted aralkyl group, a substituted or non-substituted aryl group or a substituted or non-substituted heterocyclic group; and R₂₁ and R₂₂ each independently represents a hydrogen atom, a substituted or non-substituted alkyl group, a substituted or non-substituted cycloalkyl group, a substituted or non-substituted alkenyl group, a substituted or non-substituted aralkyl group, a substituted or non-substituted aryl group or a substituted or non-substituted heterocyclic group;

Y₂₁, Y₂₂, Y₂₃ and Y₂₄ each independently represents a monovalent substituent;

a₂₁ to a₂₄ and b₂₁ to b₂₄ represent numbers of substituents respectively on X₂₁ to X₂₄ and Y₂₁ to Y₂₄; a₂₁ to a₂₄ each independently represents a number of 0 to 4, and at least one of a₂₁ to a₂₄ is not zero; b₂₁ to b₂₄ each independently represents a number of 0 to 4; and, in case any of a₂₁ to a₂₄ and b₂₁ to b₂₄ represents a number equal to or larger than 2, plural ones in X₂₁ to X₂₄ and Y₂₁ to Y₂₄ may be mutually same or different;

M represents a hydrogen atom, a metal atom, an oxide of the metal atom, a hydroxide of the metal atom, or a halide of the metal atom;

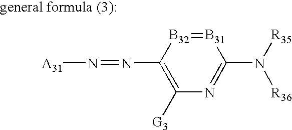

in the general formula (3), A₃₁ represents a 5-membered heterocyclic ring;

B₃₁ and B₃₂ each represents ═CR₃₁— or —CR₃₂═, or either one represents a nitrogen atom while the other one represents ═CR₃₁— or —CR₃₂═;

R₃₅ and R₃₆ each independently represents a hydrogen atom, an aliphatic group, an aromatic group, a heterocyclic group, an acyl group, an alkoxycarbonyl group, an aryloxycarbonyl group, a carbamoyl group, an alkyl- or arylsulfonyl group, or a sulfamoyl group, each of which may further have a substituent;

G₃, R₃₁ and R₃₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including an arylamino group and a heterocyclic amino group), an acylamino group, an ureido group, a sulfamoylamino group, an alkoxycarbonylamino group, an aryloxycarbonylamino group, an alkyl- or aryl sulfonylamino group, a heterocyclic sulfonylamino group, a nitro group, an alkyl- or arylthio group, an alkyl- or arylsulfonyl group, a heterocyclic sulfonyl group, an alkyl- or arylsulfinyl group, a heterocyclic sulfinyl group, a sulfamoyl group, a sulfo group or a heterocyclic thio group, each of which may be further substituted;

R₃₁ and R₃₅, or R₃₅ and R₃₆ may be bonded to form a 5- or 6-membered ring; and
A₄₁-N═N—B₄₁—N═N—C₄₁ general formula (4)

in the general formula (4), A₄₁, B₄₁ and C₄₁ each independently represents an aromatic group or a heterocyclic group, each of which may be further substituted.
(7) An ink for ink jet as described in any one of (1), (2), (4), (5) and (6), wherein the dye represented by the general formula (2) is a dye represented by general formula (5):

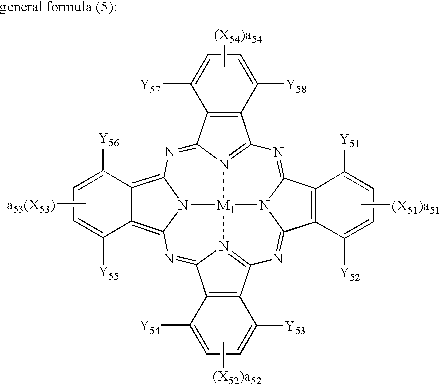

in the general formula (5), X₅₁ to X₅₄, Y₅₁ to Y₅₈ and M₁ respectively have same meanings as X₂₁ to X₂₄, Y₂₁ to Y₂₄ and M in the general formula (2); and a₄₁ to a₅₄ each independently represents an integer 1 or 2.

(8) An ink set for ink jet comprising an ink as described in any one of (1), (2), (4), (5), (6) and (7).

(9) An ink jet recording method comprising executing an image recording on one of a plain paper and an ink jet exclusive paper with an ink jet printer by using at least one of: an ink as described in any one of (1), (2), (4), (5), (6) and (7); and an ink set for ink jet according as described in (8).

### BEST MODE FOR CARRYING OUT THE INVENTION

In the following, the present invention will be explained in detail.

The ink for ink jet of the invention is characterized in utilizing an anionic dye, having an anionic dissociable group, as a colorant and simultaneously containing a polymer compound including, within its molecule, a cation capable of forming an ion pair therewith.

The cationic group can be, for example, a group containing a protonated aminic nitrogen atom, a group having a protonated site such as guanidine or amidine, a protonated group of a 6-membered heterocycle aromatic compound such as pyridine, pyradine, quinoline, isoquinoline, pyrimidine or pyridazine, or a group having an onium salt such as an ammonium salt, an amidinium salt, a guanidium salt, a phophonium salt, an oxonium salt or a thiuronium salt.

Among these, it is preferably a group containing a cation derived from a nitrogen atom, such as a group containing a protonated aminic nitrogen atom, guanidine, amidine, an ammonium salt, an amidinium salt, a guanidium salt, or a protonated group of a 6-membered heteroaromatic cycle compound.

The ink of the invention employs the polymer compound having these groups together with a dye. The polymer compound employed in the invention can be used in a state of a water-soluble polymer or a water-dispersed polymer (polymer latex), but is preferably a water-soluble polymer.

The cationic group may be contained in such a form as to constitute a main chain relative to a monomer unit of the polymer, or as a substituent (so-called pendant group). The polymer of the invention may be a polymer formed by polymerization singly of a monomer unit containing a cationic group (homopolymer) or a copolymer with another functional group. In case of a copolymer, it can be a random copolymer or a block copolymer.

In the following, preferred examples of cationic group site in the polymer to be employed in the invention will be given in the following.

A structural site of an organic molecule that can constitute a cation can be an aminic nitrogen atom or a heteroaromatic ring containing the same. As the heteroaromatic ring, there can be employed pyridine, pyrazole or an imidazole ring having a basic property.

As a cationic polymer compound, there is advantageously employed a polymer compound having a primary-tertiary amino group or a quaternary ammonium salt group as a cationic group, but other cationic polymer compounds can also be employed.

Such polymer compound is preferably obtained from a monomer (polymer-compound monomer) having a primary to tertiary amino group or a salt thereof, or a quaternary ammonium salt group, or as a copolymer or a polycondensate of such monomer with another monomer (hereinafter called “another polymer-compound monomer”. Such polymer can be employed in a form of a water-soluble polymer or water-dispersible latex particles.

Examples of the monomer (polymer-compound monomer) includes:
trimethyl-p-vinylbenzylammonium chloride,
trimethyl-m-vinylbenzylammonium chloride,
triethyl-p-vinylbenzylammonium chloride,
triethyl-m-vinylbenzylammonium chloride,
N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride;
trimethyl-p-vinylbenzylammonium bromide,
trimethyl-m-vinylbenzylammonium bromide,
trimethyl-p-vinylbenzylammonium sulfonate,
trimethyl-m-vinylbenzylammonium sulfonate,
trimethyl-p-vinylbenzylammonium acetate,
trimethyl-m-vinylbenzylammonium acetate,
N,N,N-triethyl-N-2-(4-vinylphenyl)ethylammonium chloride,
N,N,N-triethyl-N-2-(3-vinylphenyl)ethylammonium chloride,
N,N-diethyl-N-methyl-N-2-(4-vinylphenyl)ethylammonium chloride,
N,N-diethyl-N-methyl-N-2-(4-vinylphenyl)ethylammonium acetate;
a quaternary compound formed by
N,N-dimethylaminoethyl(meth)acrylate,
N,N-diethylaminoethyl(meth)acrylate,
N,N-dimethylaminopropyl(meth)acrylate,
N,N-diethylaminopropyl(meth)acrylate,
N,N-dimethylaminoethyl(meth)acrylamide,
N,N-diethylaminoethyl(meth)acrylamide,
N,N-dimethylaminopropyl(meth)acrylamide, or
N,N-diethylaminopropyl(meth)acrylamide, with methyl chloride, ethyl chloride, methyl bromide, ethyl bromide, methyl iodide or ethyl iodide, and a sulfonate salt, an alkylsulfonate salt, an acetate salt or an alkylcarboxylate salt formed by substituting an anion thereof.

Specific examples include:
monomethyldiallylammonium chloride,
trimethyl-2-(methacryloyloxy)ethylammonium chloride,
triethyl-2-(methacryloyloxy)ethylammonium chloride,
trimethyl-2-(acryloyloxy)ethylammonium chloride,
triethyl-2-(acryloyloxy)ethylammonium chloride,
trimethyl-3-(methacryloyloxy)propylammonium chloride,
triethyl-3-(methacryloyloxy)propylammonium chloride,
trimethyl-2-(methacryloylamino)ethylammonium chloride,
triethyl-2-(methacryloylamino)ethylammonium chloride,
trimethyl-2-(acryloylamino)ethylammonium chloride,
triethyl-2-(acryloylamino)ethylammonium chloride,
trimethyl-3-(methacryloylamino)propylammonium chloride,
triethyl-3-(methacryloylamino)propylammonium chloride,
trimethyl-3-(acryloylamino)propylammonium chloride,
triethyl-3-(acryloylamino)propylammonium chloride,
N,N-dimethyl-N-ethyl-2-(methacryloyloxy)ethylammonium chloride,
N,N-diethyl-N-methyl-2-(methacryloyloxy)ethylammonium chloride,
N,N-dimethyl-N-ethyl-3-(acryloylamino)propylammonium chloride,
trimethyl-2-(methacryloyloxy)ethylammonium bromide,
trimethyl-3-(acryloylamino)propylammonium bromide,
trimethyl-2-(methacryloyloxy)ethylammonium sulfonate, and
trimethyl-3-(acryloyloxy)propylammonium acetate.

Other copolymerizable monomers include N-vinylimidazole, and N-vinyl-2-methylimidazole.

There can also be utilized allylamine, diallylamine, a derivative or a salt thereof. Examples of such compound include allylamine, allylamine hydrochlorate salt, allylamine acetate salt, allylamine sulfate salt, diallylamine, diallylamine hydrochlorate salt, diallylamine acetate salt, diallylamine sulfate salt, diallylmethylamine and a salt thereof (such as hydrochlorate salt, acetate salt, or sulfate salt), diallylethylamine and a salt thereof (such as hydrochlorate salt, acetate salt, or sulfate salt), and diallyldimethylammonium salt (counter ion being chloride, acetate ion or sulfate ion). Such derivatives of allylamine or diallylamine, showing inferior polymerizing property in an amine state, is generally polymerized in a salt state and is desalted if necessary.

There can also be utilized a vinylamine unit formed by polymerizing a unit of N-vinylacetamide or N-vinylformamide followed by a hydrolysis, or a salt of such unit.

The aforementioned another polymer-compound monomer means a monomer not including a basic or cationic portion such as a primary to tertiary amino group, a salt thereof, or a quaternary ammonium salt group and free from or substantially free from an interaction with the dye in the ink for ink jet recording.

Examples of such another polymer-compound monomer include a (meth)acrylate allyl ester; a (meth)acrylate cycloalkyl ester such as cyclohexyl(meth)acrylate; a (meth)acrylate aryl ester such as phenyl (meth)acrylate; an aralkyl ester such as benzyl(meth)acrylate; an aromatic vinyl compound such as styrene, vinyltoluene, or α-methylstyrene; a vinyl ester such as vinyl acetate, vinyl propionate, or vinyl versatate; an allyl ester such as allyl acetate; a halogen-containing monomer such as vinylidene chloride or vinyl chloride; a vinyl cyanide such as (meth)acrylonitrile; and an olefin such as ethylene or propylene.

The (meth)acrylate alkyl ester is preferably a (meth)acrylate alkyl ester with 1 to 18 carbon atoms in an alkyl portion, such as methyl(meth)acrylate, ethyl(meth)acrylate, propyl(meth)acrylate, isopropyl (meth)acrylate, n-butyl(meth)acrylate, isobutyl(meth)acrylate, t-butyl(meth)acrylate, hexyl(meth)acrylate, octyl(meth)acrylate, 2-ethylhexyl(meth)acrylate, lauryl(meth)acrylate, or stearyl(meth)acrylate.

Among these, methyl acrylate, ethyl acrylate, methyl methacrylate, ethyl methacrylate and hydroxyethyl methacrylate are preferred.

Also such another polymer-compound monomer can be employed singly or in a combination of two or more kinds.

Furthermore, preferred examples of the polymer mordant include polydiallyldimethylammonium chloride, polymethacryloyloxyethyl-β-hydroxyethyldimethylammonium chloride, polyethylenimine, polyallylamine and derivatives thereof, polyamide-polyamine resin, cationized starch, dicyandiamide-formalin condensate, dimethyl-2-hydroxypropylammonium salt polymer, polyamidine, polyvinylamine, a dicyan cationic resin represented by dicyandiamide-formalin polycondensate, a polyamine cationic resin represented by dicyanamide-diethyltriamine polycondensate, an epichlorohydrin-dimethylamine addition polymer, a dimethyldiallylammonium chloride-SO₂ copolymer, a diallylamine salt-SO₂ copolymer, a (meth)acrylate-containing polymer having an alkyl group substituted with a quaternary ammonium salt group in an ester portion, and a styryl polymer having an alkyl group substituted with a quaternary ammonium salt group.

Specific examples of the polymer compound are described for example in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236, U.S. Pat. Nos. 2,484,430, 2,548,564, 3,148,061, 3,309,690, and 4,115,124, 4,124,386, 4,193,800, 4,273,853, 4,282,305, and 4,450,224, JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314, JP-B Nos. 5-35162, 5-35163, 5-36164, and 5-88846, JP-A Nos. 7-118333 and 2000-344990, and Japanese Patents Nos. 2648847 and 2661677. Among these, polyallylamine and derivatives thereof are particularly preferred.

As polyallylamine or a derivative to be employed in the invention can be various known allylamine polymers and derivatives thereof. Such derivatives include a salt of polyallylamine and an acid (acid can be an inorganic acid such as hydrochloric acid, sulfuric acid, phosphoric acid or nitric acid, an organic acid such as methanesulfonic acid, toluenesulfonic acid, acetic acid, propionic acid, cinnamic acid or (meth)acrylic acid, or a combination thereof, or a salt formed only in a part of polyallylamine), a derivative formed by a polymer reaction of polyallylamine, and a copolymer of polyallylamine and another copolymerizable monomer (such monomer can for example be a (meth)acrylate ester, a styrene, a (meth)acrylamide, acrylonitrile or a vinyl ester).

Specific examples of polyallylamine and derivatives thereof include compounds described in JP-B Nos. 62-31722, 2-14364, 63-43402, 63-43403, 63-45721, 63-29881, 1-26362, 2-56365, 2-57084, 4-41686, 6-2780, 6-45649, 6-15592, and 4-68622, Japanese Patents Nos. 3199227 and 3008369, JP-A Nos. 10-330427, 11-21321, 2000-281728, 2001-106736, 62-256801, 7-173286, 7-213897, 9-235318, 9-302026, and 11-21321, WO Nos. 99/21901 and 99/19372, JP-A No. 5-140213 and JP-T No. 11-506488.

In case of forming an ion pair of a dye and a polymer in the present invention, the formed ion pair is preferably water soluble. In case it precipitates, an ink solvent can be so selected that it becomes soluble by an addition of such ink solvent.

In the following, there will be given an explanation on a dye to be employed in the present invention, including those represented by the general formulas (1) to (4).

The dye to be employed in the present invention preferably has an oxidation potential more precious (higher) than 1.0 V (more preferably higher than 1.1 V and particularly preferably higher than 1.15 V), and an oxidation potential of the dye higher than 1.0 V allows to obtain an image excellent in an image durability, particularly in an ozone resistance.

The oxidation potential (E_{OX}) can be easily measured by those skilled in the art. Method of such measurement is described for example by P. Delahay, “New Instrumental Methods in Electrochemistry” (Interscience Pulishers, 1954), A. J. Bard et al., “Electrochemical Methods” (John Wiley & Sons, 1980), and Akira Fujishima et al., “Denki Kagaku Sokuteiho”, (Gihodo-Shuppansha, 1984).

More specifically, the oxidation potential is measured by dissolving a measured sample by 1×10⁻² to 1×10⁻⁶ mol/liter in a solvent such as dimethylformamide or acetonitrile and by cyclic voltammetry as a value to SCE (saturated calomel electrode). This value may be deviated by about several tens of millivolts by the influence of a liquid-to-liquid potential difference or a liquid resistance of sample solution, but the reproducibility of the potential can be ensured by employing a standard sample (for example hydroquinone). For defining the potential uniquely, the present invention defines the oxidation potential of a dye by a measured value (vs. SCE) in dimethylformamide (with a dye concentration of 0.001 mol/liter) containing tetrapropylammonium perchlorate as the supporting electrolyte at 0.1 mol/liter. In case a water-soluble dye is difficult to dissolve directly in N,N-dimethylformamide, the dye is dissolved in water of an amount as little as possible, and the measurement is executed by so diluting the solution with N,N-dimethylformamide as to obtain a water content of 2% or less.

The oxidation potential (E_{OX}) indicates ease of electron transfer from the sample to the electrode, and a larger value (more precious oxidation potential) means that the electron is more difficult to transfer from the sample to the electrode, or the sample is less likely to be oxidized. In relation to the structure of the compound, the oxidation potential becomes higher by the introduction of an electron attracting group, or lower by the introduction of an electron donating group.

The dye having the aforementioned characteristics includes an azo dye (yellow dye, magenta dye, black dye), and a phthalocyanine dye (cyan dye) of specified property or structure. Each dye will be explained in the following.

[Yellow Dye]

A yellow dye to be employed in the invention, in consideration of fastness and fastness to ozone gas, preferably has an oxidation potential higher than 1.0 V (vs. SCE), more preferably higher than 1.1 V (vs. SCE) and particularly preferably higher than 1.15 V (vs. SCE). As a type of the dye, an azo dye satisfying the aforementioned conditions is particularly preferred.

The dye to be employed in the present invention is preferably satisfactory in fastness and in color hue, and particularly preferably has a satisfactory cut-off of the absorption spectrum at the longer wavelength side. For this reason, a yellow dye preferably has λₘₐₓ from 390 to 470 nm, and has I(λₘₐₓ+70 nm)/I(λₘₐₓ), namely a ratio of absorbance I(λₘₐₓ+70 nm) at a wavelength of λₘₐₓ+70 nm to absorbance I(λₘₐₓ) at a wavelength of λₘₐₓ, of 0.20 or less, more preferably 0.15 or less and further preferably 0.10 or less. The absorption wavelength and the absorbance defined herein are values obtained in a solvent (water or ethyl acetate).

As a dye satisfying such oxidation potential and absorption characteristics, there is preferred a dye represented by a following general formula (1):
(A₁₁-N═N—B₁₁)ₙ-L general formula (1)

In the formula, A₁₁ and B₁₁ each independently represents a heterocyclic group that may be substituted.

Such heterocycle is preferably a 5- or 6-membered heterocycle, may have a single ring structure or a poly-ring structure in which two or more rings are condensed, and may be an aromatic or non-aromatic heterocycle. A hetero atom constituting the heterocycle is preferably an N, O or S atom. n represents an integer selected from 1 and 2, preferably 2. L represents a substituent, bonded at an arbitrary position to A₁₁ or B₁₁, and, in case n is 1, L represents a hydrogen atom or a monovalent substituent and, in case n is 2, L represents a mere single bond or a divalent connecting group.

In the foregoing general formula (1), the heterocycle represented by A₁₁ is preferably 5-pyrazolone, pyrazole, triazole, oxazolone, isooxazolone, barbituric acid, pyridone, pyridine, rhodanine, pyrazolidinedion; pyrazolopyridone, Meldrum's acid or condensed heterocycles in which such heterocycle is condensed with an aromatic hydrocarbon ring or a heterocycle. Among these, 5-pyrazolone, 5-aminopyrazole, pyridone, 2,6-diaminopyridine or pirazoloazole is preferable, and 5-aminopyrazole, 2-hydroxy-6-pyridone, or pyrazolotriazole is particularly preferable.

The heterocycle represented by B₁₁ can be pyridine, pyradine, pyrimidine, pyridazine, triazine, quinoline, isoquinoline, quinazoline, cinnoline, phthalazine, quinoxaline, pyrole, indole, furan, benzofuran, thiophene, benzothiophene, pirazole, imidazole, benzimidazole, triazole, oxazole, isoxazole, benzoxazole, thiazole, benzothiazole, isothiazole, benzisothiazole, thiadiazole, benzisoxazole, pyrrolidine, piperidine, piperadine, imidazolidine, or thiazoline. Among these, preferred is pyridine, quinoline, thiophene, benzothiophene, pirazole, imidazole, benzimidazole, triazole, oxazole, isoxazole, benzoxazole, thiazole, benzothiazole, isothiazole, benzisothiazole, thiadiazole, or benzisoxazole, and more preferably quinoline, thiophene, pirazole, thiazole, benzoxazole, benzisoxazole, isothiazole, imidazole, benzothiazole, or thiadiazole, and particularly preferably pirazole, benzothiazole, benzoxale, imidazole, 1,2,4-thiadiazole or 1,3,4-thiadiazole.

Examples of a substituent on A₁₁ and B₁₁ include a halogen atom, an alkyl group, a cycloalkyl group, an aralkyl group, an alkenyl group, an alkinyl group, an aryl group, a heterocyclic group, a cyano group, a hydroxy group, a nitro group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, an alkyl- or aryl-sulfinyl group, an alkyl- or aryl-sulfonyl group, an acyl group, an aryloxycarbonyl group, an alkoxycarbonyl group, a carbamoyl group, an imido group, a phosphino group, a phosphinyl group, a phosphinyloxy group, a phosphinylamino group, a silyl group and a following ionic hydrophilic group.

A monovalent substituent represented by L can be the aforementioned substituent on A₁₁ and B₁₁ or the following ionic hydrophilic group. Also a divalent connecting group represented by L is an alkylene group, an arylene group, a heterocyclic residue, —CO—, —SOₙ— (n being 0, 1 or 2), —NR— (R representing a hydrogen atom, an alkyl group or an aryl group), —O—, or a divalent group formed by combining these connecting groups, and such group may further have a substituent same as those for A₁₁ and B₁₁ or a following ionic hydrophilic group.

The dye of the general formula (1), in case of being employed as a water-soluble dye, preferably has an ionic hydrophilic group within the molecule. Examples of the ionic hydrophilic group include a sulfo group, a carboxyl group, a phosphono group and a quaternary ammonium group. The ionic hydrophilic group is preferably a carboxyl group, a phosphono group or a sulfo group, particularly a carboxyl group or a sulfo group. In particular, it is most preferable that at least one is a carboxyl group. The carboxyl group, phosphono group or sulfo group may be in a state of a salt, and a counter ion forming the salt can be, for example ammonium ion, an alkali metal ion (such as lithium ion, sodium ion, or potassium ion), or an organic cation (such as tetramethyl ammonium ion, tetramethyl guanidium ion, or tetramethyl phosphonium ion), among which most preferred is an alkali metal ion.

Among the dyes represented by the general formula (1), there is preferred a dye in which a portion A₁₁-N═N—B₁₁ corresponds to a general formula (1-A), (1-B) or (1-C).

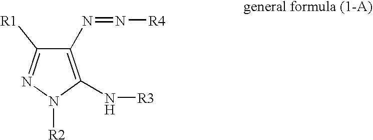

In the general formula (1-A), R1 and R3 each represents a hydrogen atom, a cyano group, an alkyl group, a cycloalkyl group, an aralkyl group, an alkoxy group, an alkylthio group, an arylthio group, an aryl group or an ionic hydrophilic group; R2 represents a hydrogen atom, an alkyl group, a cycloalkyl group, an aralkyl group, a carbamoyl group, an acyl group, an aryl group or a heterocyclic group; and R4 represents a heterocyclic group.

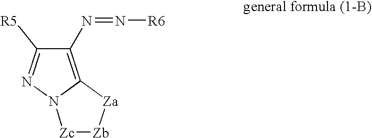

In the general formula (1-B), R5 represents a hydrogen atom, a cyano group, an alkyl group, a cycloalkyl group, an aralkyl group, an alkoxy group, an alkylthio group, an arylthio group, an aryl group or an ionic hydrophilic group; Za represents —N═, —NH—, or —C(R11)=; Zb and Zc each independently represents —N═ or —C(R11)=; R11 represents a hydrogen atom or a non-metal substituent; and R6 represents a heterocyclic group.

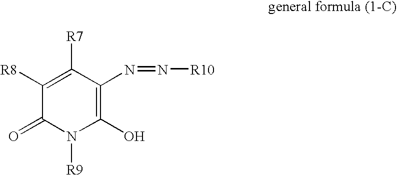

In the general formula (1-C), R7 and R9 each independently represents a hydrogen atom, a cyano group, an alkyl group, a cycloalkyl group, an aralkyl group, an aryl group, an alkylthio group, an arylthio group, an alkoxycarbonyl group, a carbamoyl group or an ionic hydrophilic group; R8 represents a hydrogen atom, a halogen atom, an alkyl group, an alkoxy group, an aryl group, an aryloxy group, a cyano group, an acylamino group, a sulfonylamino group, an alkoxycarbonylamino group, an ureido group, an alkylthio group, an arylthio group, an alkoxycarbonyl group, a carbamoyl group, a sulfamoyl group, a sulfonyl group, an acyl group, an alkylamino group, an arylamino group, a hydroxy group or an ionic hydrophilic group; and R10 represents a heterocyclic group.

In the general formulas (1-A), (1-B) and (1-C), the alkyl group represented by R1, R2, R3, R5, R7, R8 and R9 can be an alkyl group having a substituent or a non-substituted alkyl group. Such alkyl group is preferably an alkyl group with 1 to 20 carbon atoms. Examples of such substituent include a hydroxyl group, an alkoxy group, a cyano group, a halogen atom and an ionic hydrophilic group. Examples of the aforementioned alkyl group include methyl, ethyl, butyl, isopropyl, t-butyl, hydroxyethyl, methoxyethyl, cyanoethyl, trifluoromethyl, 3-sulfopropyl and 4-sulfobutyl.

The cycloalkyl group represented by R1, R2, R3, R5, R7, R8 and R9 can be a cycloalkyl group having a substituent and a non-substituted cycloalkyl group. Such cycloalkyl group is preferably a cycloalkyl group with 5 to 12 carbon atoms. Examples of such substituent include an ionic hydrophilic group. Examples of the cycloalkyl group include a cyclohexyl group. The aralkyl group represented by R1, R2, R3, R5, R7, R8 and R9 can be an aralkyl group having a substituent or a non-substituted aralkyl group. Such aralkyl group is preferably an aralkyl group with 7 to 20 carbon atoms. Examples of such substituent include an ionic hydrophilic group. Examples of the aralkyl group include benzyl and 2-phenethyl.

The aryl group represented by R1, R2, R3, R5, R7, R8 and R9 can be an aryl group having a substituent or a non-substituted aryl group. Such aryl group is preferably an aryl group with 6 to 20 carbon atoms. Examples of such substituent include a hydroxy group, an alkyl group, an alkoxy group, a halogen atom, a cyano group, a carbamoyl group, a sulfamoyl group, an alkylamino group, an acylamino group and an ionic hydrophilic group. Examples of the aryl group include phenyl, p-tolyl, p-methoxyphenyl, o-chlorophenyl and m-(3-sulfopropylamino)phenyl.

The alkylthio group represented by R1, R2, R3, R5, R7, R8 and R9 can be an alkylthio group having a substituent or a non-substituted alkylthio group. Such alkylthio group is preferably an alkylthio group with 1 to 20 carbon atoms. Examples of such substituent include an ionic hydrophilic group. Examples of the alkylthio group include methylthio and ethylthio. The arylthio group represented by R1, R2, R3, R5, R7, R8 and R9 can be an arylthio group having a substituent and a non-substituted arylthio group. Such arylthio group is preferably an arylthio group with 6 to 20 carbon atoms. Examples of such substituent are same as those for the aforementioned aryl group. Examples of the arylthio group include phenylthio and p-tolylthio.

The heterocyclic group represented by R2 is preferably a 5- or 6-membered heterocyclic group that may further have a condensed ring structure. A hetero atom constituting the heterocycle is preferably N, S or O. It may be an aromatic or non-aromatic heterocycle. The heterocycle may be further substituted, and examples of the substituent are same as those for the aforementioned aryl group. The heterocycle is preferably a 6-membered nitrogen-containing heterocycle, and particularly preferable examples include triazine, pyrimidine, and phthalazine.

The halogen atom represented by R8 can be a fluorine atom, a chlorine atom or a bromine atom.

The alkoxy group represented by R1, R3, R5 and R8 can be an alkoxy group having a substituent or a non-substituted alkoxy group. Such alkoxy group is preferably an alkoxy group with 1 to 20 carbon atoms. Examples of such substituent include a hydroxyl group and an ionic hydrophilic group. Examples of the alkoxy group include methoxy, ethoxy, isopropoxy, methoxyethoxy, hydroxyethoxy and 3-carboxypropoxy.

The aryloxy group represented by R8 can be an aryloxy group having a substituent or a non-substituted aryloxy group. Such aryloxy group is preferably an aryloxy group with 6 to 20 carbon atoms. Examples of such substituent are same as those for the aforementioned aryl group. Examples of the aryloxy group include phenoxy, p-methoxyphenoxy and o-methoxyphenoxy.

The acylamino group represented by R8 can be an acylamino group having a substituent or a non-substituted acylamino group. Such acylamino group is preferably an acylamino group with 2 to 20 carbon atoms. Examples of such substituent are same as those for the aforementioned aryl group. Examples of the acylamino group include acetamide, propionamide, benzamide and 3,5-disulfobenzamide.

The sulfonylamino group represented by R8 can be an alkylsulfonylamino group, an arylsulfonylamino group or a heterocyclic sulfonylamino group, and an alkyl group portion, an aryl group portion or a heterocyclic portion thereof may have a substituent. Examples of such substituent can be same as those for the aforementioned aryl group. Such sulfonylamino group is preferably a sulfonylamino group with 1 to 20 carbon atoms. Examples of the sulfonylamino group include methylsulfonylamino, and ethylsulfonylamino.

The alkoxycarbonylamino group represented by R8 can be an alkoxycarbonylamino group having a substituent or a non-substituted alkoxycarbonylamino group. Such alkoxycarbonylamino group is preferably an alkoxycarbonylamino group with 2 to 20 carbon atoms. Examples of such substituent include an ionic hydrophilic group. Examples of the alkoxycarbonylamino group include ethoxycarbonylamino.

The ureido group represented by R8 can be an ureido group having a substituent or a non-substituted ureido group. Such ureido group is preferably an ureido group with 1 to 20 carbon atoms. Examples of such substituent include an alkyl group and an aryl group. Examples of the ureido group include 3-methylureido, 3,3-dimethylureido and 3-phenylureido.

The alkoxycarbonyl group represented by R7, R8 and R9 can be an alkoxycarbonyl group having a substituent or a non-substituted alkoxycarbonyl group. Such alkoxycarbonyl group is preferably an alkoxycarbonyl group with 2 to 20 carbon atoms. Examples of such substituent include an ionic hydrophilic group. Examples of the aforementioned alkoxycarbonyl group include methoxycarbonyl and ethoxycarbonyl.

The carbamoyl group represented by R2, R7, R8 and R9 can be a carbamoyl group having a substituent or a non-substituted carbamoyl group. Examples of such substituent include an alkyl group. Examples of the carbamoyl group include a methylcarbamoyl group and a dimethylcarbamoyl group.

The sulfamoyl group represented by R8 can be a sulfamoyl group having a substituent or a non-substituted sulfamoyl group. Examples of such substituent include an alkyl group. Examples of the sulfamoyl group include a dimethylsulfamoyl group and a di-(2-hydroxyethyl)sulfamoyl group.

The sulfonyl group represented by R8 can be an alkylsulfonyl group, an arylsulfonyl group or a heterocyclic sulfonyl group, which may further have a substituent. Examples of such substituent include an ionic hydroplilic group. Examples of the sulfonyl group include methylsulfonyl and phenylsulfonyl.

The acyl group represented by R2 and R8 can be an acyl group having a substituent or a non-substituted acyl group. Such acyl group is preferably an acyl group with 1 to 20 carbon atoms.

Examples of such substituent include an ionic hydrophilic group. Examples of the acyl group include acetyl and benzoyl.

The amino group represented by R8 can be an amino group having a substituent or a non-substituted amino group. Examples of such substituent include an alkyl group, an aryl group and a heterocyclic group. Examples of the amino group include methylamino, diethylamino, anilino and 2-chloroanilino.

The heterocyclic group represented by R4, R6 and R10 can be same as the heterocyclic group B₁₁ that may be substituted in the general formula (1), and preferred examples, more preferred examples and particularly preferred examples are also same. Examples of the substituent include an alkyl group with 1 to 12 carbon atoms, an aryl group, an alkyl- or aryl-thio group, a halogen atom, a cyano group, a sulfamoyl group, a sulfonamino group, a carbamoyl group and an acylamino group, in which the alkyl group, aryl group and the like mentioned above may further have a substituent.

In the foregoing general formula (1-B), Za represents —N═, —NH— or —C(R11)=, Zb and Zc each independently represents —N═ or —C(R11)=, and R11 represents a hydrogen atom or a non-metal substituent. A non-metal substituent represented by R11 is preferably a cyano group, a cycloalkyl group, an aralkyl group, an aryl group, an alkylthio group, an arylthio group or an ionic hydrophilic group. Each of the aforementioned substituents has the same meaning as each substituent represented by R1, and preferred examples are also similar. Examples of heterocycles formed by two 5-membered rings and contained in the aforementioned general formula (1-B) are shown in the following.

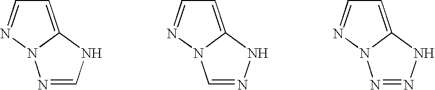

In the foregoing substituents which may further have a substituent, examples of such substituent are same as those of the substituent that can be substituted on the heterocycles A₁₁ and B₁₁ in the foregoing general formula (1).

Among the general formulas (1-A), (1-B) and (1-C), the general formula (1-A) is preferred, and particularly preferred is a dye represented by a following general formula (1-A1).

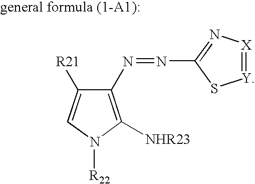

In the formula (1-A1), R21 and R23 each represents a hydrogen atom, an alkyl group, a cycloalkyl group, an aralkyl group, an alkoxy group or an aryl group; R22 represents a hydrogen atom, an aryl group or a heterocyclic group; either of X and Y represents a nitrogen atom while the other represents —CR24; R24 represents a hydrogen atom, a halogen atom, a cyano group, an alkyl group, an alkylthio group, an alkylsulfonyl group, an alkylsulfinyl group, an alkyloxycarbonyl group, a carbamoyl group, an alkoxy group, an aryl group, an arylthio group, an arylsulfonyl group, an arylsulfinyl group, an aryloxy group or an acylamino group. Among these, a hydrogen atom, an alkyl group, an alkyl- or aryl-thio group, or an aryl group is preferable, and a hydrogen atom, an alkylthio group or an aryl group is particularly preferable. Each of substituent may be further substituted.

The dye preferred in the present invention includes those described in Japanese patent Application Nos. 2003-286844, 2002-211683, and 2002-124832, and JP-A Nos. 2003-128953 and 2003-41160, and compounds shown in the following are particularly preferable. However, the dyes usable in the invention are not limited to these examples. These compounds can be synthesized by referring to, in addition to the aforementioned patent references, JP-A Nos. 2-124191 and 2001-279145.

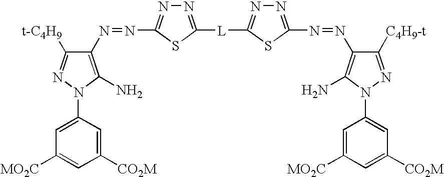

| Dye | L | M |
|---|---|---|
| 1 | —SCH₂CH₂S— | Na |
| 2 | —SCH₂CH₂S— | Li |
| 3 | —SCH₂CH₂CH₂S— | Na |
| 4 | —SCH₂CH₂CH₂S— | K |
| 5 | —SCH₂CH₂CH₂S— | Li |
| 6 | —SCH₂CH₂CH₂S— | NH₄ |
| 7 | —SCH₂CH₂CH₂S— | HN(Et)₃ |
| 8 | 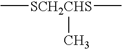 | Na |
| 9 | —SCH₂CH₂OCH₂CH₂S— | Na |
| 10 | 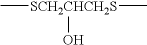 | Na |
| 11 | 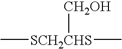 | Na |
| 12 | 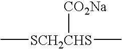 | Na |
| 13 | 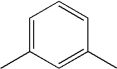 | Na |
| 14 | 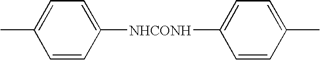 | Na |

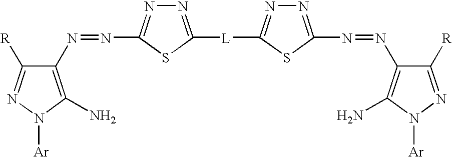

| Dye | Ar | L | R |
|---|---|---|---|
| 15 | 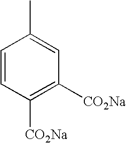 | —SCH₂CH₂CH₂S— | t-C₄H₉— |
| 16 | 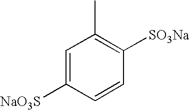 | —SCH₂CH₂CH₂S— | t-C₄H₉— |
| 17 | 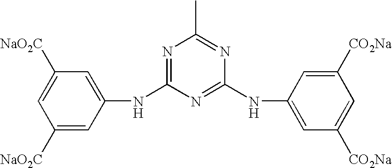 | —SCH₂CH₂CH₂S— | t-C₄H₉— |
| 18 | 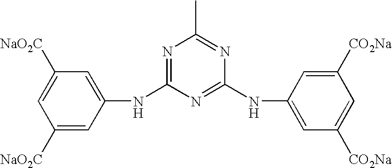 | —SCH₂CH₂S— | t-C₄H₉— |
| 19 | 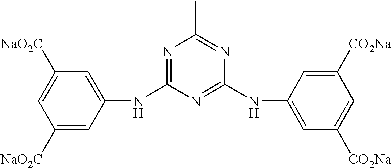 | —CH₂CH₂CH₂CH₂— | t-C₄H₉— |
| 20 | 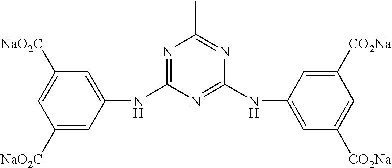 | 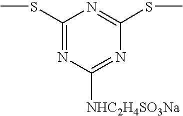 | t-C₄H₉— |
| 21 | 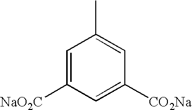 | —SCH₂CH₂CH₂S— | Ph |
| 22 | 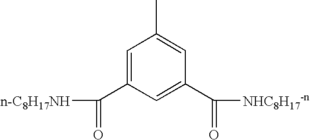 | —SCH₂CH₂CH₂S— | t-C₄H₉— |
| 23 | 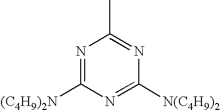 | —SCH₂CH₂S— | t-C₄H₉— |

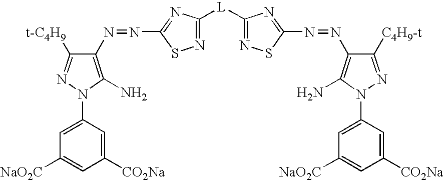

| Dye | L |
|---|---|
| 24 | —SCH₂CH₂CH₂S— |
| 25 | 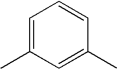 |

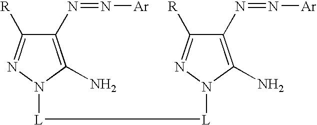

| Dye | Ar | L | R |
|---|---|---|---|
| 26 | 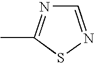 | 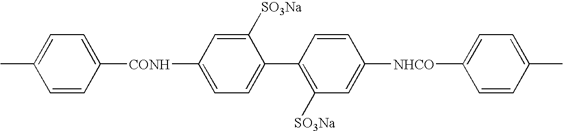 | t-C₄H₉— |
| 27 | 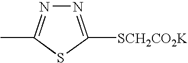 | 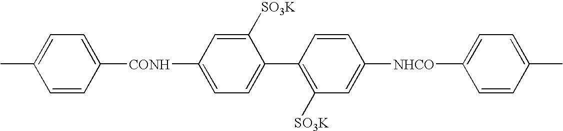 | t-C₄H₉— |
| 28 | 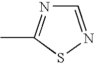 | 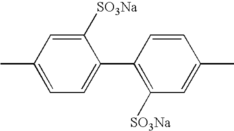 | t-C₄H₉— |
| 29 | 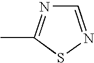 | 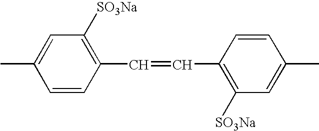 | t-C₄H₉— |
| 30 | 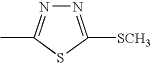 | 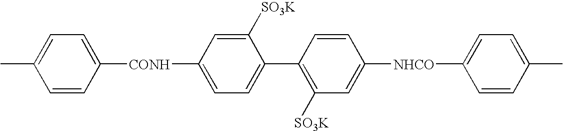 | t-C₄H₉— |
| 31 | 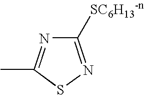 | 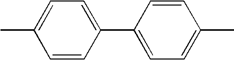 | t-C₄H₉— |
| 32 | 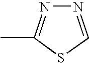 | 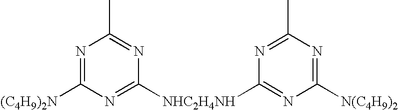 | t-C₄H₉— |

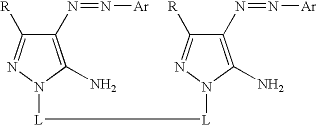

| Dye | Ar | L | R |
|---|---|---|---|
| 33 | 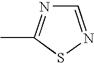 | 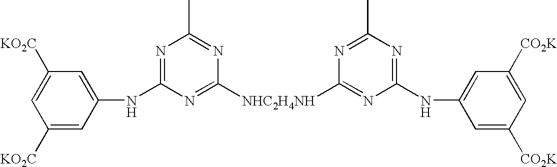 | t-C₄H₉— |
| 34 | 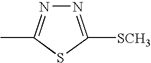 | 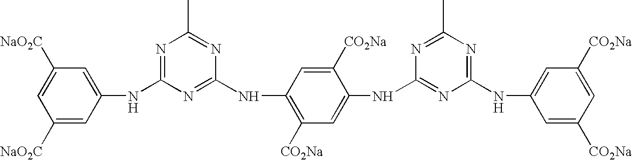 | t-C₄H₉— |
| 35 | 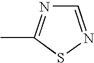 | 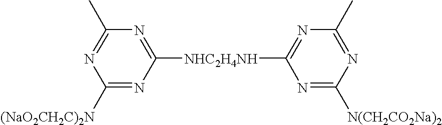 | t-C₄H₉— |

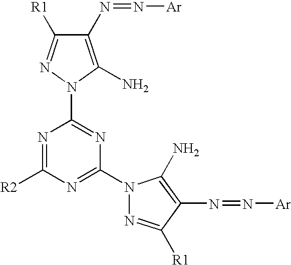

| Dye | Ar | R1 | R2 |
|---|---|---|---|
| 36 | 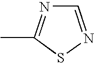 | t-C₄H₉— | 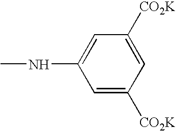 |
| 37 | 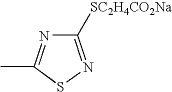 | t-C₄H₉— | —NHC₂H₄SO₃Na |
| 38 | 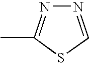 | Ph | —NHC₁₂H₂₅−n |

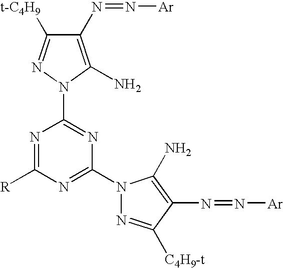

| Dye | Ar | R |
|---|---|---|
| 39 | 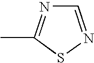 | 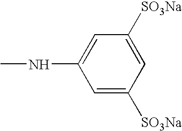 |
| 40 | 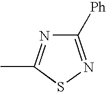 | 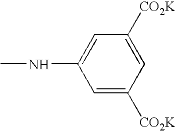 |
| 41 | 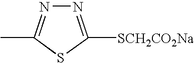 | —NHC₂H₄SO₃Na |
| 42 | 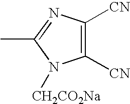 | —NHC₂H₄SO₃Na |
| 43 | 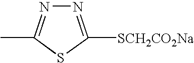 | 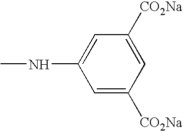 |
| 44 | 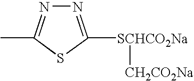 | 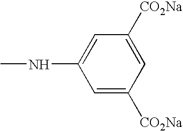 |
| 45 | 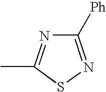 | 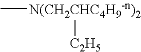 |

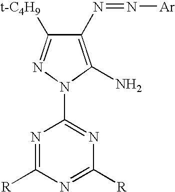

| Dye | Ar | R |
|---|---|---|
| 46 | 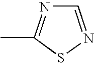 | —NHC₂H₄SO₃Na |
| 47 | 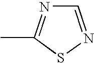 | 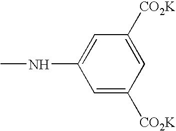 |
| 48 | 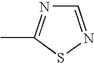 | 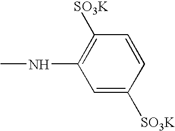 |
| 49 | 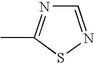 | —N(CH₂CO₂Na)₂ |
| 50 | 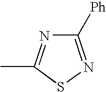 | 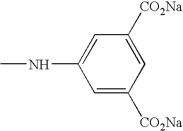 |
| 51 | 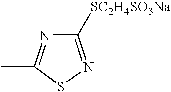 | 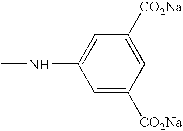 |
| 52 | 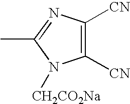 | 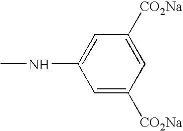 |
| 53 | 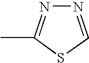 | 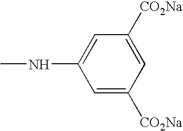 |
| 54 | 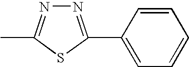 | 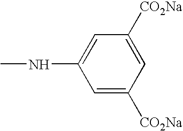 |

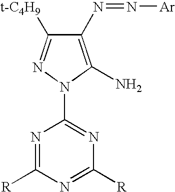

| Dye | Ar | R |
|---|---|---|
| 55 | 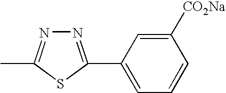 | 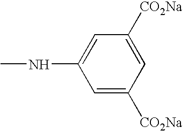 |
| 56 | 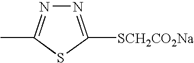 | 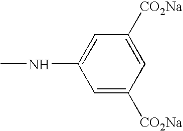 |
| 57 | 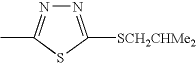 | 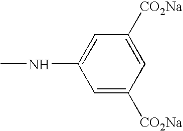 |
| 58 | 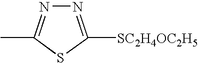 | 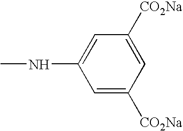 |
| 59 | 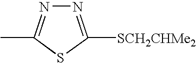 | 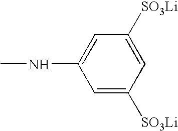 |
| 60 | 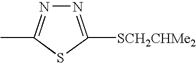 | 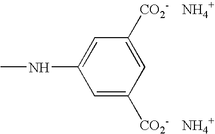 |
| 61 | 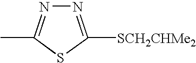 | —NHC₈H₁₇₋n |
| 62 | 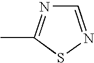 | 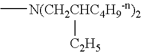 |
| 63 | 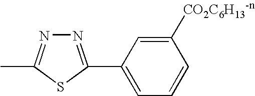 | —NHC₆H₁₃⁻ⁿ |

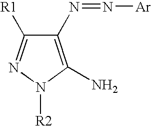

| Dye | Ar | R1 | R2 |
|---|---|---|---|
| 64 | 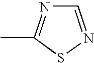 | t-C₄H₉— | 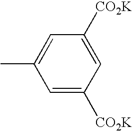 |
| 65 | 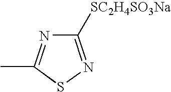 | 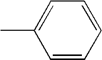 | 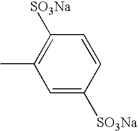 |
| 66 | 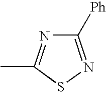 | t-C₄H₉— | 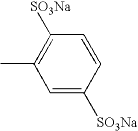 |
| 67 | 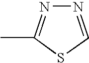 | t-C₄H₉— | 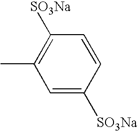 |
| 68 | 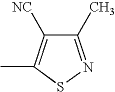 | t-C₄H₉— | 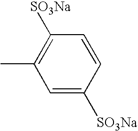 |
| 69 | 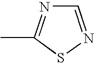 | t-C₄H₉— | 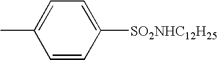 |
| 70 | 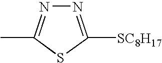 | t-C₄H₉— | 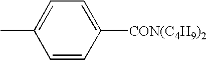 |
| 71 | 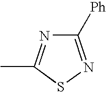 | t-C₄H₉— | 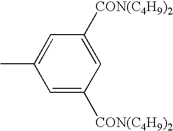 |
| 72 | 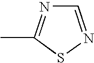 | t-C₄H₉— | 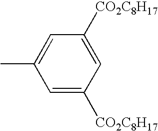 |

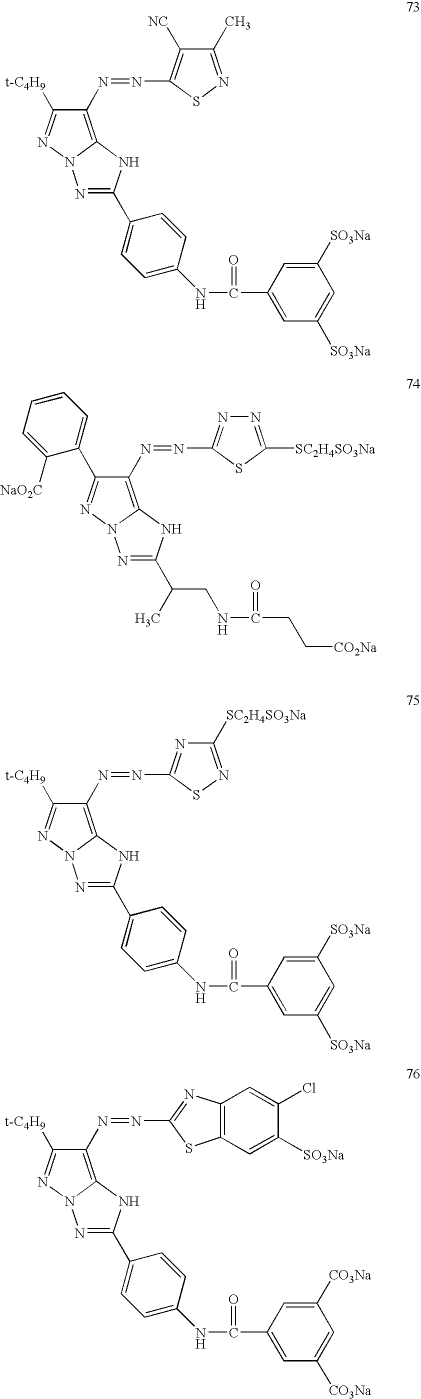

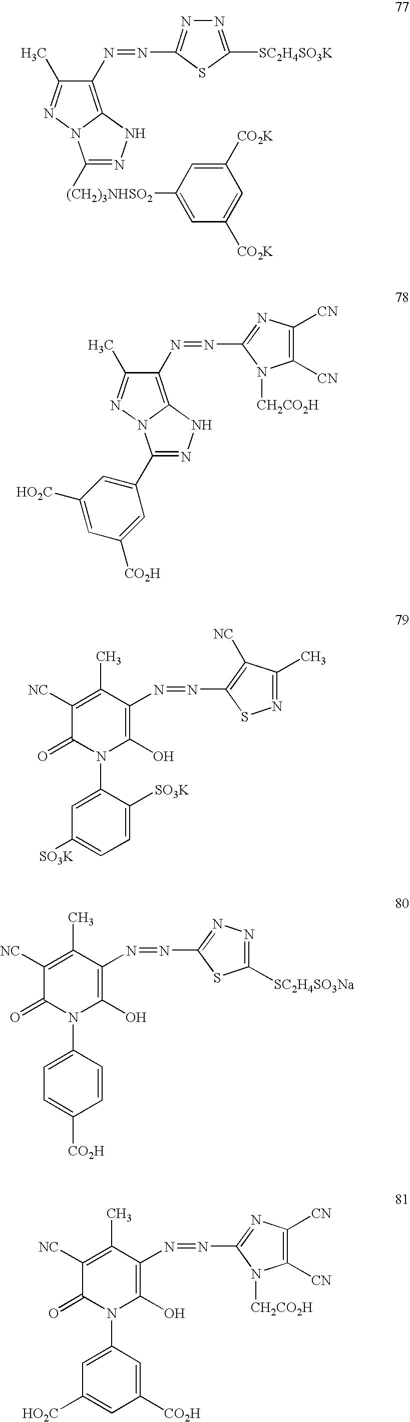

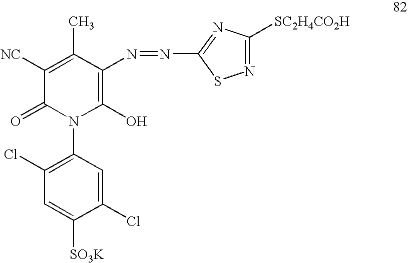

The yellow dye represented by the general formula (1) preferably has a content in the ink of 0.2 to 20 mass/, more preferably 0.5 to 15 mass % (weight %).

[Cyan Dye]

In the following, a phthalocyanine dye used as a cyan dye will be explained in detail.

The phthalocyanine dye employed in the present invention preferably is excellent in a light fastness and an ozone resistance, and shows a little change in hue and surface state (not easily generating a bronze tone and causing a dye precipitation).

As to the light fastness, an image printed on an Epson PM photographic image receiving sheet and irradiated, in a portion having a reflective density OD of 1.0, with a light of a xenon lamp (Xe 1.1 W/m (intermittent condition)) through a TAC filter for 3 days preferably shows a dye retention rate (reflective density after irradiation/initial density×100) of 90% or higher, and the dye retention rate after 14 days is preferably 85% or higher.

As to the change in the hue and the surface state, an amount of Cu ions, generated by the decomposition of the phthalocyanine dye and present as a phthalate salt, can be used as an index. A converted amount of Cu ions present in an actual print is preferably made as 10 mg/m² or less. An amount of Cu ions flowing out from a print image into water is preferably maintained at 20% or less, when a solid image is formed with a converted amount of Cu ions of 20 mg/m² or less and is subjected to an ozone fading in an ozone environment of 5 ppm for 24 hours. Prior to the fading, all the Cu compound is trapped in the image receiving material.

A phthalocyanine dye having the aforementioned properties can be obtained, for example, 1) by elevating the oxidation potential, 2) by elevating the associating property, 3) by introducing an association promoting group, namely by intensifying a hydrogen bonding at a π-π stacking, and 4) by not introducing a substituent in the α-position thereby facilitating stacking.

The structural characteristics of the phthalocyanine dye employed in the invention is that the phthalocyanine can be specified in number and position of substituents, while the phthalocyanine dye used in the prior inks is a mixture derived by a sulfonation of a non-substituted phthalocyanine and not specifiable in number and position of substituents.

A first structural feature is that it is a phthalocyanine dye not derived from a sulfonation of a non-substituted phthalocyanine. A second structural feature is that an electron attracting group is present in a β-position of the benzene ring of phthalocyanine, and is present particularly preferably in β-positions of all the benzene rings. More specifically, useful structures include one with a substitution of sulfonyl group (JP-A Nos. 2002-249677 and 2003-119415), one with a substitution of all sulfamoyl groups (JP-A Nos. 2002-302623 and 2003-3109), one with a substitution of a sulfamoyl group in the heterocycle (JP-A Nos. 2002-294097 and 2003-3086), one with a substitution of a sulfonyl group in the heterocycle (JP-A Nos. 2002-275386 and 2003-3099), one with a substitution of a specified sulfamoyl group (JP-A No. 2002-256167), one with a substitution of a carbonyl group (JP-A No. 2003-213153), and preferably ones having a specified substituent for improving solubility and ink stability and avoiding bronze phenomenon, such as one including an asymmetric carbon (JP-A No. 2003-213168) and one constituting a Li salt (JP-A No. 2003-213167).

Also a first feature in physical properties is to have a high oxidation potential (higher than 1.0 V). A second feature in the physical properties is to have a strong association property. More specifically, there can be employed a structure having a defined association for an oil-soluble dye (Japanese Patent Application No. 2001-64413), and a structure having a defined association for a water-soluble dye (JP-A No. 2002-309118).

A number of the associating groups is correlated with a property (optical absorbance of ink) in such a manner that an introduction of associating groups facilitates a decrease in the optical absorbance and a shift to a shorter wavelength of λₘₐₓ, even in a dilute solution. Also a number of the associating groups is correlated with a property (reflective density OD in Epson PM920 image receiving paper) in such a manner that the reflective density OD for a same ionic strength decreases with an increase in the number of the associating groups. It is therefore presumed that the association proceeds on the image receiving sheet. Also a number of the associating groups is correlated with a property (ozone resistance and light fastness) in such a manner that the ozone resistance is improved with an increase in the number of the associating groups. A dye with a larger number of the associating groups tends to show a better light fastness. For obtaining an ozone resistance, it is necessary to introduce a substituent in the benzene ring of phthalocyanine. As the reflective density OD and the light fastness are in a trade-off relation, it is necessary to improve the light fastness without decreasing the association.

Preferred embodiments of a cyan ink employing the phthalocyanine dye of the aforementioned characteristics are shown in the following:

1) A cyan ink showing, when printed on an Epson PM photographic image receiving sheet and irradiated, in a portion having a reflective density OD of 1.0, with a light of a xenon lamp (Xe 1.1 W/m (intermittent condition)) through a TAC filter for 3 days, a dye retention rate of 90% or higher;

2) A cyan ink showing, when a portion of a printed image having a reflective density of 0.9-1.1 through a status A filter is stored for 24 hours in an ozone environment of 5 ppm, a dye retention rate of 60% or higher (preferably 80% or higher);

3) A cyan ink in which an amount of Cu ions flowing out into water after the ozone fading under the condition 2) is 20% or less of the total dye; and

4) A cyan ink capable of a penetration in 30% or more of an upper part of an image receiving layer in a specified image receiving sheet.

The dye having the aforementioned characteristics can be a phthalocyanine dye represented by the foregoing general formula (2).

The phthalocyanine dye is known as a fast dye, but is known to be inferior in the fastness to ozone gas in case it is used as a dye for ink jet recording.

In the invention, it is preferable, as explained in the foregoing, to introduce an electron-attracting group into the phthalocyanine skeleton thereby obtaining an oxidation potential higher than 1.0 V (vs. SCE). The oxidation potential can be made higher by introducing a substituent having a large Hammett's substituent constant σp (an index for an electron attracting property or an electron donating property) such as a sulfinyl group, a sulfonyl group or a sulfamoyl group.

Also for such potential regulation, it is preferable, in the invention, to employ a phthalocyanine dye represented by the general formula (2).

In the following, the phthalocyanine dye represented by the general formula (2) will be explained in detail.

In the general formula (2), X₂₁, X₂₂, X₂₃ and X₂₄ each independently represents —SO-Z₂, —SO₂-Z₂, —SO₂NR₂₁R₂₂, a sulfo group, —CONR₂₁R₂₂, or —SO₂NR₂₁. Among these substituents, —SO-Z₂, —SO₂-Z₂, —SO₂NR₂₁R₂₂ and —CONR₂₁R₂₂ are preferable, —SO₂-Z₂ and —SO₂NR₂₁R₂₂ are particularly preferable, and —SO₂-Z₂ is most preferable. In case any of a₂₁-a₂₄, representing number of substituents, is 2 or more, any of X₂₁-X₂₄ present in plural units may be mutually same or different, which each independently represents any of the aforementioned groups. Also X₂₁, X₂₂, X₂₃ and X₂₄ may all be same substituents, or may be substituents of a same type but mutually different partially as in a case where X₂₁, X₂₂, X₂₃ and X₂₄ are all —SO₂-Z₂ but contain different Z₂, or may include mutually different substituents (for example —SO₂-Z₂ and —SO₂NR₂₁R₂₂).

Z₂ each independently represents a substituted or non-substituted alkyl group, a substituted or non-substituted cycloalkyl group, a substituted or non-substituted alkenyl group, a substituted or non-substituted aralkyl group, a substituted or non-substituted aryl group, or a substituted or non-substituted heterocyclic group. Preferably it is a substituted or non-substituted alkyl group, a substituted or non-substituted aryl group, or a substituted or non-substituted heterocyclic group, among which a substituted alkyl group, a substituted aryl group or a substituted heterocyclic group is most preferable.

R₂₁ and R₂₂ each independently represents a hydrogen atom, a substituted or non-substituted alkyl group, a substituted or non-substituted cycloalkyl group, a substituted or non-substituted alkenyl group, a substituted or non-substituted aralkyl group, a substituted or non-substituted aryl group, or a substituted or non-substituted heterocyclic group. Among these, a hydrogen atom, a substituted or non-substituted alkyl group, a substituted or non-substituted aryl group, or a substituted or non-substituted heterocyclic group is preferable, and a hydrogen atom, a substituted alkyl group, a substituted aryl group or a substituted heterocyclic group is further preferable. However, it is not preferable that R₂₁ and R₂₂ are both hydrogen atoms.

The substituted or non-substituted alkyl group represented by R₂₁, R₂₂ and Z₂ is preferably an alkyl group with 1 to 30 carbon atoms. In particular, for improving solubility of the dye or stability of the ink, a branched alkyl group is preferable, and a case including an asymmetric carbon (use of a racemic body) is particularly preferable. Examples of the substituent are same as those for the substituent in case Z₂, R₂₁, R₂₂, Y₂₁, Y₂₂, Y₂₃ or Y₂₄ to be explained later can further have a substituent. In particular, a hydroxyl group, an ether group, an ester group, a cyano group, an amide group or a sulfonamide group is preferable for increasing association of the dye thereby improving the fastness. In addition, there may also be included a halogen atom or an ionic hydrophilic group. The number of carbon atoms of the alkyl group does not include the carbon atoms of the substituent, and it applies also to other groups.

The substituted or non-substituted cycloalkyl group represented by R₂₁, R₂₂ and Z₂ is preferably a cycloalkyl group with 5 to 30 carbon atoms. In particular, for improving solubility of the dye and stability of the ink, a case having an asymmetric carbon (use of a racemic body) is particularly preferable. Examples of the substituent are same as those for the substituent in case Z₂, R₂₁, R₂₂, Y₂₁, Y₂₂, Y₂₃ or Y₂₄ to be explained later can further have a substituent. In particular, a hydroxyl group, an ether group, an ester group, a cyano group, an amide group or a sulfonamide group is preferable for increasing the association of the dye thereby improving the fastness. In addition, there may also be included a halogen atom or an ionic hydrophilic group.

The substituted or non-substituted alkenyl group represented by R₂₁, R₂₂ and Z₂ is preferably an alkenyl group with 2 to 30 carbon atoms. In particular, for improving solubility of the dye and stability of the ink, a branched alkenyl group is preferable, and a case having an asymmetric carbon (use of a racemic body) is particularly preferable. Examples of the substituent are same as those for the substituent in case Z₂, R₂₁, R₂₂, Y₂₁, Y₂₂, Y₂₃ or Y₂₄ to be explained later can further have a substituent. In particular, a hydroxyl group, an ether group, an ester group, a cyano group, an amide group or a sulfonamide group is preferable for increasing the association of the dye thereby improving the fastness. In addition, there may also be included a halogen atom or an ionic hydrophilic group.

The substituted or non-substituted aralkyl group represented by R₂₁, R₂₂ and Z₂ is preferably an aralkyl group with 7 to 30 carbon atoms. In particular, for improving solubility of the dye and stability of the ink, a branched aralkyl group is preferable, and a case having an asymmetric carbon (use of a racemic body) is particularly preferable. Examples of the substituent are same as those for the substituent in case Z₂, R₂₁, R₂₂, Y₂₁, Y₂₂, Y₂₃ or Y₂₄ to be explained later can further have a substituent. In particular, a hydroxyl group, an ether group, an ester group, a cyano group, an amide group or a sulfonamide group is preferable for increasing association of the dye thereby improving the fastness. In addition, there may also be included a halogen atom or an ionic hydrophilic group.

The substituted or non-substituted aryl group represented by R₂₁, R₂₂ and Z₂ is preferably an aryl group with 6 to 30 carbon atoms. Examples of the substituent are same as those for the substituent in case Z₂, R₂₁, R₂₂, Y₂₁, Y₂₂, Y₂₃ or Y₂₄ to be explained later can further have a substituent. In particular, an electron attracting group is preferable as it realizes a high oxidation potential of the dye thereby improving the fastness. The electron attracting group can be a substituent having a Hammett's substituent constant σp of a positive value. Among such substituent, there is further preferred a halogen atom, a heterocyclic group, a cyano group, a carboxyl group, an acylamino group, a sulfonamide group, a sulfamoyl group, a carbamoyl group, a sulfonyl group, an imide group, an acyl group, a sulfo group or a quaternary ammonium group, further preferably a cyano group, a carboxyl group, a sulfamoyl group, a carbamoyl group, a sulfonyl group, an imide group, an acyl group, a sulfo group or a quaternary ammonium group.

The heterocyclic group represented by R₂₁, R₂₂ and Z₂ is preferably a 5- or 6-membered heterocyclic group that may further have a condensed ring structure. It may be an aromatic or non-aromatic heterocycle. In the following, examples of the heterocyclic group represented by R₂₁, R₂₂ and Z₂ are given in the form of heterocycle without indicating a substituting position, but the substituting position is not restricted, and, pyridine for example can be substituted at a 2-, 3- or 4-position. The examples include pyridine, pyradine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperadine, imidazolidine, and thiazoline. Among these, an aromatic heterocycle is preferable, and preferred examples thereof, indicated in the same manner as above, include pyridine, pyradine, pyrimidine, pyridazine, triazine, pyrazole, imidazole, benzimidazole, triazole, thiazole, benzothiazole, isothiazole, benzisothiazole, and thiadiazole. These may have a substituent, and examples of the substituent are same as those for the substituent in case Z₂, R₂₁, R₂₂, Y₂₁, Y₂₂, Y₂₃ or Y₂₄ to be explained later can further have a substituent. Preferable substituents are same as the aforementioned preferable substituents for the aryl group, and more preferable substituents are same as the more preferable substituents for the aryl group.

Y₂₁, Y₂₂, Y₂₃ and Y₂₄ each independently represents a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an acylamino group, an arylamino group, an ureido group, a sulfamoylamino group, an alkylthio group, an arylthio group, an alkoxycarbonylamino group, a sulfonamide group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a phosphoryl group, an acyl group, a carboxyl group, or a sulfo group, each of which may further have a substituent.

Among these, a hydrogen atom, a halogen atom, an alkyl group, an aryl group, a cyano group, an alkoxy group, an amide group, an ureido group, a sulfonamide group, a carbamoyl group, a sulfamoyl group, an alkoxycarbonyl group, a carboxyl group, or a sulfo group is preferred, particularly a hydrogen atom, a halogen atom, a cyano group, a carboxyl group or a sulfo group is preferred, and a hydrogen atom is most preferred.

Z₂, R₂₁, R₂₂, Y₂₁, Y₂₂, Y₂₃ or Y₂₄, in case representing a group that can further have a substituent, may further have a following substituent.

Examples include a linear or branched alkyl group with 1 to 12 carbon atoms, a linear or branched aralkyl group with 7 to 18 carbon atoms, a linear or branched alkenyl group with 2 to 12 carbon atoms, a linear or branched alkinyl group with 2 to 12 carbon atoms, a linear or branched cycloalkyl group with 3 to 12 carbon atoms, and a linear or branched cycloalkenyl group with 3 to 12 carbon atoms (foregoing groups preferably having a branched chain for improving solubility of the dye and stability of the ink, and particularly preferably having an asymmetric carbon; and specific examples of the foregoing groups including methyl, ethyl, propyl, isopropyl, sec-butyl, t-butyl, 2-ethylhexyl, 2-methylsulfonylethyl, 3-phenoxypropyl, trifluoromethyl, and cyclopentyl), a halogen atom (such as a chlorine atom or a bromine atom), an aryl group (such as phenyl, 4-t-butylphenyl, or 2,4-di-t-amylphenyl), a heterocyclic group (such as imidazolyl, pyrazolyl, triazolyl, 2-furyl, 2-thienyl, 2-pyrimidinyl or 2-benzothiazolyl), a cyano group, a hydroxyl group, a nitro group, a carboxy group, an amino group, an alkyloxy group (such as methoxy, ethoxy, 2-methoxyethoxy, or 2-methanesulfonylethoxy), an aryloxy group (such as phenoxy, 2-methylphenoxy, 4-t-butylphenoxy, 3-nitrophenoxy, 3-t-butyloxycarbamoylphenoxy, or 3-methoxycarbamoyl), an acylamino group (such as acetamide, benzamide, or 4-(3-t-butyl-4-hydroxyphenoxy)butanamide), an alkylamino group (such as methylamino, butylamino, diethylamino, or methylbutylamino), an anilino group (such as phenylamino or 2-chloroanilino), an ureido group (such as phenylureido, methylureido or N,N-dibutylureido), a sulfamoylamino group (such as N,N-dipropylsulfamoylamino), an alkylthio group (such as methylthio, octylthio, or 2-phenoxyethylthio), an arylthio group (such as phenylthio, 2-butoxy-5-t-octylphenylthio or 2-carboxyphenylthio), an alkyloxycarbonylamino group (such as methoxycarbonylamino), a sulfonamide group (such as methanesulfonamide, benzenesulfonamide, or p-toluenesulfoneamide), a carbamoyl group (such as N-ethylcarbamoyl, or N,N-dibutylcarbamoyl), a sulfamoyl group (such as N-ethylsulfamoyl, N,N-dipropylsulfamoyl, or N-phenylsulfamoyl), a sulfonyl group (such as methanesulfonyl, octanesulfonyl, benzenesulfonyl or toluenesulfonyl), an alkyloxycarbonyl group (such as methoxycarbonyl, or butyloxycarbonyl), a heterocyclic oxy group (such as 1-phenyltetrazol-5-oxy, or 2-tetrahydropyranyloxy), an azo group (such as phenylazo, 4-methoxyphenylazo, 4-pivaloylaminophenylazo, or 2-hydroxy-4-propanoylphenylazo), an acyloxy group (such as acetoxy), a carbamoyloxy group (such as N-methylcarbamoyloxy, or N-phenylcarbamoyloxy), a silyloxy group (such as trimethylsilyloxy or dibutylmethylsilyloxy), an aryloxycarbonylamino group (such as phenoxycarbonylamino), an imide group (such as N-succinimide, or N-phthalimide), a heterocyclic thio group (such as 2-benzothiazolylthio, 2,4-diphenoxy-1,3,5-triazole-6-thio, or 2-pyridylthio), a sulfinyl group (such as 3-phenoxypropylsulfinyl), a phosphonyl group (such as phenoxyphosphonyl, octyloxyphosphonyl, or phenylphosphonyl), an aryloxycarbonyl group (such as phenoxycarbonyl), an acyl group (such as acetyl, 3-phenylpropanoyl or benzoyl), and an ionic hydrophilic group (such as a carboxyl group, a sulfo group, a phosphono group or a quaternary ammonium group).

In case the phthalocyanine dye represented by the foregoing general formula (2) is water-soluble, it preferably has an ionic hydrophilic group. The ionic hydrophilic group includes a sulfo group, a carboxyl group, a phosphono group and a quaternary ammonium group. The ionic hydrophilic group is preferably a carboxyl group, a phosphono group or a sulfo group, and particularly preferably a carboxyl group or a sulfo group. The carboxyl group, phosphono group or sulfo group may be in a salt state, and a counter ion constituting the salt includes an ammonium ion, an alkali metal ion (such as lithium ion, sodium ion or potassium ion), and an organic cation (such as tetramethylammonium ion, tetramethylguanidium ion or tetramethylphosphonium). Among such counter ions, an alkali metal ion is preferred, and lithium ion is particularly preferred in improving solubility of the dye and stability of the ink.

As to the number of the ionic hydrophilic group, the phthalocyanine dye preferably includes at least two such groups within a molecule, and more preferably includes at least two sulfo and/or carboxyl groups.

In the general formula (2), a₂₁-a₂₄ and b₂₁-b₂₄ respectively represent numbers of the substituents in X₂₁-X₂₄ and Y₂₁-Y₂₄. a₂₁-a₂₄ each independently represents an integer from 0 to 4, but all do not assume 0 at the same time. b₂₁-b₂₄ each independently represents an integer from 0 to 4. In case any of a₂₁-a₂₄ and b₂₁-b₂₄ represents an integer equal to or larger than 2, any of X₂₁-X₂₄ and Y₂₁-Y₂₄ is present in plural units, which may be mutually same or different.

a₂₁ and b₂₁ satisfy a relation a₂₁+b₂₁=4, in which particularly preferred is a combination where a₂₁ represents 1 or 2 and b₂₁ represents 3 or 2, and most preferred is a combination where a₂₁ represents 1 and b₂₁ represents 3.

Combinations of a₂₂ and b₂₂, a₂₃ and b₂₃, and a₂₄ and b₂₄ have similar relations as in the combination of a₂₁ and b₂₁, and preferred combinations are also similar,

M represents a hydrogen atom, a metal element or an oxide, a hydroxide or a halide thereof.

M is preferably a hydrogen atom, a metal element such as Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, or Bi.

Preferred examples of oxide include VO and GeO.

Preferred examples of hydroxide include Si(OH)₂, Cr(OH)₂ and Sn(OH)₂.

Also examples of halide include AlCl, SiCl₂, VCl, VCl₂, VOCl, FeCl, GaCl and ZrCl.

Among these, Cu, Ni, Zn, Al etc. are preferable, and Cu is most preferable.

Also in the phthalocyanine dye represented by the general formula (2), the phthalocyanine ring (Pc) may form, through L (divalent connecting group), a dimer (for example Pc-M-L-M-Pc) or a trimer, and Ms in such case may be mutually same or different.

In such case, the divalent connecting group represented by L is preferably an oxy group —O—, a thio group —S—, a carbonyl group —CO—, a sulfonyl group —SO₂—, an imino group —NH—, a methylene group —CH₂— or a group formed by combining these groups.

As to a preferred combination of the substituents in the compound represented by the general formula (2), there is preferred a compound in which at least one of the various substituents is the aforementioned preferable group, more preferably a compound in which a larger number of the various substituents are the aforementioned preferable groups, and most preferably a compound in which all the substituents are the aforementioned preferable groups.

Among the phthalocyanine dye represented by the general formula (2), a phthalocyanine dye of a structure represented by the foregoing general formula (5) is more preferable. In the following, the phthalocyanine dye represented by the general formula (5) will be explained in detail.

In the general formula (5), X₅₁-X₅₄ and Y₅₁-Y₅₈ respectively have same meanings as X₂₁-X₂₄ and Y₂₁-Y₂₄ in the general formula (2), and have same preferable examples. Also M₁ has a same meaning as M in the general formula (2), and has same preferable examples.

In the general formula (5), a₅₁-a₅₄ each independently represents an integer 1 or 2, preferably satisfy a relation 4≦a₅₁+a₅₂+a₅₃+a₅₄≦6, and particularly preferably satisfy a relation a₅₁=a₅₂=a₅₃=a₅₄=1.

X₅₁, X₅₂, X₅₃ and X₅₄ may all be same substituents, or may be substituents of a same type but partially mutually different for example as in a case where X₅₁, X₅₂, X₅₃ and X₅₄ are all —SO₂-Z₂ but different in Z₂, or may include substitutes of mutually different types, such as —SO₂-Z₂ and —SO₂NR₂₁R₂₂.

Within the phthalocyanine dye represented by the general formula (5), a particularly preferable combination of substituents is as follows.

X₅₁ to X₅₄ each independently and preferably represents —SO-Z₂, —SO₂-Z₂, —SO₂NR₂₁R₂₂ or —CONR₂₁R₂₂, and particularly preferably —SO₂-Z₂ or —SO₂NR₂₁R₂₂, and most preferably —SO₂-Z₂.

Z₂ preferably represents a substituted or non-substituted alkyl group, a substituted or non-substituted aryl group, or a substituted or non-substituted heterocyclic group, among which a substituted alkyl group, a substituted aryl group or a substituted heterocyclic group is most preferable. In particular, for improving solubility of the dye and stability of the ink, a case having an asymmetric carbon in the substituent (use of a racemic body) is particularly preferable. Also for increasing association of the dye thereby improving the fastness, a case of having a hydroxyl group, an ether group, an ester group, a cyano group, an amide group or a sulfonamide group in the substituent is preferable.

R₂₁ and R₂₂ each independently and preferably represents a hydrogen atom, a substituted or non-substituted alkyl group, a substituted or non-substituted aryl group, or a substituted or non-substituted heterocyclic group, and more preferably a hydrogen atom, a substituted alkyl group, a substituted aryl group or a substituted heterocyclic group. However, it is not preferable that R₂₁ and R₂₂ both represent hydrogen atoms. In particular, for improving solubility of the dye and stability of the ink, a case of having an asymmetric carbon in the substituent (use of a racemic body) is particularly preferable. Also for increasing association of the dye thereby improving the fastness, a case of having a hydroxyl group, an ether group, an ester group, a cyano group, an amide group or a sulfonamide group in the substituent is preferable.

Y₅₁ to Y₅₈ each independently and preferably represents a hydrogen atom, a halogen atom, an alkyl group, an aryl group, a cyano group, an alkoxy group, an amide group, an ureido group, a sulfonamide group, a carbamoyl group, a sulfamoyl group, an alkoxycarbonyl group, a carboxyl group, or a sulfo group, particularly preferably a hydrogen atom, a halogen atom, a cyano group, a carboxyl group or a sulfo group, and most preferably a hydrogen atom.

a₅₁ to a₅₄ each independently and preferably represents 1 or 2, and particularly preferably are all 1.

M₁ represents a hydrogen atom or an oxide, a hydroxide or a halide thereof, preferably Cu, Ni, Zn or Al and particularly preferably Cu.

In case the phthalocyanine dye represented by the general formula (5) is water-soluble, it preferably has an ionic hydrophilic group. The ionic hydrophilic group includes a sulfo group, a carboxyl group, a phosphono group and a quaternary ammonium group. The ionic hydrophilic group is preferably a carboxyl group, a phosphono group or a sulfo group, and particularly preferably a carboxyl group or a sulfo group. The carboxyl group, phosphono group or sulfo group may be in a salt state, and a counter ion constituting the salt includes an ammonium ion, an alkali metal ion (such as lithium ion, sodium ion or potassium ion), and an organic cation (such as tetramethylammonium ion, tetramethylguanidium ion or tetramethylphosphonium). Among such counter ions, an alkali metal ion is preferred, and lithium ion is particularly preferred in improving solubility of the dye and stability of the ink.

As to the number of the ionic hydrophilic group, the phthalocyanine dye preferably includes at least two such groups within a molecule, and more preferably includes at least two sulfo and/or carboxyl groups.

As to a preferred combination of the substituents in the compound represented by the general formula (5), there is preferred a compound in which at least one of the various substituents is the aforementioned preferable group, more preferably a compound in which a larger number of the various substituents are the aforementioned preferable groups, and most preferably a compound in which all the substituents are the aforementioned preferable groups.

As to the chemical structure of the compound represented by the general formula (5), it is preferable to introduce at least an electron attracting group such as a sulfinyl group, a sulfonyl group or a sulfamoyl group in each of four benzene rings of phthalocyanine, in such a manner that a total σp value of the substituents of the entire phthalocyanine skeleton becomes 1.6 or higher.

Now an explanation will be given on the Hammett's substituent constant σp. The Hammett's rule is an empirical rule proposed by L. P. Hammett in 1935 in order to quantitatively discuss the influence of a substituent on a reaction or an equilibrium of a benzene derivative, and is now recognized as widely plausible. The substituent constants based on the Hammett's rule include σp and σm, which are described in various references for example J. A. Dean, “Lange's Handbook of Chemistry”, 12th edition, 1979 (McGraw-Hill), and “Kagaku no Ryoiki”, Zoukan, 122, pp. 96-103, 1979 (Nankodo). In the present invention, each substituent is defined or described by the Hammett's substituent constant σp, but such description is not limited to the substituents of which the constants are known in the aforementioned references but naturally covers substituents of which the constants, even if not described in the references, will fall in the desired range in a measurement according to the Hammett's rule. Also the dyes employed in the invention include those which are not derivatives of benzene, but the σp is used as an index indicating an electronic efficiency of a substituent, regardless of the substituting position. In the present invention, σp is used in the meaning explained above.

The phthalocyanine dye represented by the general formula (2) is generally a mixture of analogs in which substituents Xn (n=1-4) and Ym (m=1-4) are inevitably different in the positions and numbers of introduction by a synthesizing method thereof, and the general formula often represents the mixture of such analogs in statistical average. The present invention is based on a finding that, by classifying the mixture of such analogs into following three types, a specified mixture is particularly preferable. More specifically, the mixture of analogs of the phthalocyanine dye represented by the general formulas (2) and (5) is classified into following three types depending on substituting positions, in which Y₅₁, Y₅₂, Y₅₃, Y₅₄, Y₅₅, Y₅₆, Y₅₇ and Y₅₈ are respectively defined as 1-, 4-, 5-, 8-, 9-, 12-, 13- and 16-positions.

(1) β-position substitution type: A phthalocyanine dye having specified substituents in 2- and/or 3-position, 6- and/or 7-position, 10- and/or 11-position, and 14- and/or 15-position.

(2) α-position substitution type: A phthalocyanine dye having specified substituents in 1- and/or 4-position, 5- and/or 8-position, 9- and/or 12-position, and 13- and/or 16-position.

(3) α,β-position substitution type: A phthalocyanine dye having specified substituents in 1- to 16-positions without regularity.

In the present description, the β-position substitution type, the α-position substitution type, and the α,β-position substitution type mentioned above will be used in explaining derivatives of the phthalocyanine dye, different in structure (particularly different in substituting position).

The phthalocyanine dye employed in the invention can be synthesized by combining methods described or cited for example in Shirai and Kobayashi, “Phthalocyanine-Chemistry and Function-”, published by IPC Co., (pp. 1-62), and C. C. Leznoff and A. B. P. Lever, “Phthalocyanines-Properties and Applications”, published by VCH (pp. 1-54) or similar methods.

The phthalocyanine compound represented by the general formula (2) can be synthesized, as described in WO Nos. 00/17275, 00/08103, 00/08101 and 98/41853, and JP-A No. 10-36471, by a sulfonation reaction, a sulfonylchlorination reaction and an amidation reaction of a non-substituted phthalocyanine compound. In this case, the sulfonation may take place in any position of the phthalocyanine nucleus and the number of sulfonation is also difficult to control. Therefore, sulfo group introduction under such reaction condition is unable to specify the position and the number of the introduced sulfo groups, and inevitably provides a mixture of analogs different in the number or the substituting positions of the substituents. Therefore, in a synthesis utilizing such mixture as a raw material, it is not possible to specify the number or the substituting position of the sulfamoyl groups on the heterocycle and the resulting phthalocyanine dye is obtained as an α,β-position mixed substitution type containing certain compounds different in the number and the substituting position of the substituents.

As described in the foregoing, an introduction of an electron attracting group such as a sulfamoyl group by a large number into the phthalocyanine nucleus provides a higher oxidation potential, thereby improving the resistance to ozone. In the aforementioned synthesis, it is impossible to avoid presence of phthalocyanine dyes with a fewer number of the introduced electron attracting groups, namely of a lower oxidation potential. Therefore, in order to improve the resistance to ozone, it is more preferable to employ a synthesis capable of suppressing generation of compounds with a lower oxidation potential.

The phthalocyanine compound represented by the general formula (5) of the invention can be derived from a tetrasulfophthalocyanine compound obtained by reacting a phthalonitrile derivative (compound P) represented by a following formula and/or a diiminoisoindoline derivative (compound Q) with a metal derivative represented by a general formula (6), or by reacting a 4-sulfophthalonitrile derivative (compound R) represented by a following formula with a metal derivative represented by a general formula (6).

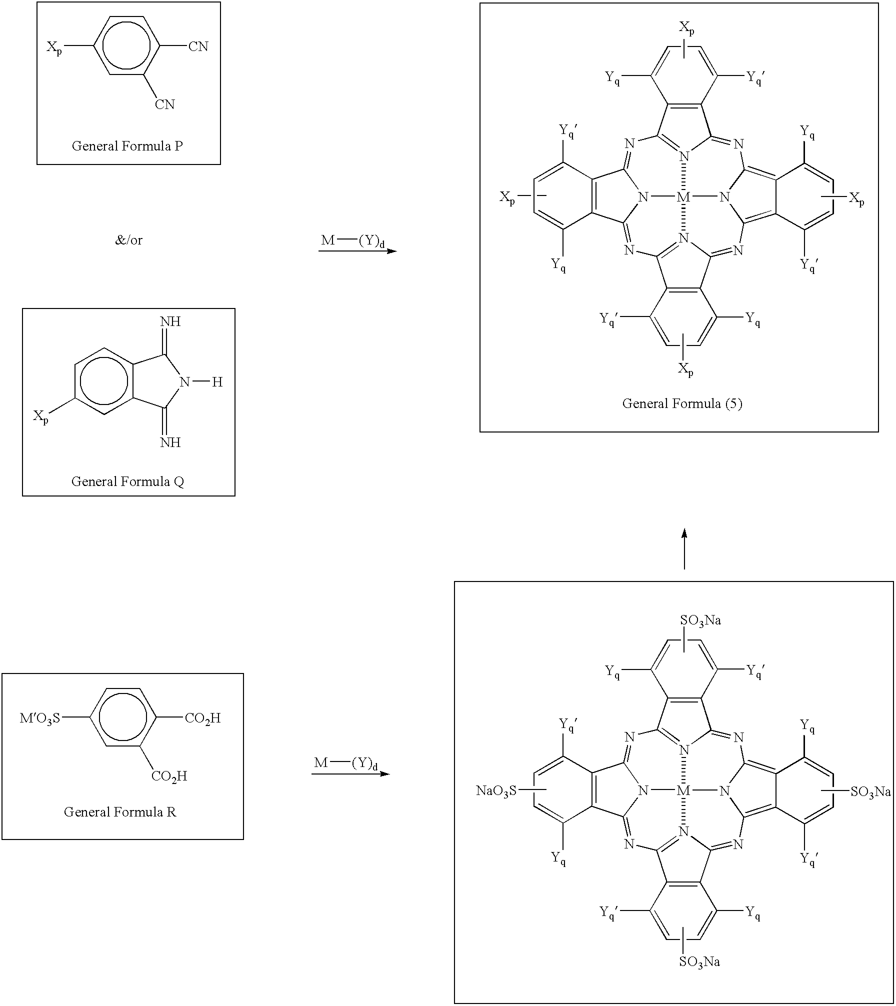

In these formulas, Xₚ corresponds to X₅₁, X₅₂, X₅₃ or X₅₄ in the general formula (5); Y_{q} and Y_{q}′ each corresponds to Y₅₁, Y₅₂, Y₅₃, Y₅₄, Y₅₅, Y₅₆, Y₅₇ or Y₅₈ in the general formula (5); and M′ in the compound R represents a cation.

A cation represented by M′ can be an alkali metal ion such as Li, Na or K, or an organic cation such as triethylammonium ion or a pyridinium ion.
M-(Y)d general formula (6)

In the general formula (6), M has the same meaning as M in the general formula (2) or M₁ in the general formula (5); Y represents a monovalent or divalent ligand such as a halogen atom, an acetate anion, acetylacetonate or oxygen; and d represents an integer from 1 to 4.

The above-mentioned synthesis allows to introduce a desired substituent by a specified number. Such synthesis is far superior to the method explained in the foregoing for synthesizing the phthalocyanine compound of the general formula (2), in case of introducing a large number of electron attracting groups in order to obtain a high oxidation potential as in the invention.

The thus obtained phthalocyanine compound represented by the general formula (5) is normally a mixture of compounds represented by following general formulas (a)-1 to (a)-4 which are isomers in the substituting positions Xp, namely a β-position substitution type.

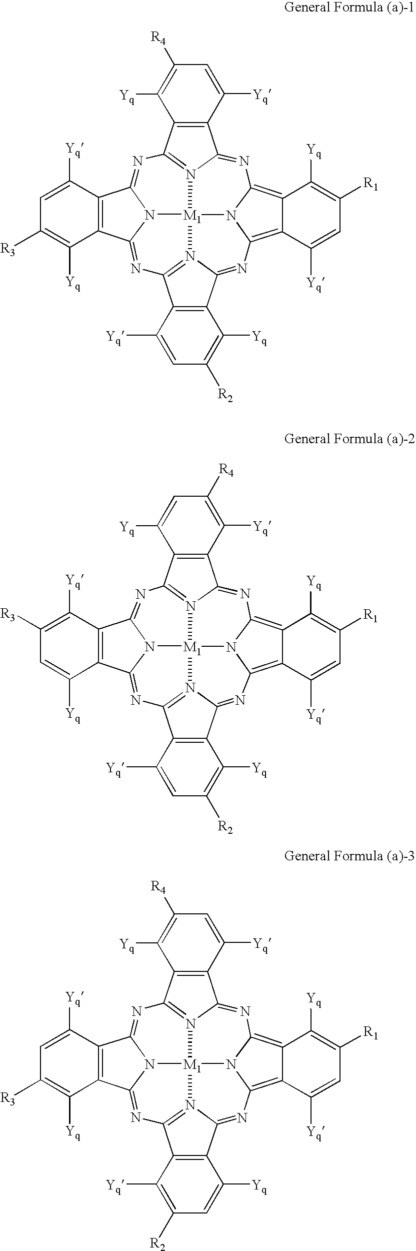

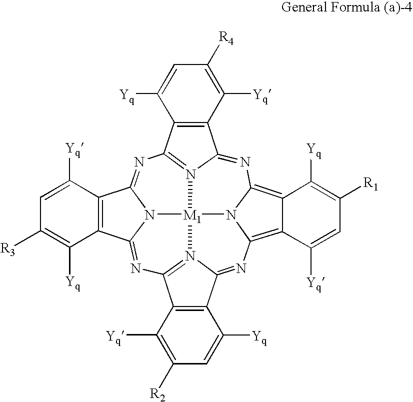

In the aforementioned synthesis, a β-position substituted phthalocyanine dye with identical substituents as X₅₁, X₅₂, X₅₃ and X₅₄ can be obtained by employing all same Xₚs. On the other hand, by employing different Xₚs in combination, it is possible to synthesize a dye having substituents which are of a same type but are partially different mutually, or a dye having substituents which are of different types. Among the dyes represented by the general formula (5), such dye having mutually different electron attracting substituents is particularly preferable as it allows to regulate a solubility or an association property of the dye and a stability in time of the ink.

In the invention, it is found, in any substitution type, that an oxidation potential higher than 1.0 V (vs. SCE) is very important for improving the fastness, and the magnitude of such effect is totally unpredictable from the aforementioned prior technologies. Also, though the detailed reason is still unclear, the β-position substitution type is evidently superior to the α,β-position mixed substitution type in the color hue, light fastness and ozone resistance.

Specific examples of the phthalocyanine dye represented by the general formulas (2) and (5) are shown in the following (example compound I-1 to I-12 and 101-190), but the phthalocyanine dyes to be employed in the invention are not limited to such examples.

Example Compound

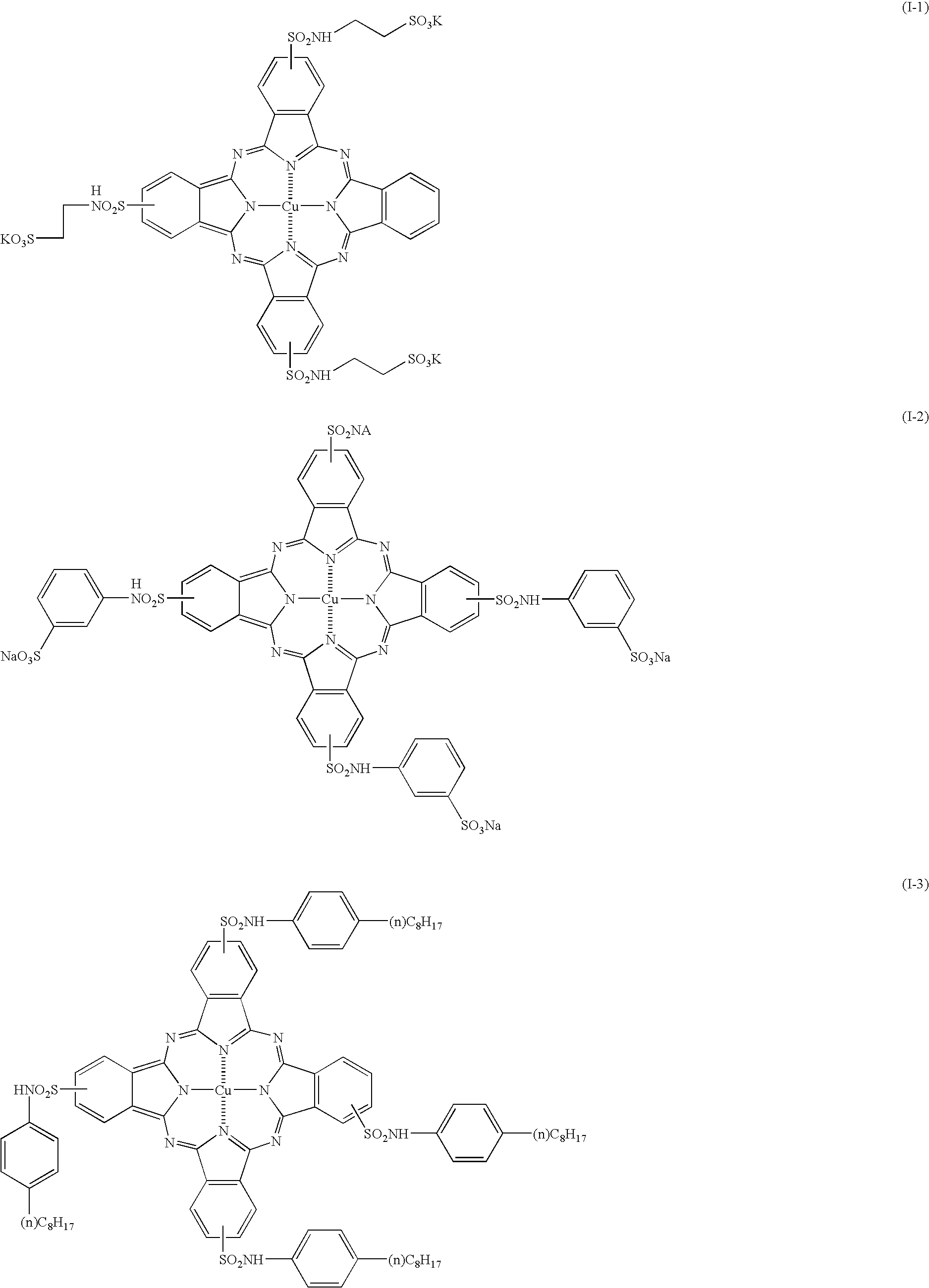

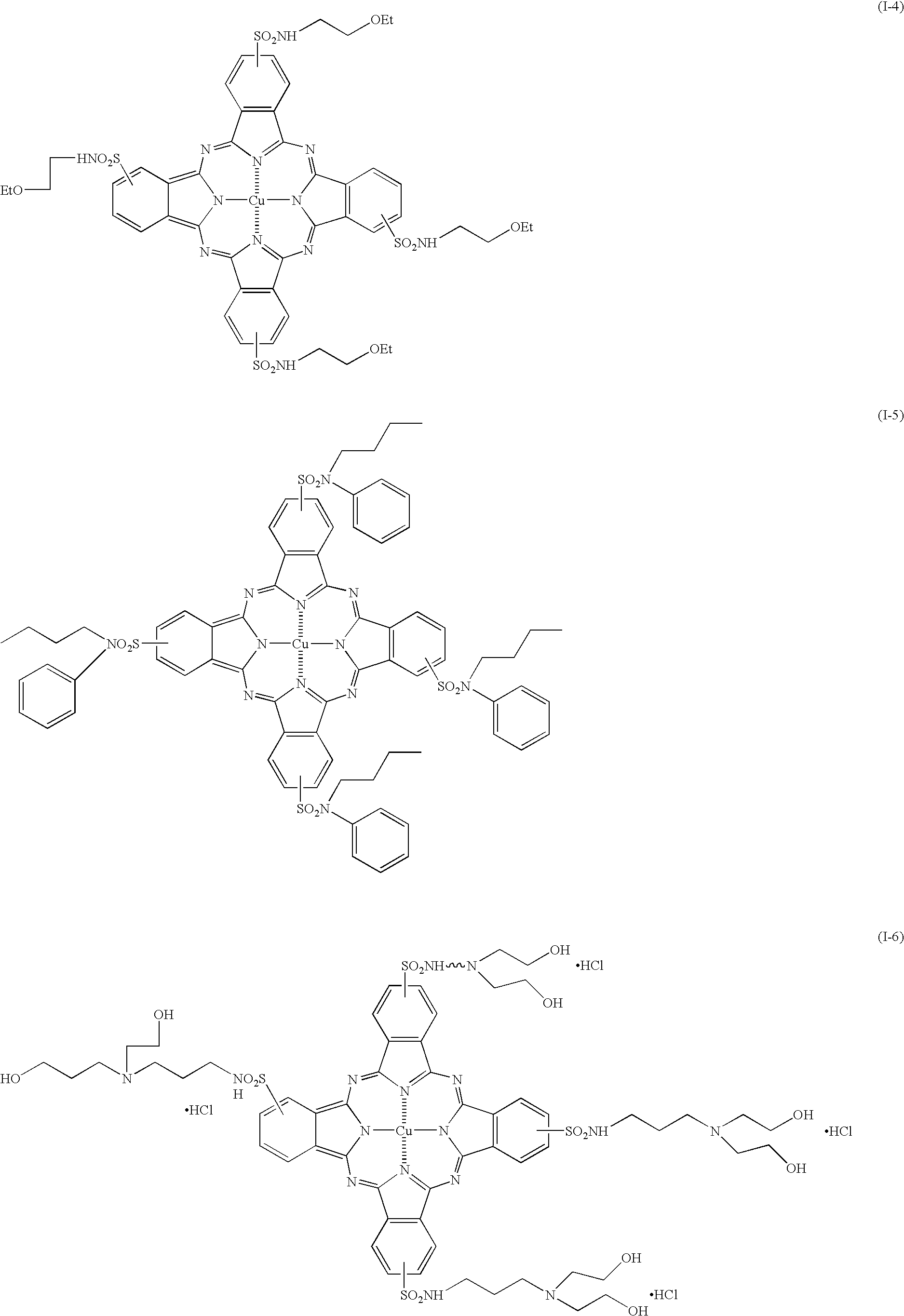

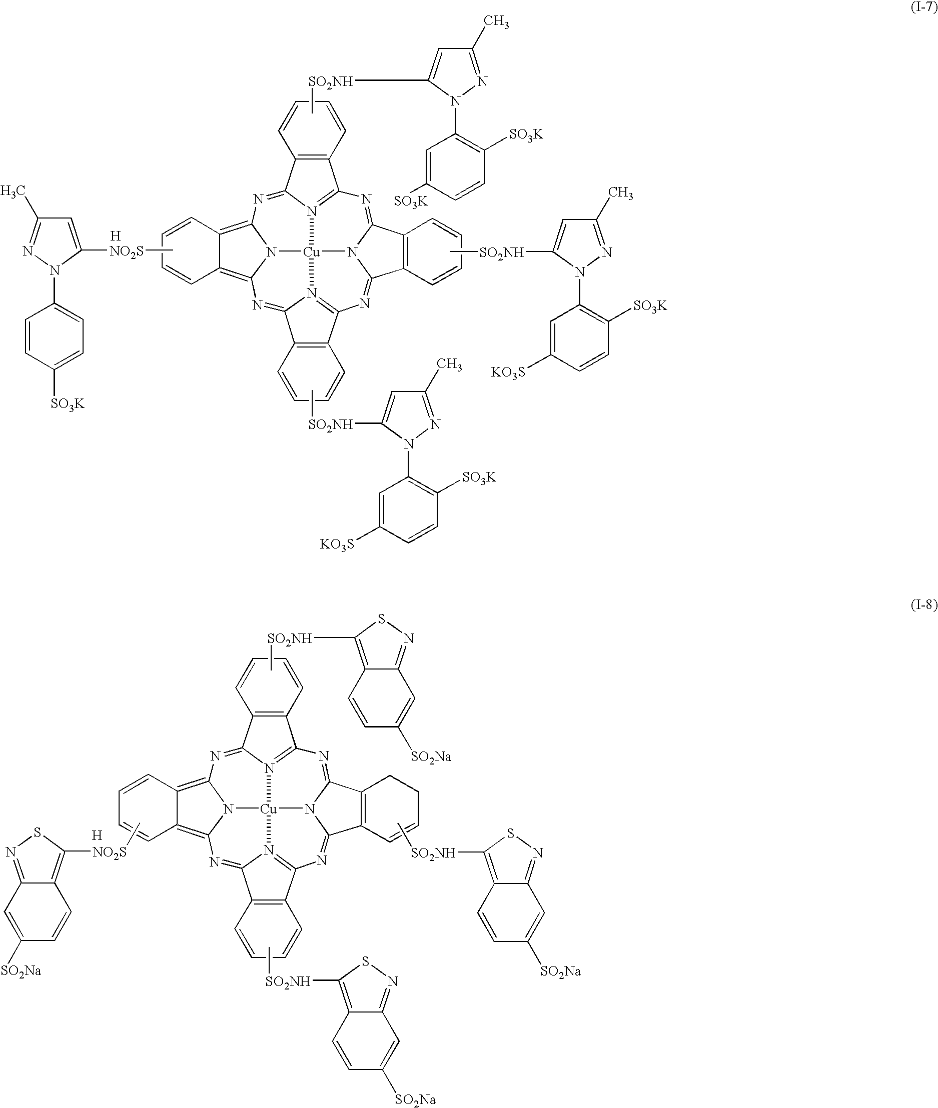

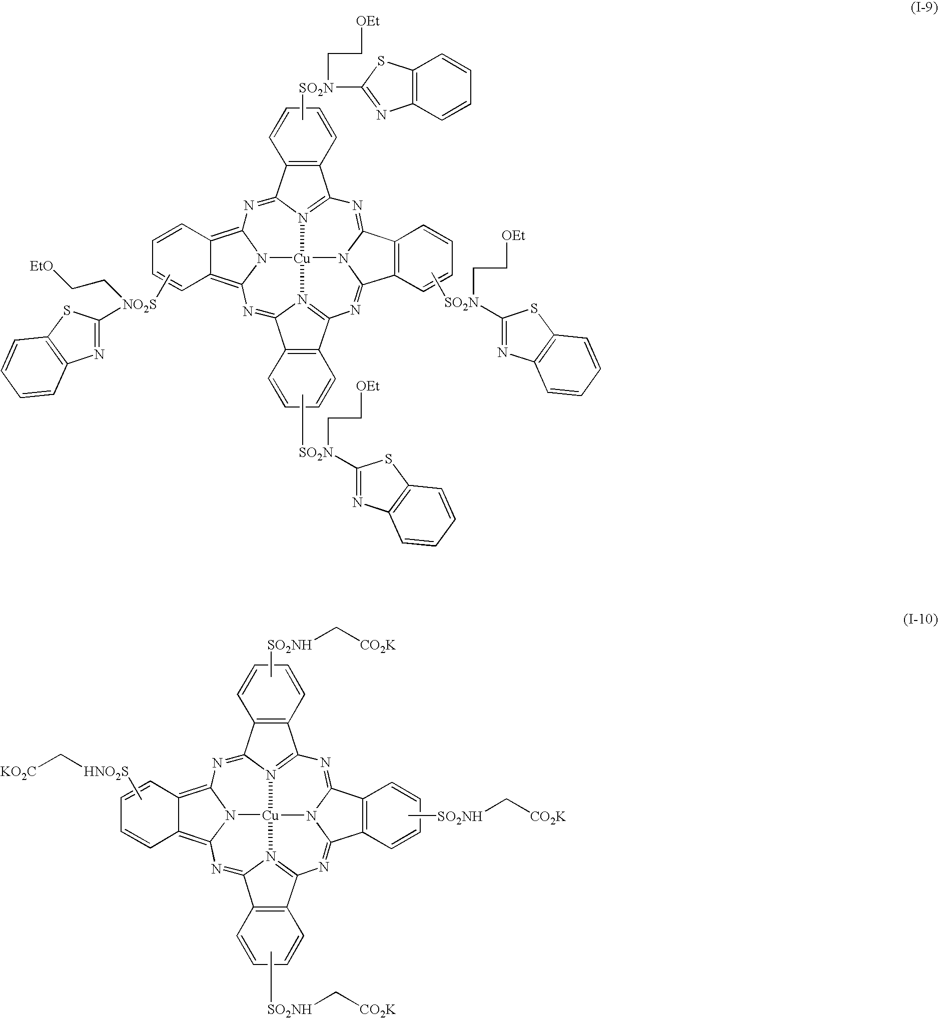

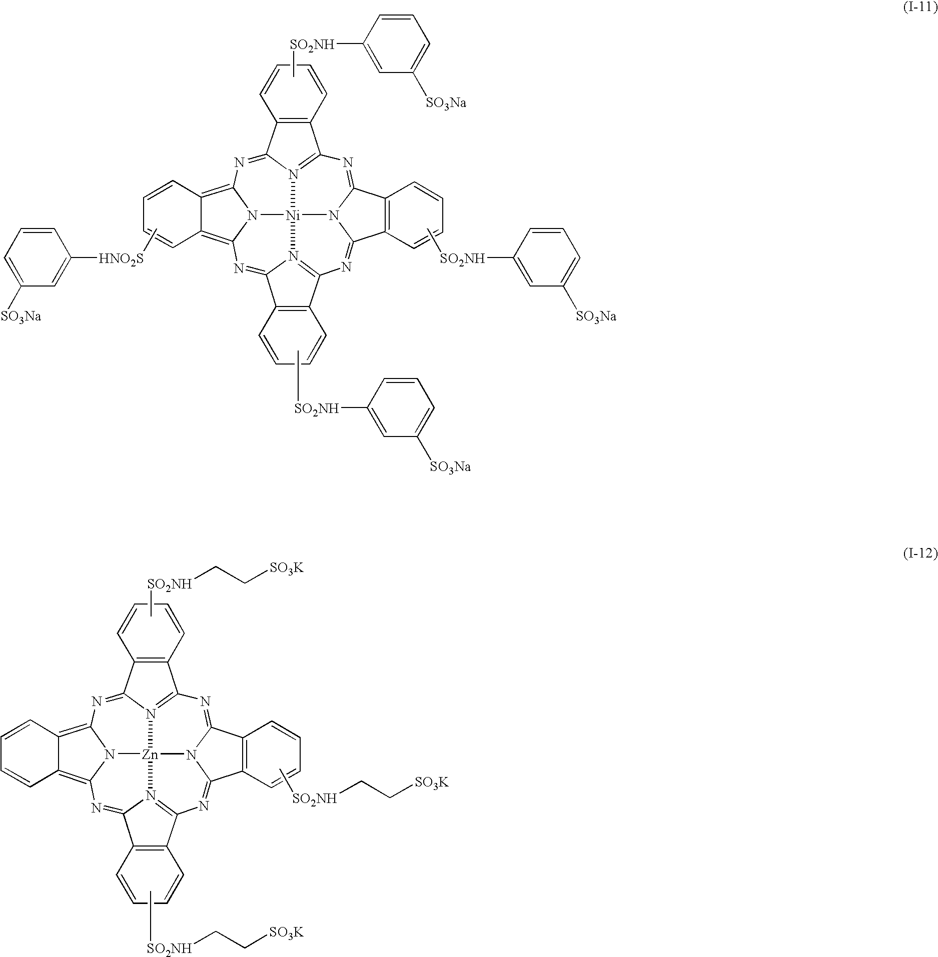

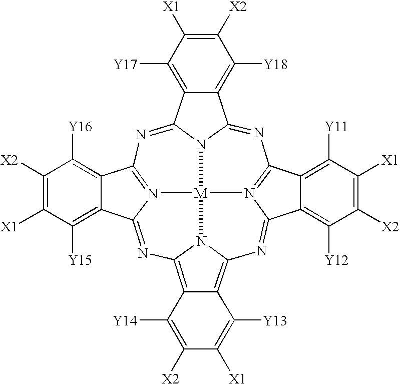

| Compd. No. | M | X1 | X2 | Y11, Y12 | Y13, Y14 | Y15, Y16 | Y17, Y18 |
|---|---|---|---|---|---|---|---|
| 101 | Cu | —SO₂—NH—CH₂—CH₂—SO₃Li | —H | —H, —H | —H, —H | —H, —H | —H, —H |
| 102 | Cu | 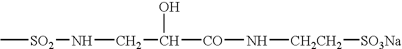 | —H | —Cl, —H | —Cl, —H | —Cl, —H | —Cl, —H |
| 103 | Cu | 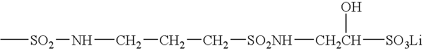 | —H | —H, —H | —H, —H | —H, —H | —H, —H |
| 104 | Cu | 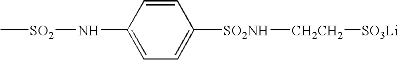 | —H | —H, —H | —H, —H | —H, —H | —H, —H |
| 105 | Ni | 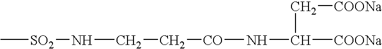 | —H | —Cl, —H | —Cl, —H | —Cl, —H | —Cl, —H |
| 106 | Cu | —SO₂—NH—CH₂—CH₂—SO₂—NH—CH₂—COONa | —CN | —H, —H | —H, —H | —H, —H | —H, —H |
| 107 | Cu | 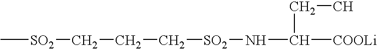 | —H | —H, —H | —H, —H | —H, —H | —H, —H |
| 108 | Cu | —SO₂—CH₂—CH₂—CH₂—SO₃Li | —H | —H, —H | —H, —H | —H, —H | —H, —H |
| 109 | Cu | —SO₂—CH₂—CH₂—CH₂—SO₃K | —H | —H, —H | —H, —H | —H, —H | —H, —H |
| 110 | Cu | —SO₂—(CH₂)₆—CO₂K | —H | —H, —H | —H, —H | —H, —H | —H, —H |

In the table, specific examples are shown in random order independently in each of sets (X1, X2), (Y11, Y12), (Y13, Y14), (Y15, Y16) and (Y17, Y18).

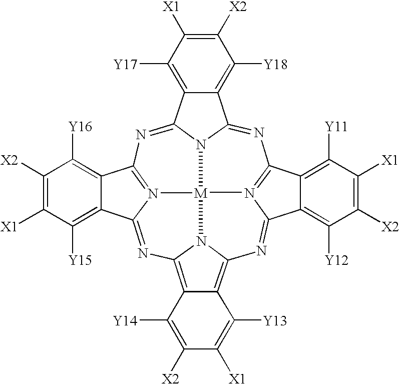

| Compd. | | | | | | | |
|---|---|---|---|---|---|---|---|
| No. | M | X1 | X2 | Y11, Y12 | Y13, Y14 | Y15, Y16 | Y17, Y18 |
| 111 | Cu | 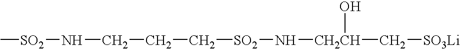 | —H | —H, —H | —H, —H | —H, —H | —H, —H |
| 112 | Cu | 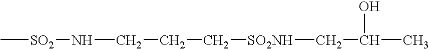 | —SO₃Li | —H, —H | —H, —H | —H, —H | —H, —H |
| 113 | Cu | 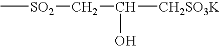 | —H | —H, —H | —H, —H | —H, —H | —H, —H |
| 114 | Cu | 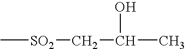 | —SO₃Li | —H, —H | —H, —H | —H, —H | —H, —H |
| 115 | Cu | 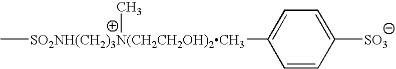 | —H | —H, —H | —H, —H | —H, —H | —H, —H |
| 116 | Cu | 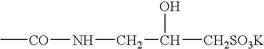 | —H | —H, —H | —H, —H | —H, —H | —H, —H |
| 117 | Cu | 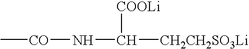 | —H | —H, —H | —H, —H | —H, —H | —H, —H |

In the table, specific examples are shown in random order independently in each of sets (X1, X2), (Y11, Y12), (Y13, Y14), (Y15, Y16) and (Y17, Y18).

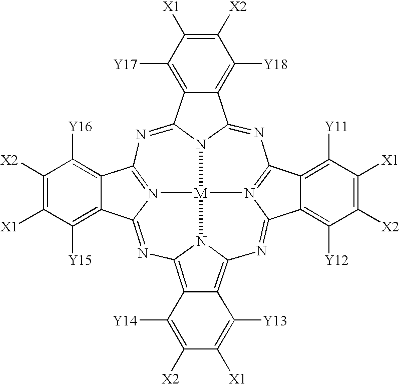

| Compd. No. | M | X1 | X2 | Y11, Y12 | Y13, Y14 | Y15, Y16 | Y17, Y18 |
|---|---|---|---|---|---|---|---|
| 118 | Cu | 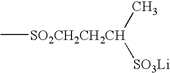 | —H | —H, —H | —H, —H | —H, —H | —H, —H |
| 119 | Cu | 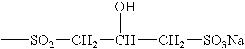 | —H | —H, —H | —H, —H | —H, —H | —H, —H |
| 120 | Cu | 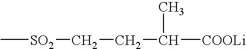 | —H | —H, —H | —H, —H | —H, —H | —H, —H |
| 121 | Cu | 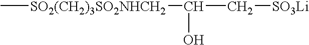 | —H | —H, —H | —H, —H | —H, —H | —H, —H |
| 122 | Cu | 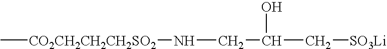 | —H | —H, —H | —H, —H | —H, —H | —H, —H |
| 123 | Cu | —SO₂NH—C₈H₁₇(t) | —H | —H, —H | —H, —H | —H, —H | —H, —H |
| 124 | Cu | 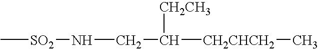 | —H | —H, —H | —H, —H | —H, —H | —H, —H |

In the table, specific examples are shown in random order independently in each of sets (X1, X2), (Y11, Y12), (Y13, Y14), (Y15, Y16) and (Y17, Y18).

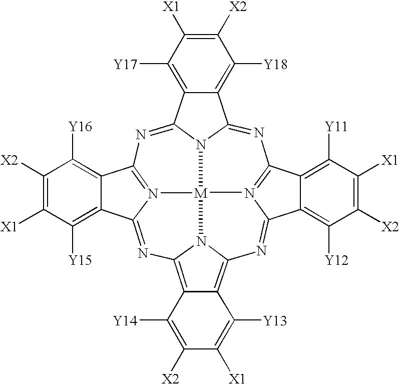

| Compd. No. | M | X1 | X2 | Y11, Y12 | Y13, Y14 | Y15, Y16 | Y17, Y18 |
|---|---|---|---|---|---|---|---|
| 125 | Cu | 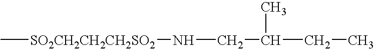 | —H | —H, —H | —H, —H | —H, —H | —H, —H |
| 126 | Cu | 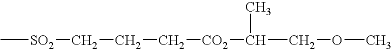 | —H | —H, —H | —H, —H | —H, —H | —H, —H |
| 127 | Cu | 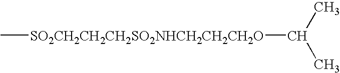 | —H | —H, —H | —H, —H | —H, —H | —H, —H |
| 128 | Zn | 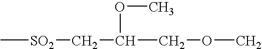 | —CN | —H, —H | —H, —H | —H, —H | —H, —H |
| 129 | Cu | 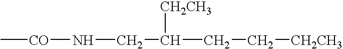 | —H | —Cl, —H | —Cl, —H | —Cl, —H | —Cl, —H |
| 130 | Cu | 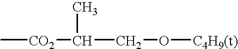 | —H | —H, —H | —H, —H | —H, —H | —H, —H |
| 131 | Cu | 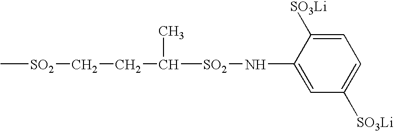 | —H | —H, —H | —H, —H | —H, —H | —H, —H |

In the table, specific examples are shown in random order independently in each of sets (X1, X2), (Y11, Y12), (Y13, Y14), (Y15, Y16) and (Y17, Y18).

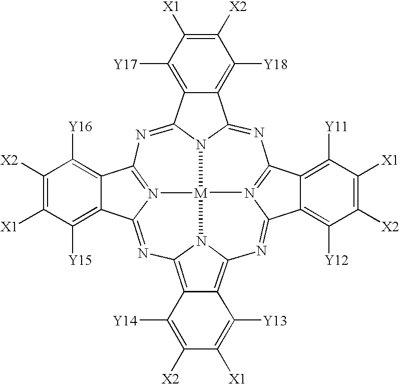

| Compd. | | | | | | | |
|---|---|---|---|---|---|---|---|
| No. | M | X1 | X2 | Y11, Y12 | Y13, Y14 | Y15, Y16 | Y17, Y18 |
| 132 | Cu | 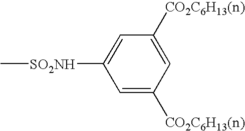 | —H | —H, —H | —H, —H | —H, —H | —H, —H |
| 133 | Cu | 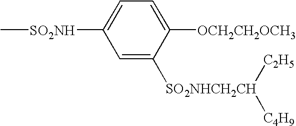 | —H | —H, —H | —H, —H | —H, —H | —H, —H |
| 134 | Cu | 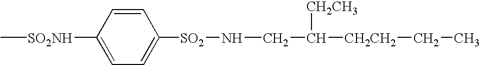 | —H | —H, —H | —H, —H | —H, —H | —H, —H |
| 135 | Cu | 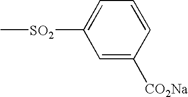 | —H | —H, —H | —H, —H | —H, —H | —H, —H |
| 136 | Cu | 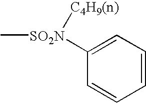 | —H | —H, —H | —H, —H | —H, —H | —H, —H |

In the table, specific examples are shown in random order independently in each of sets (X1, X2), (Y11, Y12), (Y13, Y14), (Y15, Y16) and (Y17, Y18).

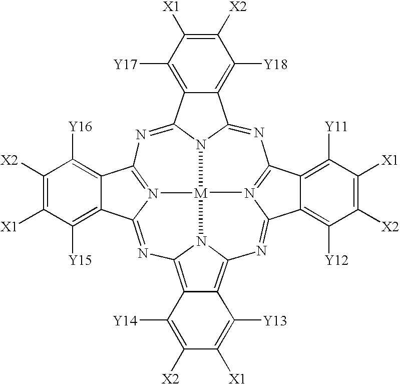

| Compd. | | | | | | | |
|---|---|---|---|---|---|---|---|
| No. | M | X1 | X2 | Y11, Y12 | Y13, Y14 | Y15, Y16 | Y17, Y18 |
| 137 | Cu | 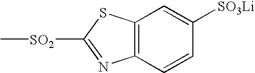 | —H | —H, —H | —H, —H | —H, —H | —H, —H |
| 138 | Cu | 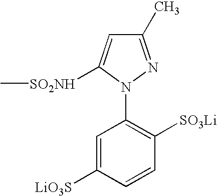 | —H | —H, —H | —H, —H | —H, —H | —H, —H |
| 139 | Cu | 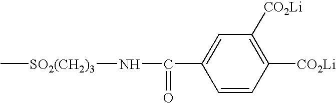 | —Cl | —H, —H | —H, —H | —H, —H | —H, —H |
| 140 | Cu | 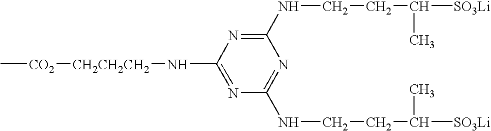 | —H | —H, —H | —H, —H | —H, —H | —H, —H |

In the table, specific examples are shown in random order independently in each of sets (X1, X2), (Y11, Y12), (Y13, Y14), (Y15, Y16) and (Y17, Y18).

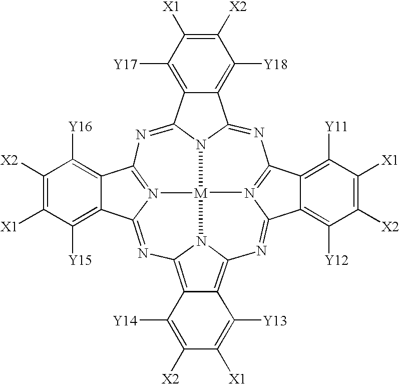

| Compd. | | | | | | | |
|---|---|---|---|---|---|---|---|
| No. | M | X1 | X2 | Y11, Y12 | Y13, Y14 | Y15, Y16 | Y17, Y18 |
| 141 | Cu | 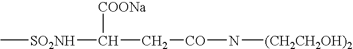 | —H | —H, —H | —H, —H | —H, —H | —H, —H |
| 142 | Cu | 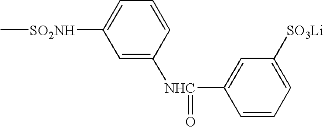 | —H | —H, —H | —H, —H | —H, —H | —H, —H |
| 143 | Cu | 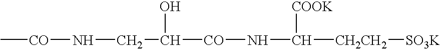 | —H | —H, —H | —H, —H | —H, —H | —H, —H |
| 144 | Cu | 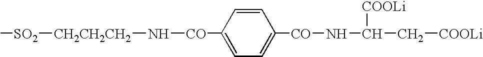 | —H | —H, —H | —H, —H | —H, —H | —H, —H |
| 145 | Cu | —SO₂CH₂CH₂OCH₂CH₂OCH₂CH₂SO₃Li | —H | —H, —H | —H, —H | —H, —H | —H, —H |

In the table, specific examples are shown in random order independently in each of sets (X1, X2), (Y11, Y12), (Y13, Y14), (Y15, Y16) and (Y17, Y18).

M-PC(R₁)ₘ(R₂)ₙ

| Compd. No. | M | R₁ | m | R₁ | n |
|---|---|---|---|---|---|
| 146 | Cu | 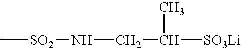 | 3 | 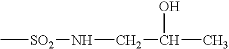 | 1 |
| 147 | Cu | —SO₂—NH—CH₂—CH₂SO₃Li | 3 | 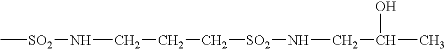 | 1 |
| 148 | Cu | 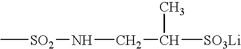 | 3 | —SO₂NH—CH₂—CH₂—CH₂—SO₂—NH—CH₂—CH₂—O—CH₂—CH₂—OH | 1 |
| 149 | Cu | 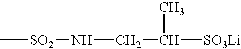 | 2 | 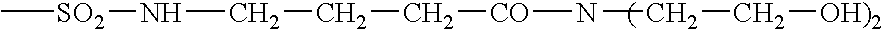 | 2 |
| 150 | Cu | —SO₂—NH—CH₂—CH₂—SO₂—NH—CH₂CH₂—COONa | 3 | 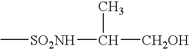 | 1 |
| 151 | Cu | 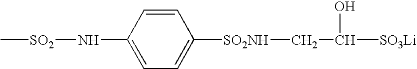 | 3 | —SO₂NH—CH₂—CH₂—O—CH₂—CH₂—OH | 1 |
| 152 | Cu | 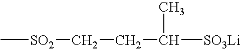 | 2.5 | —SO₂—CH₂—CH₂—O—CH₂—CH₂—OH | 1.5 |
| 153 | Cu | 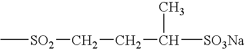 | 2 | 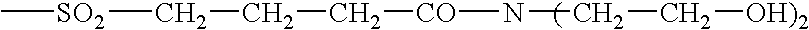 | 2 |
| 154 | Cu | —SO₂—CH₂—CH₂—CH₂—SO₃Li | 3 | 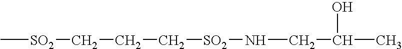 | 1 |
| 155 | Cu | —SO₂—CH₂—CH₂—CH₂—COOK | 2 | 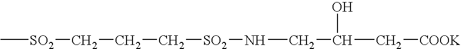 | 2 |
| 156 | Cu | —SO₂—CH₂—CH₂—CH₂—SP₃Li | 3 | 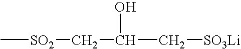 | 1 |
| 157 | Cu | —SO₂—CH₂—CH₂—O—CH₂—CH₂—SO₃Li | 2 | 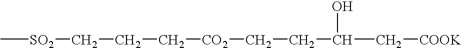 | 2 |
| 158 | Cu | 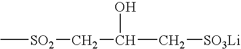 | 3 | 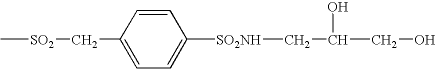 | 1 |
| 159 | Cu | —SO₂NHCH₂CH₂—SO₃Li | 3 | 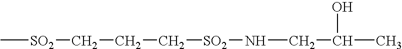 | 1 |
| 160 | Cu | —SO₂—CH₂—CH₂—O—CH₂—CH₂—O—CH₂—CH₂—SO₃Na | 3 | 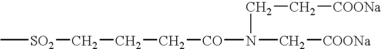 | 1 |
| 161 | Cu | —SO₂CH₂CH₂CH₂SO₃Li | 3 | 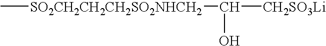 | 1 |
| 162 | Cu | —SO₂CH₂CH₂CH₂SO₃Li | 2 | —SO₂CH₂CH₂OCH₂CH₂OCH₂CH₂OH | 2 |
| 163 | Cu | —SO₂CH₂CH₂CH₂SO₃K | 3 | 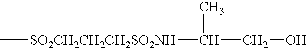 | 1 |
| 164 | Cu | —SO₂CH₂CH₂CH₂SO₃Li | 2 | —SO₂CH₂CH₂CH₂SO₂N(CH₂CH₂OH)₂ | 2 |
| 165 | Cu | —CO—NH—CH₂—CH₂—SO₃K | 3 | —CO—NH—CH₂—CH₂—O—CH₂—CH₂—CH | 1 |
| 166 | Cu | —CO—NH—CH₂—CH₂—SO₂—NH—CH₂—CH₂—COONa | 3 | 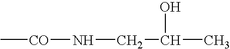 | 1 |
| 167 | Cu | 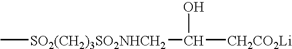 | 2.5 | 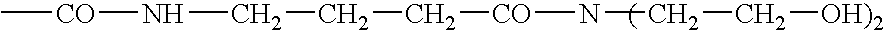 | 1.5 |
| 168 | Cu | 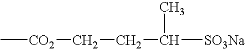 | 2 | 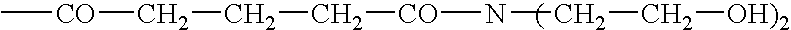 | 2 |
| 169 | Cu | —CO₂—CH₂—CH₂—CH₂—SO₃Li | 3 | 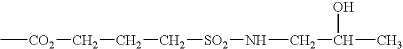 | 1 |
| 170 | Cu | —CO₂—CH₂—CH₂—CH₂COOK | 2 | 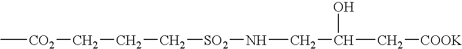 | 2 |
| 171 | Cu | —CO₂—CH₂—CH₂—O—CH₂—CH₂—O—CH₂—CH₂—SO₃Na | 3 | 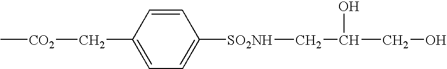 | 1 |
| 172 | Cu | —SO₂CH₂CH₂OCH₂CH₂O—CH₂CH₂SO₃K | 2 | 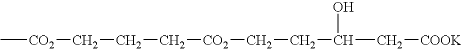 | 2 |
| 173 | Cu | 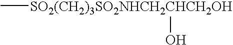 | 2 | 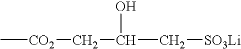 | 2 |
| 174 | Cu | 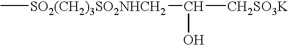 | 3 | 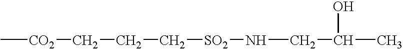 | 1 |
| 175 | Cu | —SO₂(CH₂)₃SO₂NH(CH₂)₃N(CH₂CH₂OH)₂ | 2 | 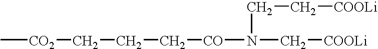 | 2 |
| 176 | Cu | 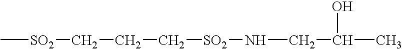 | 3 | 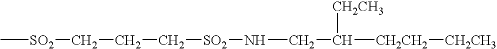 | 1 |
| 177 | Cu | —SO₂—CH₂—CH₂—O—CH₂—CH₂—O—CH₃ | 2 | 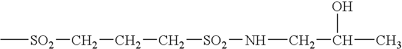 | 1 |
| 178 | Cu | —SO₂—CH₂—CH₂—O—CH₂—CH₂—O—CH₂—CH₂—OH | 3 | 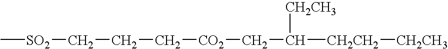 | 1 |
| 179 | Cu | 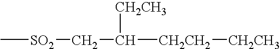 | 2 | 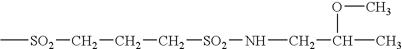 | 2 |
| 180 | Cu | 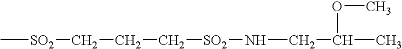 | 3 | —SO₂NH—CH₂—CH₂—SO₂NH—CH₂—CH₂—O—CH₂—CH₂—OH | 1 |
| 181 | Cu | 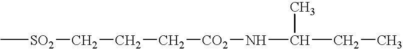 | 3 | 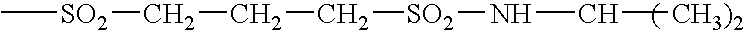 | 1 |
| 182 | Cu | 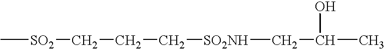 | 2.5 | 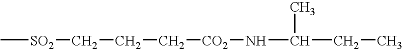 | 1.5 |
| 183 | Cu | 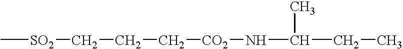 | 2 | —SO₂—CH₂—CH₂—CH₂—SO₂—NH—(CH₂)₃—CH₃—O—CH₂CH₂—OH | 2 |
| 184 | Cu | 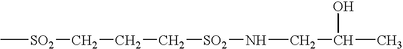 | 3 | —SO₂—CH₂—CH₂—O—CH₂—CH₂—O—CH₃ | 1 |
| 185 | Cu | 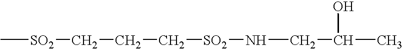 | 3 | —SO₂—CH₂—CH₂—O—CH₂—CH₂—O—CH₂—CH₂—O—CH₃ | 1 |
| 186 | Cu | 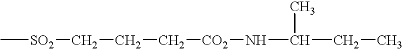 | 3 | —SO₂—CH₂—CH₂—O—CH₂—CH₂—O—CH₂—CH₂—OH | 1 |
| 187 | Cu | 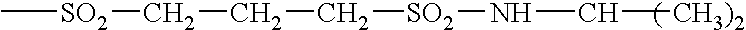 | 3 | 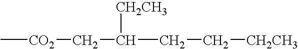 | 1 |
| 188 | Cu | 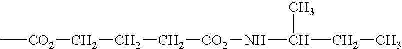 | 3 | —CO₂—CH₂—CH₂—O—CH₂—CH₂—O—CH₃ | 1 |
| 189 | Cu | 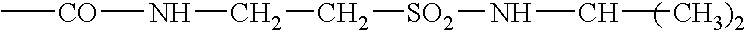 | 3 | 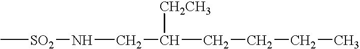 | 1 |
| 190 | Cu | 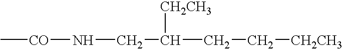 | 3 | —CO—NH—CH₂—CH₂—O—CH₂—CH₂—O—CH₃ | 1 |

In the table, substituents (R₁) and (R₂) are random in the order of introducing positions in β-position substituent.

The phthalocyanine compound, indicated by M-Pc(Xp1)ₘ(Xp2)ₙ, of compound Nos. 146-190 have a following structure.

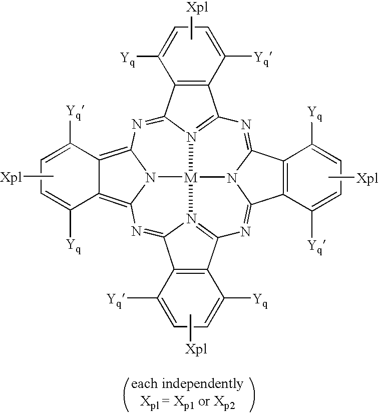

The phthalocyanine dye represented by the general formula (2) can be synthesized according to the aforementioned patent references. Also the phthalocyanine dye represented by the general formula (5) can be synthesized, in addition to the aforementioned synthesizing methods, by methods described in JP-A Nos. 2001-226275, 2001-96610, 2001-47013 and 2001-193638. A starting material, a dye intermediate and a synthesizing route are not restricted to those described in the foregoing.

The phthalocyanine dye represented by the general formula (2) is preferably used with a content in the ink of 0.2 to 20 mass %, more preferably 0.5 to 15 mass %.

[Magenta Dye]

A magenta dye to be employed in the invention is preferably an azo dye having an absorption maximum within a spectral range of 500 to 580 nm in an aqueous medium and having an oxidation potential higher than 1.0 V (vs. SCE).

Such azo dye serving as the magenta dye has, as a first preferred structural feature of dye, a chromophore represented by a general formula: (heterocycle A)-N═N-(heterocycle B). In this case, the heterocycle A and heterocycle B may have a same structure. Each of the heterocycle A and the heterocycle B is a 5- or 6-membered heterocycle selected from pyrazole, imidazole, triazole, oxazole, thiazole, selenazole, pyrridone, pyradine, pyrimidine and pyridine. Specific examples are described for example in JP-A No. 2001-279145, Japanese Patent Application No. 2001-15614, JP-A Nos. 2002-309116 and 2002-371214.

Further, a second preferred structural feature of the azo dye is that the azo group is directly connected, at least at an end thereof, with an aromatic nitrogen-containing 6-membered aromatic heterocycle as a coupling component, and specific examples are described in JP-A No. 2002-371214.

A third preferred structural feature is that an auxochrome has a structure of an aromatic cyclic amino group or a heterocyclic amino group, more specifically an anilino group or a heterylamino group.

A fourth preferred structural feature is the presence of a steric structure, which is more specifically described in Japanese Patent Application No. 2002-12015.

Providing the azo dye with the aforementioned structural features allows to increase the oxidation potential of the dye and to improve the ozone resistance. Means for increasing the oxidation potential can be an elimination of an α-hydrogen of the azo dye. The azo dye of the general formula (3) is preferable also from the standpoint of increasing the oxidation potential. Means for increasing the oxidation potential of the azo dye is described in Japanese Patent Application No. 2001-254878.

The magenta ink of the invention, utilizing the azo dye having the aforementioned features, preferably has λmax (wavelength of absorption maximum) within a range of 500 to 580 nm in terms of color hue, and has a small half-peak width at the longer wavelength side and the shorter wavelength side of the absorption maximum, namely a sharp absorption. A specific description is given in JP-A No. 2002-309133. It is also possible to obtain a sharper absorption by employing the azo dye of the general formula (3) and introducing a methyl group in the α-position thereof.

Also a magenta ink utilizing such azo dye preferably has a forced fading rate constant, to ozone gas, of 5.0×10⁻² [hour⁻¹] or less, more preferably 3.0×10⁻² [hour⁻¹] or less, and particularly preferably 1.5×10⁻² [hour⁻¹] or less.

In the measurement of the forced fading rate constant to ozone gas, a colored area having a color of a main spectral absorption region of the magenta ink in an image, obtained by printing the magenta ink only on a reflective image receiving medium, and having a reflective density of 0.90-1.10 measured through a status A filter, is selected as an initial density point, and such initial density is taken as a starting density (=100%). This image is subjected to a fading in an ozone fading tester which constantly maintains an ozone concentration of 5 mg/L to measure a time required for reaching a density corresponding to 80% of the initial density, and a reciprocal [hour⁻¹] of such time is determined and taken as the fading rate constant on an assumption that the faded density and the time follow a first-order reaction rate equation.

A print patch for testing can be a patch printed with black square marks according to JIS code 2223, a stepped color patch of Macbeth chart, or an arbitrary stepped density patch capable of providing an area for measurement.

A reflective density of the reflective image (stepped color patch) printed for measurement is a density determined through a status A filter in a densitometer meeting the international standard ISO5-4 (geometrical condition for reflective density).

A test chamber for the measurement of the forced fading rate constant to ozone gas is provided with an ozone generating apparatus (for example of a high-voltage discharge type for applying an AC voltage to dry air), capable of maintaining an internal ozone gas concentration constantly at 5 mg/L, and an exposure temperature is maintained at 25° C.

The forced fading rate constant is an index of susceptibility to oxidation by an oxidative atmosphere in the environment such as photochemical smog, automotive exhaust gas, organic vapor from a coated surface of furniture or a carpet, gas generated in a picture frame in a sunny room etc., in which such oxidative atmosphere is represented by ozone gas.

In the following, an explanation will be given on a dye represented by a general formula (3) and constituting an azo dye to be employed in the present invention.

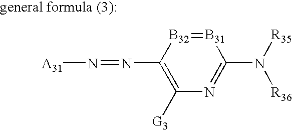

In the general formula (3), A₃₁ represents a 5-membered heterocyclic group.

B₃₁ and B₃₂ each represents ═CR₃₁— or —CR₃₂═, or either one represents a nitrogen atom while the other represents ═CR₃₁— or —CR₃₂═.

R₃₅ and R₃₆ each independently represents a hydrogen atom or a substituent, which represents an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group, and a hydrogen atom in each substituent may be substituted.

G₃, R₃₁ and R₃₂ each independently represents a hydrogen atom or a substituent, which represents a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxy group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group, an acylamino group, an ureido group, a sulfamoylamino group, an alkoxycarbonylamino group, an aryloxycarbonylamino group, an alkylsulfonylamino group, an arylsulfonylamino group, a heterocyclic sulfonylamino group, a nitro group, an alkylthio group, an arylthio group, a heterocyclic thio group, an alkylsulfonyl group, an arylsulfonyl group, a heterocyclic sulfonyl group, an alkylsulfinyl group, an arylsulfinyl group, a heterocyclic sulfinyl group, a sulfamoyl group, or a sulfo group, and a hydrogen atom of each substituent may be further substituted.

R₃₁ and R₃₅, or R₃₅ and R₃₆ may be bonded to form a 5- or 6-membered ring.

In the general formula (3), A₃₁ represents a 5-membered heterocyclic group, and a hetero atom thereof can be N, O or S. It is preferably a nitrogen-containing 5-membered heterocycle, to which an aliphatic ring, an aromatic ring or another heterocycle may be condensed.

Preferred examples of the heterocycle A₃₁ include a pirazole ring, an imidazole ring, a thiazole ring, an isothiazole ring, a thiadiazole ring, a benzothiazole ring, a benzoxazole ring, and a benzisothiazole ring. Each heterocyclic ring may further have a substituent. Among these, there are preferred a pirazole ring, an imidazole ring, an isothiazole ring, a thiadiazole ring and a benzothiazole ring represented by following general formulas (a) to (f).

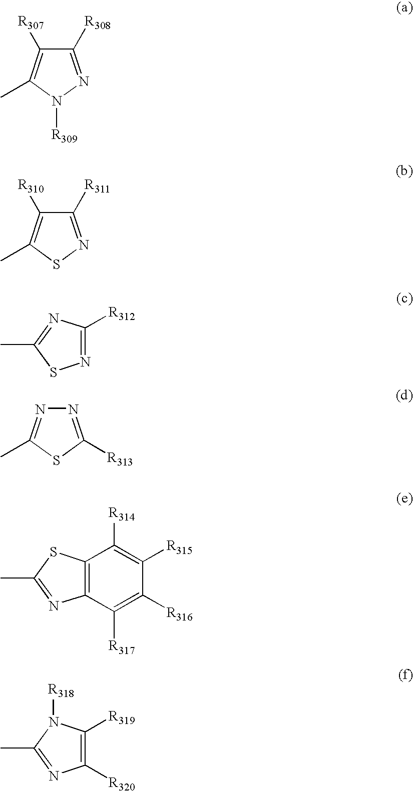

In the general formulas (a) to (f), R₃₀₇ to R₃₂₀ represent substituents same as G₃, R₃₁ and R₃₂ in the general formula (3).

Among the general formulas (a) to (f), a pirazole ring and an isothiazole ring represented by the general formulas (a) and (b) are preferred, and a pirazole ring represented by the general formula (a) is most preferred.

In the general formula (3), B₃₁ and B₃₂ each represents ═CR₃₁— or —CR₃₂═, or either one represents a nitrogen atom while the other represents ═CR₃₁— or —CR₃₂═, but there is more preferred a case where each represents ═CR₃₁— or —CR₃₂═.

R₃₅ and R₃₆ each can preferably be a hydrogen atom, an aliphatic group, an aromatic group, a heterocyclic group, an acyl group, an alkyl- or aryl-sulfonyl group. More preferably it is a hydrogen atom, an aromatic group, a heterocyclic group, an acyl group, an alkyl- or aryl-sulfonyl group. Most preferably it is a hydrogen atom, an aryl group, or a heterocyclic group. A hydrogen atom of such substituent may be substituted. However, R₃₅ and R₃₆ do not become hydrogen atoms at the same time.

G₃ is preferably a hydrogen atom, a halogen atom, an aliphatic group, an aromatic group, a hydroxy group, an alkoxy group, an aryloxy group, an acyloxy group, a heterocyclic oxy group, an amino group, an acylamino group, an ureido group, a sulfamoylamino group, an alkoxycarbonylamino group, an aryloxycarbonylamino group, an alkyl- or aryl-thio group, or a heterocyclic thio group, more preferably a hydrogen atom, a halogen atom, an alkyl group, a hydroxy group, an alkoxy group, an aryloxy group, an acyloxy group, an amino group, or an acylamino group, and most preferably a hydrogen atom, an amino group (preferably an anilino group) or an acylamino group. A hydrogen atom of each substituent may be substituted.

Each of R₃₁ and R₃₂ can preferably be a hydrogen atom, an alkyl group, a halogen atom, an alkoxycarbonyl group, a carboxyl group, a carbamoyl group, a hydroxyl group, an alkoxy group, or a cyano group. A hydrogen atom of each substituent may be substituted.

Also R₃₁ and R₃₅, or R₃₅ and R₃₆ may be bonded to form a 5- or 6-membered ring.

In case A₃₁ has a substituent, or a substituent of R₃₁, R₃₂, R₃₅, R₃₆ or G₃ further has a substituent, examples of such substituent can be same as those for G₃, R₃₁ and R₃₂ cited before.

In case the dye represented by the general formula (3) is a water-soluble dye, it preferably further has an ionic hydrophilic group as a substituent in any position on A₃₁, R₃₁, R₃₂, R₃₅, R₃₆ or G₃. The ionic hydrophilic group as such substituent can be a sulfo group, a carboxyl group, a phosphono group or a quaternary ammonium group. The ionic hydroplilic group is preferably a carboxyl group, a phosphono group or a sulfo group, particularly preferably a carboxyl group or a sulfo group. The carboxyl group, the phosphono group or the sulfo group may be in a state of a salt, and a counter ion forming the salt can be an ammonium ion, an alkali metal ion (such as lithium ion, sodium ion, or potassium ion), or an organic cation (such as tetramethylammonium ion, tetramethylguanidium ion or tetramethylphosphonium).

Now, there will be given an explanation for a term “substituent” used in the explanation of the general formula (3). Such term is commonly applicable to the general formula (3) and a general formula (3-A) to be explained later.

A halogen atom means a fluorine atom, a chlorine atom or a bromine atom.

An aliphatic group means an alkyl group, a substituted alkyl group, an alkenyl group, a substituted alkenyl group, an alkinyl group, a substituted alkinyl group, an aralkyl group or a substituted aralkyl group. A term “substituted” used for example in “substituted alkyl group” or the like means that a hydrogen atom present in the “alkyl group” or the like is substituted with a substituent cited for G₃, R₃₁ and R₃₂ in the foregoing.

The aliphatic group may be branched or may form a ring. The aliphatic group preferably has 1 to 20 carbon atoms, further preferably 1 to 16 carbon atoms. An aryl portion of the aralkyl group or the substituted aralkyl group is preferably a phenyl group or a naphthyl group, particularly preferably a phenyl group. Examples of the aliphatic group include a methyl group, an ethyl group, a butyl group, an isopropyl group, a t-butyl group, a hydroxyethyl group, a methoxyethyl group, a cyanoethyl group, a trifluoromethyl group, a 3-sulfopropyl group, a 4-sulfobutyl group, a cyclohexyl group, a benzyl group, a 2-phenethyl group, a vinyl group and an allyl group.

An aromatic group means an aryl group or a substituted aryl group. The aryl group is preferably a phenyl group or a naphthyl group, particularly preferably a phenyl group. The aromatic group preferably has 6 to 20 carbon atoms, further preferably 6 to 16 carbon atoms.

Examples of the aromatic group include a phenyl group, a p-tolyl group, a p-methoxyphenyl group, an o-chlorophenyl group and a m-(3-sulfopropylamino)phenyl group.

A heterocyclic group includes a substituted heterocyclic group. The heterocyclic group may have a heterocyclic structure to which an aliphatic ring, an aromatic ring or another heterocycle is condensed. The heterocyclic group is preferably a 5- or 6-membered heterocyclic group. Examples of the substituent include an aliphatic group, a halogen atom, an alkylsulfonyl group, an arylsulfonyl group, an acyl group, an acylamino group, a sulfamoyl group, a carbamoyl group, and an ionic hydrophilic group. Examples of the heterocyclic group include a 2-pyridyl group, a 2-thienyl group, a 2-thiazolyl group, a 2-benzothiazolyl group, a 2-benzoxazolyl group and a 2-furyl group.

A carbamoyl group includes a substituted carbamoyl group. Examples of the substituent include an alkyl group. Also examples of the carbamoyl group include a methylcarbamoyl group and a dimethylcarbamoyl group.

An alkoxycarbonyl group includes a substituted alkoxycarbonyl group. The alkoxycarbonyl group preferably has 2 to 20 carbon atoms. Examples of the substituent include an ionic hydrophilic group. Examples of the alkoxycarbonyl group include a methoxycarbonyl group and an ethoxycarbonyl group.

An aryloxycarbonyl group includes a substituted aryloxycarbonyl group. The aryloxycarbonyl group preferably has 7 to 20 carbon atoms. Examples of the substituent include an ionic hydrophilic group. Examples of the aryloxycarbonyl group include a phenoxycarbonyl group.

A heterocyclic oxycarbonyl group includes a substituted heterocyclic oxycarbonyl group. The heterocycle structure can be those cited for the heterocyclic group. The heterocyclic oxycarbonyl group preferably has 2 to 20 carbon atoms. Examples of the substituent include an ionic hydrophilic group. Examples of the heterocyclic oxycarbonyl group include a 2-pyridyl oxycarbonyl group.

An acyl group includes a substituted acyl group. The acyl group preferably has 1 to 20 carbon atoms. Examples of the substituent include an ionic hydroplilic group. Examples of the acyl group include an acetyl group and a benzoyl group.

An alkoxy group includes a substituted alkoxy group. The alkoxy group preferably has 1 to 20 carbon atoms. Examples of the substituent include an alkoxy group, a hydroxyl group and an ionic hydrophilic group. Examples of the alkoxy group include a methoxy group, an ethoxy group, an isopropoxy group, a methoxyethoxy group, a hydroxyethoxy group and a 3-carboxypropoxy group.

An aryloxy group includes a substituted aryloxy group. The aryloxy group preferably has 6 to 20 carbon atoms. Examples of the substituent include an alkoxy group, and an ionic hydrophilic group. Examples of the aryloxy group include a phenoxy group, a p-methoxyphenoxy group and an o-methoxyphenoxy group.

A heterocyclic oxy group includes a substituted heterocyclic oxy group. The heterocycle structure can be those cited for the heterocyclic group in the foregoing. The heterocyclic oxy group preferably has 2 to 20 carbon atoms. Examples of the substituent include an alkyl group, an alkoxy group, and an ionic hydrophilic group. Examples of the heterocyclic oxy group include a 3-pyridyloxy group, and a 3-thienyloxy group.

A silyloxy group is preferably a silyloxy group substituted with an aliphatic group with 1 to 20 carbon atoms or with an aromatic group. Examples of such silyloxy group includes a trimethylsilyloxy group and a diphenylmethylsilyloxy group.

An acyloxy group includes a substituted acyloxy group. The acyloxy group preferably has 1 to 20 carbon atoms. Examples of the substituent include an ionic hydrophilic group. Examples of the acyloxy group include an acetoxy group and a benzoyloxy group.

A carbamoyloxy group includes a substituted carbamoyloxy group. Examples of the substituent include an alkyl group. Examples of the carbamoyloxy group include an N-methylcarbamoyl group.

An alkoxycarbonyloxy group includes a substituted alkoxycarbonyloxy group. The alkoxycarbonyloxy group preferably has 2 to 20 carbon atoms. Examples of the alkoxycarbonyloxy group include a methoxycarbonyloxy group, and an isopropoxycarbonyloxy group.

An aryloxycarbonyloxy group includes a substituted aryloxycarbonyloxy group. The aryloxycarbonyloxy group preferably has 7 to 20 carbon atoms. Examples of the aryloxycarbonyloxy group include a phenoxycarbonyloxy group.

An amino group includes a substituted amino group. The substituent can be an alkyl group, an aryl group or a heterocyclic group, and the alkyl group, the aryl group or the heterocyclic group may further have a substituent. The alkylamino group includes a substituted alkylamino group. The alkylamino group preferably has 1 to 20 carbon atoms. Examples of the substituent include an ionic hydrophilic group. Examples of the alkylamino group include a methylamino group and a diethylamino group.

An arylamino group includes a substituted arylamino group. The arylamino group preferably has 6 to 20 carbon atoms. Examples of the substituent include a halogen atom, and an ionic hydrophilic group. Examples of the arylamino group include a phenylamino group and a 2-chlorophenylamino group.

A heterocyclic amino group includes a substituted heterocyclic amino group. The heterocycle structure can be those cited for the heterocyclic group in the foregoing. The heterocyclic amino group preferably has 2 to 20 carbon atoms. Examples of the substituent include an alkyl group, a halogen atom and an ionic hydrophilic group.

An acylamino group includes a substituted acylamino group. The acylamino group preferably has 2 to 20 carbon atoms. Examples of the substituent include an ionic hydrophilic group. Examples of the acylamino group include an acetylamino group, a propionylamino group, a benzoylamino group, an N-phenylacetylamino group and a 3,5-disulfobenzoylamino group.

An ureido group includes a substituted ureido group. The ureido group preferably has 1 to 20 carbon atoms. Examples of the substituent include an alkyl group and an aryl group. Examples of the ureido group include a 3-methylureido group, a 3,3-dimethylureido group and 3-phenylureido group.

A sulfamoylamino group includes a substituted sulfamoylamino group. Examples of the substituent include an alkyl group. Examples of the sulfamoylamino group include an N,N-dipropylsulfamoylamino group.

An alkoxycarbonylamino group includes a substituted alkoxycarbonylamino group. The alkoxycarbonylamino group preferably has 2 to 20 carbon atoms. Examples of the substituent include an ionic hydrophilic group. Examples of the alkoxycarbonylamino group include an ethoxycarbonylamino group.

An aryloxycarbonylamino group includes a substituted aryloxycarbonylamino group. The aryloxycarbonylamino group preferably has 7 to 20 carbon atoms. Examples of the substituent include an ionic hydrophilic group. Examples of the aryloxycarbonylamino group include a phenoxycarbonylamino group.

An alkylsulfonylamino group and the arylsulfonylamino group include a substituted alkylsulfonylamino group and a substituted arylsulfonylamino group. The alkylsulfonylamino group and the arylsulfonylamino group preferably have 1 to 20 carbon atoms. Examples of the substituent include an ionic hydrophilic group. Examples of the alkylsulfonylamino group and the arylsulfonylamino group include a methylsulfonylamino group, an N-phenyl-methylsulfonylamino group, a phenylsulfonylamino group, and a 3-carboxyphenylsulfonylamino group.

A heterocyclic sulfonylamino group includes a substituted heterocyclic sulfonylamino group. The heterocycle structure can be those cited for the heterocyclic group in the foregoing. The heterocyclic sulfonylamino group preferably has 1 to 12 carbon atoms. Examples of the substituent include an ionic hydrophilic group. Examples of the heterocyclic sulfonylamino group include a 2-thienylsulfonylamino group, and a 3-pyridylsulfonylamino group.

An alkylthio group, an arylthio group and a heterocyclic thio group include a substituted alkylthio group, a substituted arylthio group and a substituted heterocyclic thio group. The heterocycle structure can be those cited for the heterocyclic group in the foregoing. The alkylthio group, the arylthio group and the heterocyclic thio group preferably have 1 to 20 carbon atoms. Examples of the substituent include an ionic hydrophilic group. Examples of the alkylthio group, the arylthio group and the heterocyclic thio group include a methylthio group, a phenylthio group, and a 2-pyridylthio group.

An alkylsulfonyl group and the arylsulfonyl group include a substituted alkylsulfonyl group and a substituted arylsulfonyl group. Examples of the alkylsulfonyl group and the arylsulfonyl group respectively include a methylsulfonyl group, and a phenylsulfonyl group.

A heterocyclic sulfonyl group includes a substituted heterocyclic sulfonyl group. The heterocycle structure can be those cited for the heterocyclic group in the foregoing. The heterocyclic sulfonyl group preferably has 1 to 20 carbon atoms. Examples of the substituent include an ionic hydrophilic group. Examples of the heterocyclic sulfonyl group include a 2-thienylsulfonyl group, and a 3-pyridylsulfonyl group.

An alkylsulfinyl group and the arylsulfinyl group include a substituted alkylsulfinyl group and a substituted arylsulfinyl group. Examples of the alkylsulfinyl group and the arylsulfinyl group respectively include a methylsulfinyl group and a phenylsulfinyl group.

A heterocyclic sulfinyl group includes a substituted heterocyclic sulfinyl group. The heterocycle structure can be those cited for the heterocyclic group in the foregoing. The heterocyclic sulfinyl group preferably has 1 to 20 carbon atoms. Examples of the substituent include an ionic hydrophilic group. Examples of the heterocyclic sulfinyl group include a 4-pyridylsulfinyl group.

A sulfamoyl group includes a substituted sulfamoyl group. Examples of the substituent include an alkyl group.

Examples of the sulfamoyl group include a dimethylsulfamoyl group, and a di-(2-hydroxyethyl)sulfamoyl group.

Within the general formula (3), a particularly preferable structure is represented by a general formula (3-A).

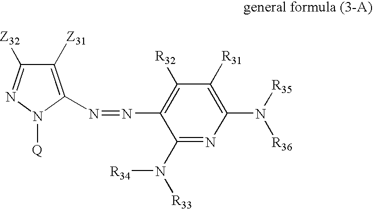

In the formula, R₃₁, R₃₂, R₃₅ and R₃₆ have the same meaning as in the general formula (3).

R₃₃ and R₃₄ each independently represents a hydrogen atom or a substituent, which can be an aliphatic group, an aromatic group, a heterocyclic group, an acyl group, an alkoxycarbonyl group, an aryloxycarbonyl group, a carbamoyl group, an alkylsulfonyl group, an arylsulfonyl group, or a sulfamoyl group. Among these, a hydrogen atom, an aromatic group, a heterocyclic group, an acyl group, an alkylsulfonyl group or an arylsulfonyl group is preferable, and a hydrogen atom, an aromatic group, or a heterocyclic group is particularly preferable.

Z₃₁ represents an electron attracting group with Hammett's substituent constant σp of 0.20 or higher. Z₃₁ is preferably an electron attracting group with σp of 0.30 or higher, more preferably an electron attracting group with σp of 0.45 or higher, particularly preferably an electron attracting group with σp of 0.60 or higher, but σp preferably does not exceed 1.0.

Specific examples of the electron attracting group with Hammett's substituent constant σp of 0.60 or higher include a cyano group, a nitro group, an alkylsulfonyl group (such as methylsulfonyl group) or an arylsulfonyl group (such as phenylsulfonyl group).

Examples of the electron attracting group with Hammett's substituent constant σp of 0.45 or higher include, in addition to those in the foregoing, an acyl group (such as acetyl group), an alkoxycarbonyl group (such as dodecyloxycarbonyl group), an aryloxycarbonyl group (such as m-chlorophenoxycarbonyl), an alkylsulfinyl group (such as n-propysulfinyl), an arylsulfinyl group (such as phenylsulfinyl), a sulfamoyl group (such as N-ethylsulfamoyl or N,N-dimethylsulfamoyl), and a halogenated alkyl group (such as trifluoromethyl).

Examples of the electron attracting group with Hammett's substituent constant σp of 0.30 or higher include, in addition to those in the foregoing, an acyloxy group (such as acetoxy), a carbamoyl group (such as N-ethylcarbamoyl or N,N-dibutylcarbamoyl), a halogenated alkoxy group (such as trifluoromethyloxy), a halogenated aryloxy group (such as pentafluorophenyloxy), a sulfonyloxy group (such as methylsulfonyloxy group), a halogenated alkylthio group (such as difluoromethylthio), an aryl group substituted with two or more electron attracting groups with σp of 0.15 or higher (such as 2,4-dinitrophenyl, or pentachlorophenyl), and a heterocycle (such as 2-benzoxazolyl, 2-benzothiazolyl or 1-phenyl-2-benzimidazolyl).

Examples of the electron attracting group with Hammett's substituent constant σp of 0.20 or higher include, in addition to those in the foregoing, a halogen atom.

Z₃₁ is preferably, among those in the foregoing, an acyl group with 2 to 20 carbon atoms, an alkyloxycarbonyl group with 2 to 20 carbon atoms, a nitro group, a cyano group, an alkylsulfonyl group with 1 to 20 carbon atoms, an arylsulfonyl group with 6 to 20 carbon atoms, a carbamoyl group with 1 to 20 carbon atoms or a halogenated alkyl group with 1 to 20 carbon atoms. It is particularly preferably a cyano group, an alkylsulfonyl group with 1 to 20 carbon atoms or an arylsulfonyl group with 6 to 20 carbon atoms, and most preferably a cyano group.

Z₃₂ represents a hydrogen atom or a substituent, which can be an aliphatic group, an aromatic group or a heterocyclic group. Z₃₂ is preferably an aliphatic group, more preferably an alkyl group with 1 to 6 carbon atoms.

Q represents a hydrogen atom or a substituent, which can be an aliphatic group, an aromatic group or a heterocyclic group. Among these, Q is preferably a non-metal atom group required for forming 5- to 8-membered ring. Such 5- to 8-membered ring may be substituted, or saturated, or may include an unsaturated bond. Among these, an aromatic group or a heterocyclic group is particularly preferable. A preferred non-metal atom can be a nitrogen atom, an oxygen atom, a sulfur atom or a carbon atom. Specific examples of such ring structure include a benzene ring, a cyclopentane ring, a cyclohexane ring, a cycloheptane ring, a cyclooctane ring, a cyclohexene ring, a pyridine ring, a pyrimidine ring, a pyrazine ring, a pyridazine ring, a triazine ring, an imidazole ring, a benzimidazole ring, an oxazole ring, a benzoxazole ring, a thiazole ring, a benzothiazole ring, an oxane ring, a sulfolane ring, and a thiane ring.

A hydrogen atom of each substituent explained in the general formula (3-A) may be substituted. Examples of such substituent can be same as those explained in the general formula (3), groups cited for G₃, R₃₁ and R₃₂, and an ionic hydrophilic group.

As a particularly preferable combination of the substituents in the azo dye represented by the general formula (3), R₃₅ and R₃₆ each is preferably a hydrogen atom, an alkyl group, an aryl group, a heterocyclic group, a sulfonyl group or an acyl group, more preferably a hydrogen atom, an acyl group, a heterocyclic group, or a sulfonyl group, and most preferably a hydrogen atom, an aryl group, or a heterocyclic group. However, R₃₅ and R₃₆ do not become hydrogen atoms at the same time.

G₃ is preferably a hydrogen atom, a halogen atom, an alkyl group, a hydroxyl group, an amino group or an acylamino group, more preferably a hydrogen atom, a halogen atom, an amino group or an acylamino group, and most preferably a hydrogen atom, an amino group or an acylamino group.

A₃₁ is preferably a pyrazole ring, an imidazole ring, an isothiazole ring, a thiadiazole ring, or a benzothiazole ring, more preferably a pyrazole ring, or an isothiazole ring, and most preferably a pyrazole ring.

B₃₁ and B₃₂ each is ═CR₃₁— or —CR₃₂═, and R₃₁ and R₃₂ each is preferably a hydrogen atom, an alkyl group, a halogen atom, a cyano group, a carbamoyl group, a carboxyl group, a hydroxyl group, an alkoxy group, or an alkoxycarbonyl group, more preferably a hydrogen atom, an alkyl group, a carboxyl group, a cyano group or a carbamoyl group.

As to a preferred combination of the substituents in the compound represented by the general formula (3), there is preferred a compound in which at least one of the various substituents is the aforementioned preferable group, more preferably a compound in which a larger number of the various substituents are the aforementioned preferable groups, and most preferably a compound in which all the substituents are the aforementioned preferable groups.

Specific examples of the azo dye represented by the general formula (3) are shown in the following, but the present invention is not limited by such examples.

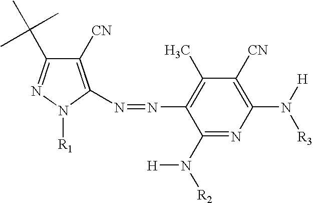

| Dye | R₁ | R₂ | R₃ |
|---|---|---|---|
| a-1 | 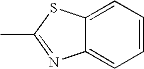 | 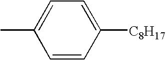 | 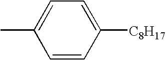 |
| a-2 | 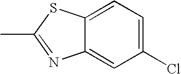 | 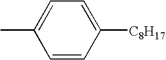 | 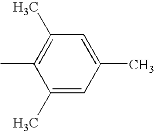 |
| a-3 | 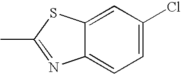 | 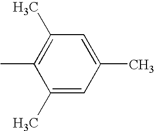 | 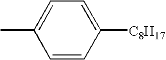 |
| a-4 | 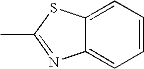 | 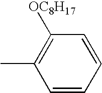 | 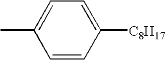 |
| a-5 | 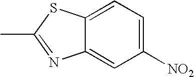 | 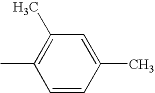 | 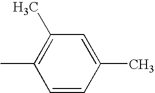 |

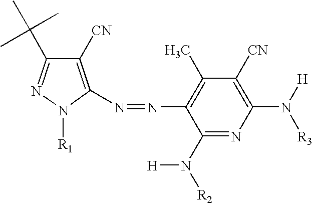

| Dye | R₁ | R₂ | R₃ |
|---|---|---|---|
| a-6 | 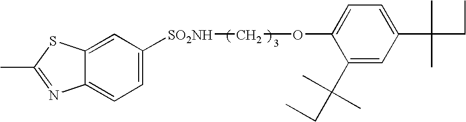 | 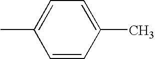 | 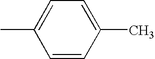 |
| a-7 | 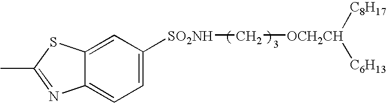 | 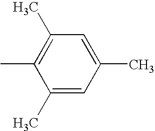 | 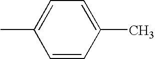 |
| a-8 | 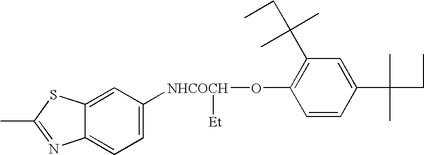 | 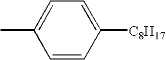 | 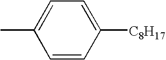 |
| a-9 | 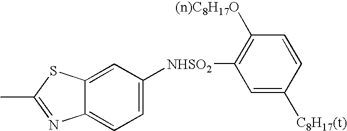 | 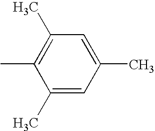 | C₈H₁₇(t) |
| a-10 | 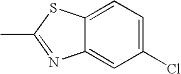 | 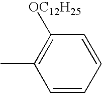 | 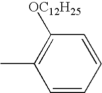 |

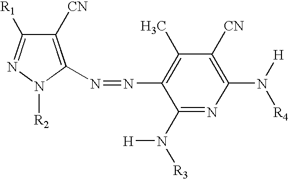

| Dye | R₁ | R₂ | R₃ | R₄ |
|---|---|---|---|---|
| a-11 | 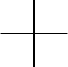 | 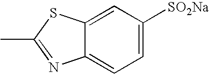 | 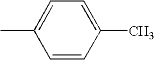 | 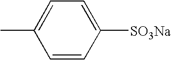 |
| a-12 | 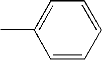 | 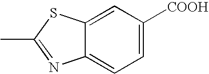 | 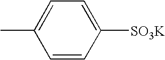 | 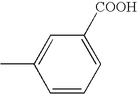 |
| a-13 | 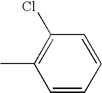 | 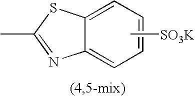 | 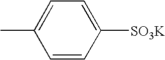 | 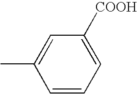 |
| a-14 | 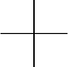 | 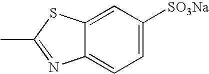 | 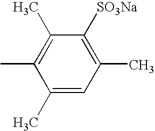 | 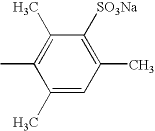 |
| a-15 | 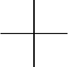 | 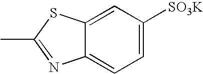 | 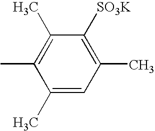 | 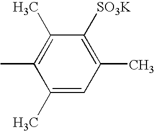 |
| a-16 | 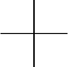 | 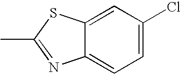 | 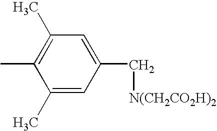 | 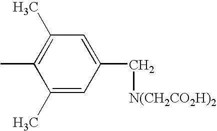 |
| a-17 | 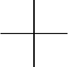 | 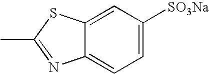 | 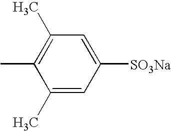 | 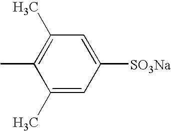 |

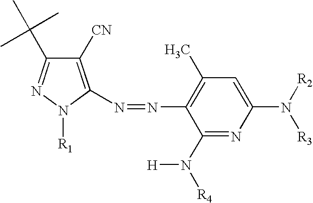

| Dye | R₁ | R₂ | R₃ | R₄ |
|---|---|---|---|---|
| a-18 | 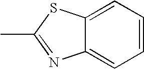 | 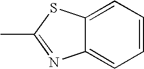 | 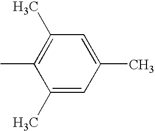 | 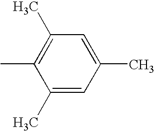 |
| a-19 | 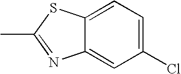 | —SO₂CH₃ | 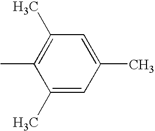 | 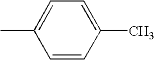 |
| a-20 | 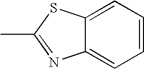 | —COCH₃ | C₈H₁₇(t) | C₈H₁₇(t) |
| a-21 | 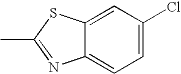 | —SO₂CH₃ | 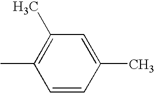 | C₈H₁₇(t) |
| a-22 | 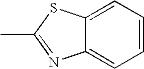 | H | 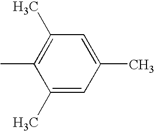 | 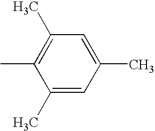 |
| a-23 | 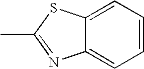 | H | 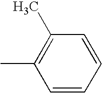 | 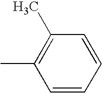 |
| a-24 | 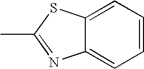 | H | 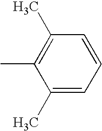 | 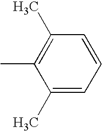 |
| a-25 | 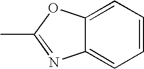 | 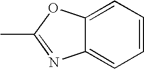 | 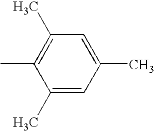 | 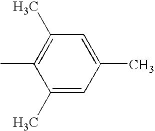 |

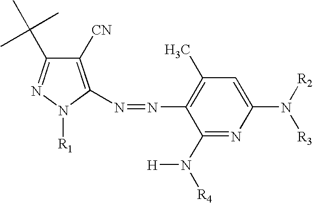

| Dye | R₁ | R₂ |
|---|---|---|
| a-26 | 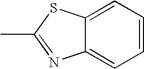 | 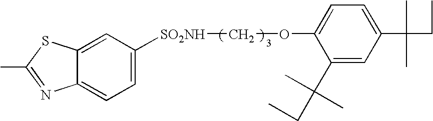 |
| a-27 | 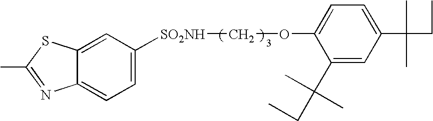 | 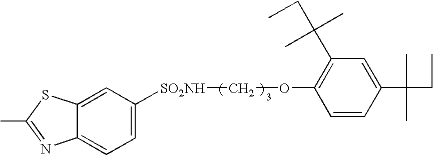 |
| a-28 | 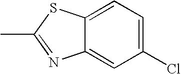 | 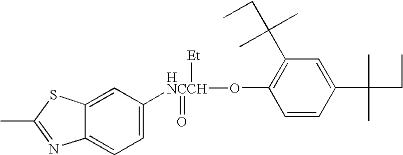 |
| a-29 | 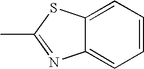 | 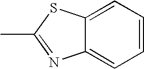 |
| a-30 | 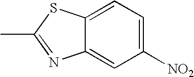 | 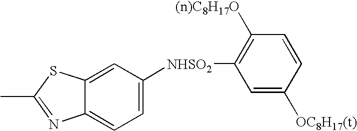 |
| a-31 | 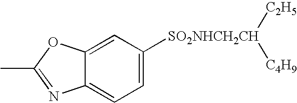 | 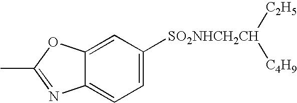 |

| Dye | R₃ | R₄ |
|---|---|---|
| a-26 | 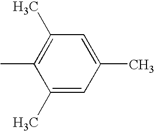 | 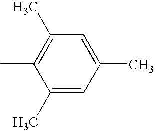 |
| a-27 | 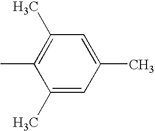 | 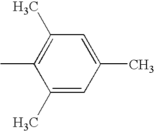 |
| a-28 | 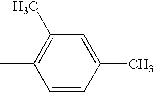 | 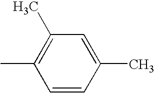 |
| a-29 | 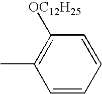 | 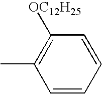 |
| a-30 | 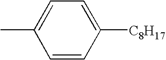 | C₈H₁₇(t) |
| a-31 | 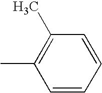 | 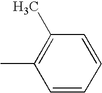 |

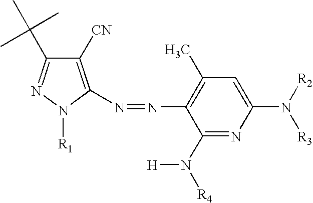

| Dye | R₁ | R₂ |
|---|---|---|
| a-32 | 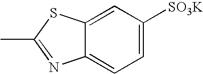 | 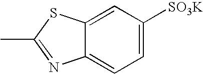 |
| a-33 | 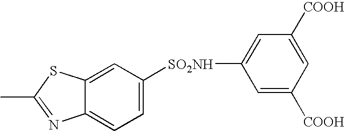 | 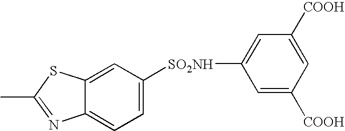 |
| a-34 | 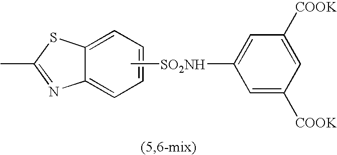 | 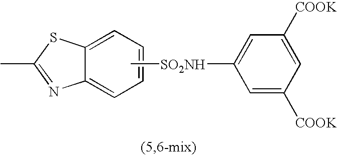 |
| a-35 | 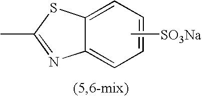 | 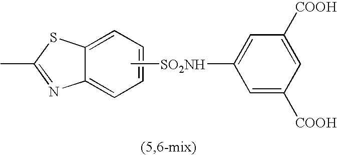 |

| Dye | R₃ | R₄ |
|---|---|---|
| a-32 | 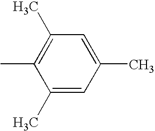 | 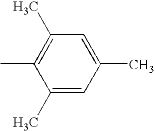 |
| a-33 | 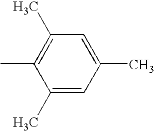 | 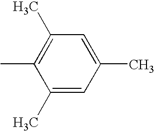 |
| a-34 | 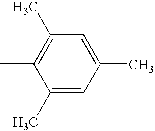 | 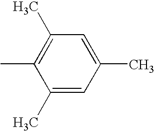 |
| a-35 | 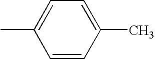 | 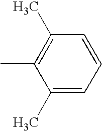 |

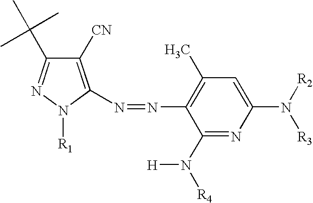

| Dye | R₁ | R₂ |
|---|---|---|
| a-36 | 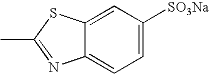 | 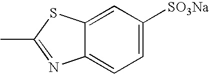 |
| a-37 | 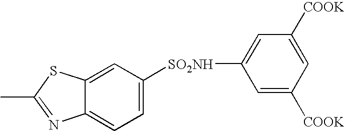 | 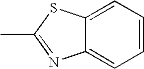 |
| a-38 | 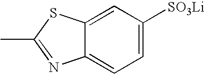 | 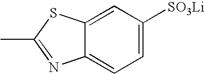 |
| a-39 | 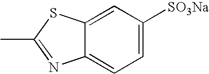 | 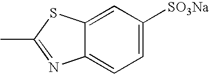 |
| a-40 | 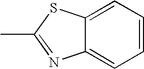 | 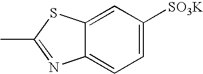 |

| Dye | R₃ | R₄ |
|---|---|---|
| a-36 | 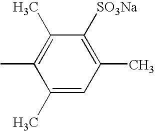 | 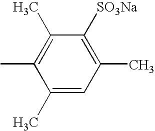 |
| a-37 | 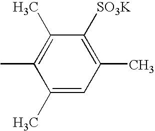 | 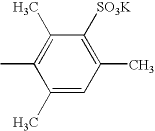 |
| a-38 | 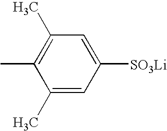 | 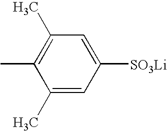 |
| a-39 | 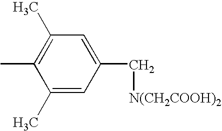 | 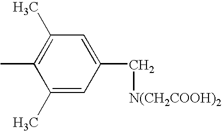 |
| a-40 | 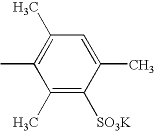 | 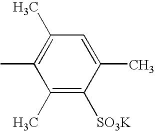 |

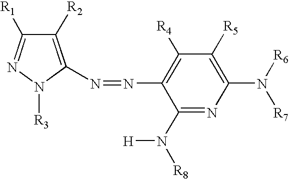

| Dye | R₁ | R₂ | R₃ | R₄ | R₅ | R₆ |
|---|---|---|---|---|---|---|
| a-41 | 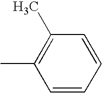 | CN | 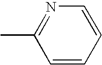 | H | CONH₂ | SO₂CH₃ |
| a-42 | 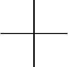 | Br | 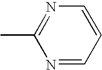 | COOEt | H | 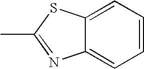 |
| a-43 | 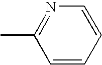 | SO₂CH₃ | 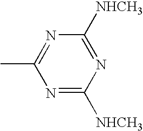 | CONH₂ | H | 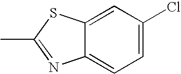 |
| a-44 | 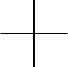 | CN | 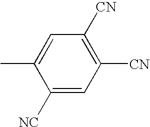 | H | H | 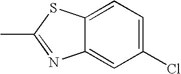 |
| a-45 | 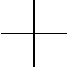 | Br | 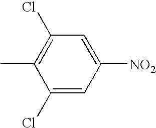 | H | CONH₂ | 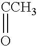 |
| a-46 | 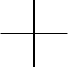 | CN | 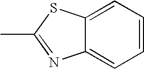 | CH₃ | H | 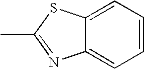 |

| Dye | R₇ | R₈ |
|---|---|---|
| a-41 | 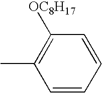 | 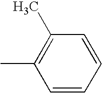 |
| a-42 | C₈H₁₇(t) | COCH₃ |
| a-43 | 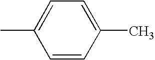 | 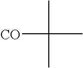 |
| a-44 | 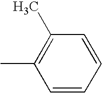 | SO₂CH₃ |
| a-45 | 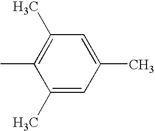 | 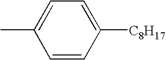 |
| a-46 | 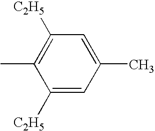 | 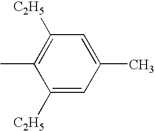 |

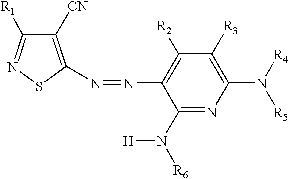

| Dye | R₁ | R₂ | R₃ | R₄ | R₅ | R₆ |
|---|---|---|---|---|---|---|
| b-1 | CH₃ | CH₃ | CN | H | 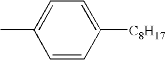 | 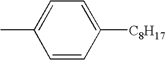 |
| b-2 | CH₃ | CH₃ | CN | H | 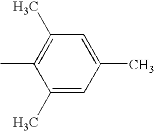 | 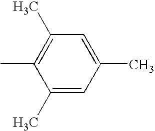 |
| b-3 | CH₃ | CH₃ | CONH₂ | H | 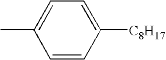 | 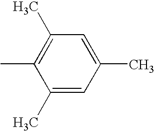 |
| b-4 | CH₃ | CH₃ | H | H | 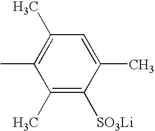 | 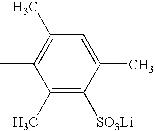 |
| b-5 | CH₃ | H | CN | H | 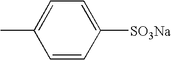 | 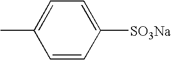 |

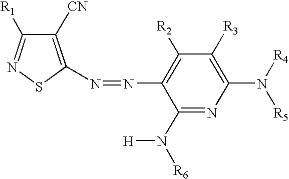

| Dye | R₁ | R₂ | R₃ | R₄ | R₅ | R₆ |
|---|---|---|---|---|---|---|
| b-6 | CH₃ | CH₃ | H | 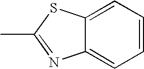 | 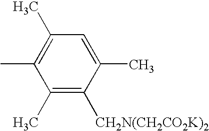 | 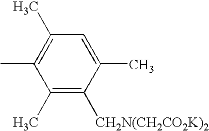 |
| b-7 | CH₃ | CH₃ | H | 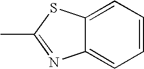 | 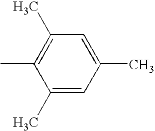 | 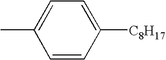 |
| b-8 | CH₃ | H | H | SO₂CH₃ | 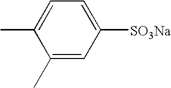 | 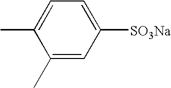 |

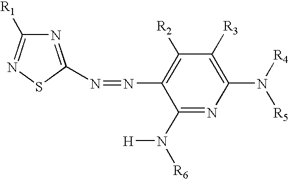

| Dye | R₁ | R₂ | R₃ | R₄ |
|---|---|---|---|---|
| c-1 | —SCH₃ | CH₃ | CN | H |
| c-2 | 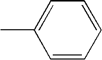 | H | CONH₂ | H |
| c-3 | 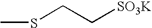 | CH₃ | H | 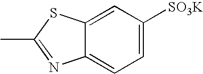 |
| c-4 | —CH₃ | CH₃ | H | 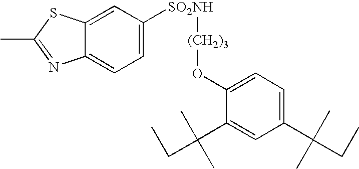 |
| c-5 | 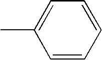 | H | H | 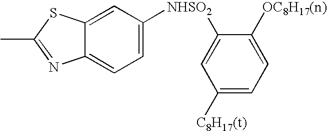 |

| Dye | R₅ | R₆ |
|---|---|---|
| c-1 | C₈H₁₇(t) | 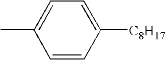 |
| c-2 | 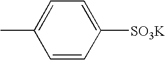 | 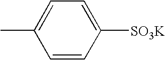 |
| c-3 | 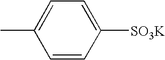 | 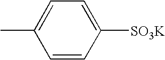 |
| c-4 | 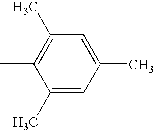 | 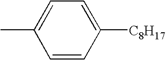 |
| c-5 | 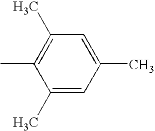 | C₈H₁₇(t) |

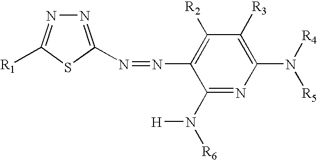

| Dye | R₁ | R₂ | R₃ | R₄ | R₅ | R₆ |
|---|---|---|---|---|---|---|
| d-1 | Me | CH₃ | CN | H | 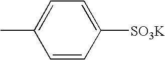 | 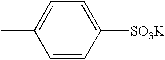 |
| d-2 | Me | CH₃ | CN | H | 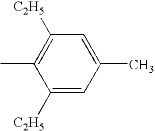 | 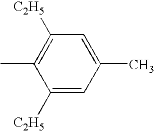 |
| d-3 | Me | H | H | 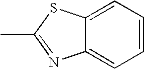 | 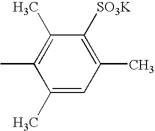 | 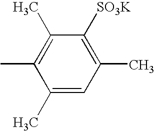 |
| d-4 | Ph | CH₃ | CONH₂ | H | 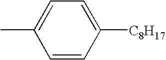 | 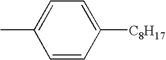 |
| d-5 | Ph | CH₃ | H | 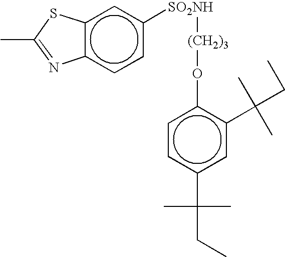 | 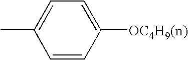 | 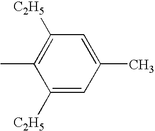 |

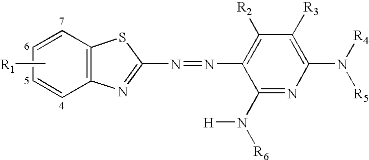

| Dye | R₁ | R₂ | R₃ | R₄ | R₅ | R₆ |
|---|---|---|---|---|---|---|
| e-1 | 5-Cl | CH₃ | CONH₂ | H | C₈H₁₇(t) | C₈H₁₇(t) |
| e-2 | 5,6-diCl | H | H | 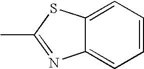 | 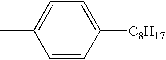 | 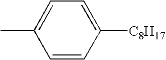 |
| e-3 | 5,6-diCl | CH₃ | H | 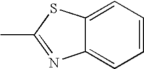 | 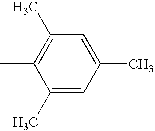 | COCH₃ |
| e-4 | 5-CH₃ | H | CN | H | 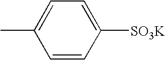 | 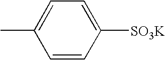 |
| e-5 | 5-NO₂ | CH₃ | H | SO₂CH₃ | 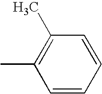 | 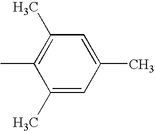 |

f-1

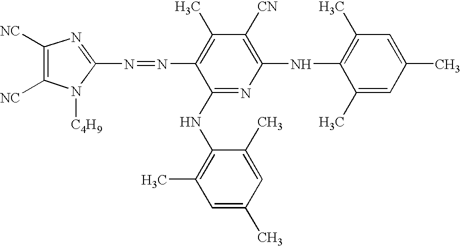

f-2

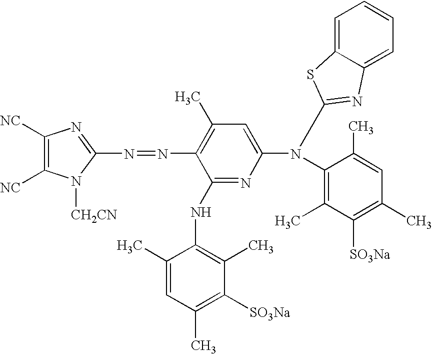

The azo dye represented by the general formula (3) preferably is employed with a content in the ink of 0.2 to 20 mass %, more preferably 0.5 to 15 mass %. Also it has a solubility (or dispersibility in stable state) in water at 20° C. preferably of 5 mass % or higher, more preferably 10 mass % or higher.

[Black Dye]

In a black ink to be employed in the invention, there is employed a dye (L) having a wavelength λmax within a range from 500 to 700 nm, and a half-peak width (Wλ,_{1/2}), in an absorption spectrum in a dilute solution normalized to an absorbance 1.0, of 100 nm or larger (preferably 120 to 500 nm, more preferably 120 to 350 nm).

Such dye (L) may be singly used as a dye for the black ink, in case it can realize “(deep) black” of high image quality, namely black color scarcely showing any of B, G and R color regardless of a light source for observation, but the dye is usually used in combination with another dye capable of covering an area where the dye indicates a low absorption. It is usually used in combination preferably with a dye (S) having a main absorption in a yellow range (λmax from 350 to 500 nm). It is also possible to prepare a black ink in combination with still another dye.

In the invention, a black ink is prepared by dissolving or dispersing the aforementioned dye either singly or in a mixture in an aqueous medium, and, there is preferred an ink meeting following conditions in order to satisfy performances preferred for the black ink for ink jet recording, namely 1) an excellent weather resistance, and/or 2) black color being maintained in a well-balanced state even after fading.

At first, a black square code of the JIS code 2223 is printed with a size of 48 points with the black ink, and a reflective density (Dᵥᵢₛ) measured with a status A filter (visual filter) is defined as an initial density. A reflective densitometer provided with the status A filter can be, for example, an X-Rite densitometer. For “black” density measurement, a measured value by Dᵥᵢₛ is used as a reflective density for a standard observation. Such print is subjected to a forced fading in an ozone fading tester capable of constantly generating ozone of 5 ppm, and, based on a time (t) required for the reflective density (Dᵥᵢₛ) to reach 80% of the initial reflective density, a forced fading rate constant (kᵥᵢₛ) is obtained by a relation 0.8=exp(−kᵥᵢₛ·t).

The black ink preferably has the rate constant (kᵥᵢₛ) of 5.0×10⁻² [hour⁻] or less, more preferably 3.0×10⁻² [hour⁻¹] or less, and particularly preferably 1.0×10⁻² [hour⁻¹] or less (condition 1).

Also the black square code of the JIS code 2223 is printed with a size of 48 points with the black ink, and a reflective density measured with a status A filter is defined, as an initial density, by reflective densities (D_{R}, D_{G}, D_{B}) of three colors C (cyan), M (magenta) and Y (yellow) instead of Dᵥᵢₛ. (D_{R}, D_{G}, D_{B}) represents (a C reflective density by a red filter, an M reflective density by a green filter, a Y reflective density by a blue filter). The print is subjected to a forced fading in an ozone fading tester capable of constantly generating ozone of 5 ppm as explained above, and, based on a time required for each of the reflective densities (D_{R}, D_{G}, D_{B}) to reach 80% of the initial density, forced fading rate constants (k_{R}, k_{G}, k_{B}) are determined in a similar manner. A ratio (R) of a maximum value and a minimum value of such three rate constants (for example k_{R} is largest and k_{G} is smallest, R=k_{R}/k_{G}), is preferably 1.2 or less, more preferably 1.1 or less and particularly preferably 1.05 or less (condition 2).

The “print of the black square code of the JIS code 2223 printed with a size of 48 points” is a printed image of a size sufficiently covering an aperture of the tester, in order to provide a sufficient size for density measurement.

Also in the black ink, at least a dye used therein has an oxidation potential, as explained in the foregoing, higher than 1.0 V (vs. SCE), preferably higher than 1.1 V (vs. SCE), further preferably higher than 1.15 V (vs. SCE), and most preferably higher than 1.25 V (vs. SCE), and at least a dye used therein preferably has λmax at 500 nm or larger (condition 3).

Also the black ink is prepared with the azo dye described in the foregoing general formula (4). The azo dye of the general formula (4) can be a dye (L) having a wavelength λmax within a range from 500 to 700 nm, and a half-peak width (Wλ,_{1/2}), in an absorption spectrum in a dilute solution normalized to an absorbance 1.0, of 100 nm or larger. The azo dye of the general formula (4) can also be a dye (S) having a wavelength λmax within a range from 350 to 500 nm. It is preferred that at least one of the dyes (L) is a dye of the general formula (4), more preferred that at least one in each of the dyes (L) and the dyes (S) is a dye of the general formula (4), and particularly preferred that 90 mass % of all the dyes in the ink is constituted of the dyes of the general formula (4) (condition 4).

The black ink of the present invention satisfies at least one of the aforementioned conditions 1-4.

In the following, the dye represented by the general formula (4) will be explained.

In the general formula (4), A₄₁, B₄₁ and C₄₁ each independently represents an aromatic group that may be substituted or a heterocyclic group that may be substituted (A₄₁ and C₄₁ being monovalent groups, while B₄₁ being a divalent group). The substituent may be an aromatic azo group or a heterocyclic azo group.

The azo dye represented by the general formula (4) is particularly preferably a dye represented by a general formula (4-A).

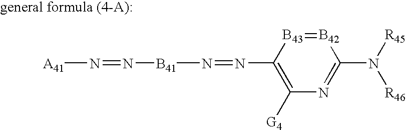

In the general formula (4-A), A₄₁ and B₄₁ have the same meanings as in the general formula (4). B₄₂ and B₄₃ each represents ═CR₄₁— or —CR₄₂═, or either one represents a nitrogen atom while the other one represents ═CR₄₁— or —CR₄₂═.

G₄, R₄₁ and R₄₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including an alkylamino group, an arylamino group and a heterocyclic amino group), an acylamino group, an ureido group, a sulfamoylamino group, an alkoxycarbonylamino group, an aryloxycarbonylamino group, an alkyl- or aryl-sulfonylamino group, a heterocyclic sulfonylamino group, a nitro group, an alkyl- or aryl-thio group, a heterocyclic thio group, an alkyl- or aryl-sulfonyl group, a heterocyclic sulfonyl group, an alkyl- or aryl-sulfinyl group, a heterocyclic sulfinyl group, a sulfamoyl group, or a sulfo group, each of which may be further substituted.

R₄₅ and R₄₆ each independently represents a hydrogen atom, an aliphatic group, an aromatic group, a heterocyclic group, an acyl group, an alkoxycarbonyl group, an aryloxycarbonyl group, a carbamoyl group, an alkyl- or aryl-sulfonyl group, or a sulfamoyl group, which may further have a substituent. In this regard, R₄₅ and R₄₆ never represent hydrogen atoms simultaneously.

R₄₁ and R₄₅, or R₄₅ and R₄₆ may be bonded to form a 5- or 6-membered ring.

The azo dye represented by the general formula (4-A) is further preferably a dye represented by a following general formula (4-B).

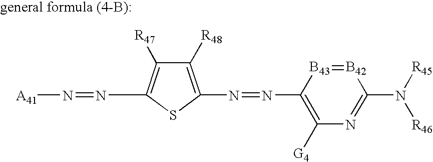

In the general formula (4-B), R₄₇ and R₄₈ have the same meaning as R₄₁ in the general formula (4-A).

In the following, there will be explained the terms (substituent) to be used in the general formulas (4), (4-A) and (4-B). These term will be used in common in general formulas (4-C) and (4-D) to be explained later.

A halogen atom means a fluorine atom, a chlorine atom or a bromine atom.

An aliphatic group means an alkyl group, a substituted alkyl group, an alkenyl group, a substituted alkenyl group, an alkinyl group, a substituted alkinyl group, an aralkyl group or a substituted aralkyl group. The aliphatic group may be branched or may form a ring. The aliphatic group preferably has 1 to 20 carbon atoms, further preferably 1 to 16 carbon atoms. An aryl portion of the aralkyl group or the substituted aralkyl group is preferably a phenyl group or a naphthyl group, particularly preferably a phenyl group. Examples of the aliphatic group include a methyl group, an ethyl group, a butyl group, an isopropyl group, a t-butyl group, a hydroxyethyl group, a methoxyethyl group, a cyanoethyl group, a trifluoromethyl group, a 3-sulfopropyl group, a 4-sulfobutyl group, a cyclohexyl group, a benzyl group, a 2-phenethyl group, a vinyl group and an allyl group.

A monovalent aromatic group means an aryl group or a substituted aryl group. The aryl group is preferably a phenyl group or a naphthyl group, particularly preferably a phenyl group. The monovalent aromatic group preferably has 6 to 20 carbon atoms, further preferably 6 to 16 carbon atoms. Examples of the monovalent aromatic group include a phenyl group, a p-tolyl group, a p-methoxyphenyl group, an o-chlorophenyl group and a m-(3-sulfopropylamino)phenyl group. A divalent aromatic group is obtained by forming such monovalent aromatic group into a divalent state, and examples include phenylene, a p-tolylene, p-methoxyphenylene, o-chlorophenylene, m-(3-sulfopropylamino)phenylene and naphthylene.

A heterocyclic group includes a substituted heterocyclic group and a non-substituted heterocyclic group. The heterocyclic group may have a heterocyclic structure to which an aliphatic ring, an aromatic ring or another heterocycle is condensed. The heterocyclic group is preferably a 5- or 6-membered heterocyclic group, and a hetero atom in the heterocycle can be N, O or S. Examples of the substituent include an aliphatic group, a halogen atom, an alkyl- and aryl-sulfonyl group, an acyl group, an acylamino group, a sulfamoyl group, a carbamoyl group, and an ionic hydrophilic group. Examples of the heterocycle employed in the monovalent and divalent heterocyclic group include pyridine, thiophene, thiazole, benzothiazole, benzoxazole, and furan.

A carbamoyl group includes a substituted carbamoyl group and a non-substituted carbamoyl group. Examples of the substituent include an alkyl group. Also examples of the carbamoyl group include a methylcarbamoyl group and a dimethylcarbamoyl group.

An alkoxycarbonyl group includes a substituted alkoxycarbonyl group and a non-substituted alkoxycarbonyl group. The alkoxycarbonyl group preferably has 2 to 20 carbon atoms. Examples of the substituent include an ionic hydrophilic group. Examples of the alkoxycarbonyl group include a methoxycarbonyl group and an ethoxycarbonyl group.

An aryloxycarbonyl group includes a substituted aryloxycarbonyl group and a non-substituted aryloxycarbonyl group. The aryloxycarbonyl group preferably has 7 to 20 carbon atoms. Examples of the substituent include an ionic hydrophilic group. Examples of the aryloxycarbonyl group include a phenoxycarbonyl group.

A heterocyclic oxycarbonyl group includes a substituted heterocyclic oxycarbonyl group and a non-substituted heterocyclic oxycarbonyl group. The heterocyclic oxycarbonyl group preferably has 2 to 20 carbon atoms. Examples of the substituent include an ionic hydrophilic group. Examples of the heterocyclic oxycarbonyl group include a 2-pyridyl oxycarbonyl group.

An acyl group includes a substituted acyl group and a non-substituted acyl group. The acyl group preferably has 1 to 20 carbon atoms. Examples of the substituent include an ionic hydrophilic group. Examples of the acyl group include an acetyl group and a benzoyl group.

An alkoxy group includes a substituted alkoxy group and a non-substituted alkoxy group. The alkoxy group preferably has 1 to 20 carbon atoms. Examples of the substituent include an alkoxy group, a hydroxyl group and an ionic hydrophilic group. Examples of the alkoxy group include a methoxy group, an ethoxy group, an isopropoxy group, a methoxyethoxy group, a hydroxyethoxy group and a 3-carboxypropoxy group.

An aryloxy group includes a substituted aryloxy group and a non-substituted aryloxy group. The aryloxy group preferably has 6 to 20 carbon atoms. Examples of the substituent include an alkoxy group, and an ionic hydrophilic group. Examples of the aryloxy group include a phenoxy group, a p-methoxyphenoxy group and an o-methoxyphenoxy group.

A heterocyclic oxy group includes a substituted heterocyclic oxy group and a non-substituted heterocyclic oxy group. The heterocyclic oxy group preferably has 2 to 20 carbon atoms. Examples of the substituent include an alkyl group, an alkoxy group, and an ionic hydrophilic group. Examples of the heterocyclic oxy group include a 3-pyridyloxy group, and a 3-thienyloxy group.

A silyloxy group is preferably a silyloxy group substituted with an aliphatic group with 1 to 20 carbon atoms or with an aromatic group. Examples of such silyloxy group includes a trimethylsilyloxy group and a diphenylmethylsilyloxy group.

An acyloxy group includes a substituted acyloxy group and a non-substituted acyloxy group. The acyloxy group preferably has 1 to 20 carbon atoms. Examples of the substituent include an ionic hydrophilic group. Examples of the acyloxy group include an acetoxy group and a benzoyloxy group.

A carbamoyloxy group includes a substituted carbamoyloxy group and a non-substituted carbamoyloxy group. Examples of the substituent include an alkyl group. Examples of the carbamoyloxy group include an N-methylcarbamoyl group.

An alkoxycarbonyloxy group includes a substituted alkoxycarbonyloxy group and a non-substituted alkoxycarbonyloxy group. The alkoxycarbonyloxy group preferably has 2 to 20 carbon atoms. Examples of the alkoxycarbonyloxy group include a methoxycarbonyloxy group, and an isopropoxycarbonyloxy group.

An aryloxycarbonyloxy group includes a substituted aryloxycarbonyloxy group and a non-substituted aryloxycarbonyloxy group. The aryloxycarbonyloxy group preferably has 7 to 20 carbon atoms. Examples of the aryloxycarbonyloxy group include a phenoxycarbonyloxy group.

An amino group includes an amino group substituted with an alkyl group, an aryl group or a heterocyclic group, which may further have a substituent. An alkylamino group preferably has 1 to 20 carbon atoms. Examples of the substituent include an ionic hydrophilic group. Examples of the alkylamino group include a methylamino group and a diethylamino group.

An arylamino group includes a substituted arylamino group and a non-substituted arylamino group. The arylamino group preferably has 6 to 20 carbon atoms. Examples of the substituent include a halogen atom, and an ionic hydrophilic group. Examples of the arylamino group include an anilino group and a 2-chlorophenylamino group.

A heterocyclic amino group includes a substituted heterocyclic amino group and a non-substituted heterocyclic amino group. The heterocyclic amino group preferably has 2 to 20 carbon atoms. Examples of the substituent include an alkyl group, a halogen atom and an ionic hydrophilic group;

An acylamino group includes a substituted acylamino group and a non-substituted acylamino group. The acylamino group preferably has 2 to 20 carbon atoms. Examples of the substituent include an ionic hydrophilic group. Examples of the acylamino group include an acetylamino group, a propionylamino group, a benzoylamino group, an N-phenylacetylamino group and a 3,5-disulfobenzoylamino group.

An ureido group includes a substituted ureido group and a non-substituted ureido group. The ureido group preferably has 1 to 20 carbon atoms. Examples of the substituent include an alkyl group and an aryl group. Examples of the ureido group include a 3-methylureido group, a 3,3-dimethylureido group and 3-phenylureido group.

A sulfamoylamino group includes a substituted sulfamoylamino group and a non-substituted sulfamoylamino group. Examples of the substituent include an alkyl group. Examples of the sulfamoylamino group include an N,N-dipropylsulfamoylamino group.

An alkoxycarbonylamino group includes a substituted alkoxycarbonylamino group and a non-substituted alkoxycarbonylamino group. The alkoxycarbonylamino group preferably has 2 to 20 carbon atoms. Examples of the substituent include an ionic hydrophilic group. Examples of the alkoxycarbonylamino group include an ethoxycarbonylamino group.

An aryloxycarbonylamino group includes a substituted aryloxycarbonylamino group and a non-substituted aryloxycarbonylamino group. The aryloxycarbonylamino group preferably has 7 to 20 carbon atoms. Examples of the substituent include an ionic hydroplilic group. Examples of the aryloxycarbonylamino group include a phenoxycarbonylamino group.

Alkyl- and aryl-sulfonylamino groups include substituted alkyl- and aryl-sulfonylamino groups and non-substituted alkyl- and aryl-sulfonylamino groups. The sulfonylamino group preferably has 1 to 20 carbon atoms. Examples of the substituent include an ionic hydrophilic group. Examples of these sulfonylamino groups include a methylsulfonylamino group, an N-phenyl-methylsulfonylamino group, a phenylsulfonylamino group, and a 3-carboxyphenylsulfonylamino group.

A heterocyclic sulfonylamino group includes a substituted heterocyclic sulfonylamino group and a non-substituted heterocyclic sulfonylamino group. The heterocyclic sulfonylamino group preferably has 1 to 12 carbon atoms. Examples of the substituent include an ionic hydrophilic group. Examples of the heterocyclic sulfonylamino group include a 2-thiophenesulfonylamino group, and a 3-pyridinesulfonylamino group.

A heterocyclic sulfonyl group includes a substituted heterocyclic sulfonyl group and a non-substituted heterocyclic sulfonyl group. The heterocyclic sulfonyl group preferably has 1 to 20 carbon atoms. Examples of the substituent include an ionic hydrophilic group. Examples of the heterocyclic sulfonyl group include a 2-thiophenesulfonyl group, and a 3-pyridinesulfonyl group.

A heterocyclic sulfinyl group includes a substituted heterocyclic sulfinyl group and a non-substituted heterocyclic sulfinyl group. The heterocyclic sulfinyl group preferably has 1 to 20 carbon atoms. Examples of the substituent include an ionic hydrophilic group. Examples of the heterocyclic sulfinyl group include a 4-pyridinesulfinyl group.

Alkyl-, aryl-, and heterocyclic-thio groups include substituted alkyl-, aryl-, and heterocyclic-thio groups and non-substituted alkyl-, aryl-, and heterocyclic-thio groups. The alkyl-, aryl-, or heterocyclic-thio group preferably has 1 to 20 carbon atoms. Examples of the substituent include an ionic hydrophilic group. Examples of the alkyl-, aryl-, and heterocyclic-thio groups include a methylthio group, a phenylthio group, and a 2-pyridylthio group.

An alkyl- and aryl-sulfonyl groups include substituted alkyl- and aryl-sulfonyl groups and non-substituted alkyl- and aryl-sulfonyl groups. Examples of the alkyl- and aryl-sulfonyl groups respectively include a methylsulfonyl group, and a phenylsulfonyl group.

An alkyl- and aryl-sulfinyl groups include substituted alkyl- and aryl-sulfinyl groups and non-substituted alkyl- and aryl-sulfinyl groups. Examples of the alkyl- and aryl-sulfinyl groups respectively include a methylsulfinyl group and a phenylsulfinyl group.

A sulfamoyl group includes a substituted sulfamoyl group and a non-substituted sulfamoyl group. Examples of the substituent include an alkyl group. Examples of the sulfamoyl group include a dimethylsulfamoyl group, and a di-(2-hydroxyethyl)sulfamoyl group.

In the following, general formulas (4), (4-A) and (4-B) will be further explained.

In the following description, the foregoing description is applied to the groups and the substituents.

In the general formula (4), A₄₁, B₄₁ and C₄₁ each independently represents an aromatic group that may be substituted (A₄₁ and C₄₁ being monovalent aromatic groups, such as an aryl group; while B₄₁ being a divalent aromatic group such as an arylene group), or a heterocyclic that may be substituted (A₄₁ and C₄₁ being monovalent heterocyclic groups; while B₄₁ being a divalent heterocyclic group). Examples of the aromatic ring include a benzene ring and a naphthalene ring, and a hetero atom of the heterocycle can be N, O or S. The heterocycle may be condensed with an aliphatic ring, an aromatic ring or another heterocycle.

The substituent may also be an arylazo group or a heterocyclic azo group.

Also it is preferable that at least one of A₄₁, B₄₁ and C₄₁ is a heterocyclic group, and more preferable that at least two of A₄₁, B₄₁ and C₄₁ are heterocyclic groups. Also all of A₄₁, B₄₁ and C₄₁ can be heterocyclic groups.

A preferred heterocyclic group for C₄₁ is an aromatic nitrogen-containing 6-membered heterocycle represented by a following general formula (4-C). In case C₄₁ is an aromatic nitrogen-containing 6-membered heterocycle represented by the following general formula (4-C), the general formula (4) corresponds to the general formula (4-A).

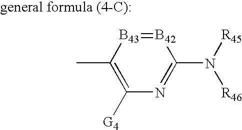

In the general formula (4-C), B₄₂ and B₄₃ each represents ═CR₄₁— or —CR₄₂═, or either one represents a nitrogen atom while the other represents ═CR₄₁— or —CR₄₂═, but there is more preferred a case where they respectively represent ═CR₄₁— or —CR₄₂═.

R₄₅ and R₄₆ each independently represents a hydrogen atom, an aliphatic group, an aromatic group, a heterocyclic group, an acyl group, an alkoxycarbonyl group, an aryloxycarbonyl group, a carbamoyl group, an alkyl- or aryl-sulfonyl group, or a sulfamoyl group, which may further have a substituent. The substituent represented by R₄₅ and R₄₆ is preferably a hydrogen atom, an aliphatic group, an aromatic group, a heterocyclic group, an acyl group, or an alkyl- or aryl-sulfonyl group, or a sulfamoyl group, more preferably a hydrogen atom, an aromatic group, a heterocyclic group, an acyl group, or an alkyl- or aryl-sulfonyl group, and most preferably a hydrogen atom, an aryl group, or a heterocyclic group. Each group may further have a substituent. However, R₄₅ and R₄₆ do not become hydrogen atoms at the same time.

G₄, R₄₁ and R₄₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including an alkylamino group, an arylamino group and a heterocyclic amino group), an acylamino group, an ureido group, a sulfamoylamino group, an alkoxycarbonylamino group, an aryloxycarbonylamino group, an alkyl- or aryl-sulfonylamino group, a heterocyclic sulfonylamino group, a nitro group, an alkyl- or aryl-thio group, a heterocyclic thio group, an alkyl- or aryl-sulfonyl group, a heterocyclic sulfonyl group, an alkyl- or aryl-sulfinyl group, a heterocyclic sulfinyl group, a sulfamoyl group, or a sulfo group, each of which may be further substituted.

A substituent represented by G₄ is preferably a hydrogen atom, a halogen atom, an aliphatic group, an aromatic group, a hydroxyl group, an alkoxy group, an aryloxy group, an acyloxy group, a heterocyclic oxy group, an amino group (including an alkylamino group, an arylamino group and a heterocyclic amino group), an acylamino group, an ureido group, a sulfamoylamino group, an alkoxycarbonylamino group, an aryloxycarbonylamino group, an alkyl- or aryl-thio group, or a heterocyclic thio group, more preferably a hydrogen atom, a halogen atom, an alkyl group, a hydroxyl group, an alkoxy group, an aryloxy group, an acyloxy group, an amino group (including an alkylamino group, an arylamino group and a heterocyclic amino group), or an acylamino group, and most preferably a hydrogen atom, an anilino group or an acylamino group, and each group may further have a substituent.

A substituent represented by R₄₁ and R₄₂ is preferably a hydrogen atom, an alkyl group, a halogen atom, an alkoxycarbonyl group, a carboxyl group, a carbamoyl group, a hydroxyl group, an alkoxy group or a cyano group. Each group may further have a substituent.

R₄₁ and R₄₅, or R₄₅ and R₄₆ may be bonded to form a 5- or 6-membered ring.

The substituent, in case the substituent represented by A₄₁, R₄₁, R₄₂, R₄₅, R₄₆ and G₄ further has a substituent, can be those cited for G₄, R₄₁ and R₄₂ in the foregoing. Also an ionic hydrophilic group is preferably present as a substituent in any position on A₄₁, R₄₁, R₄₂, R₄₅, R₄₆ and G₄.

The ionic hydrophilic group as a substituent can be a sulfo group, a carboxyl group, a phosphono group or a quaternary ammonium group. The ionic hydrophilic group is preferably a carboxyl group, a phosphono group or a sulfo group, particularly preferably a carboxyl group or a sulfo group. The carboxyl group, the phosphono group or the sulfo group may be in a state of a salt, and a counter ion forming the salt can be an ammonium ion, an alkali metal ion (such as lithium ion, sodium ion, or potassium ion), or an organic cation (such as tetramethylammonium ion, tetramethylguanidium ion or tetramethylphosphonium ion), among which lithium ion is preferred.

A heterocyclic ring in case B₄₁ has a cyclic structure is preferably a thiophene ring, a thiazole ring, an imidazole ring, a benzothiazole ring or a thienothiazole ring. Each heterocyclic group may further have a substituent. Among these, a thiophene ring, a thiazole ring, an imidazole ring, a benzothiazole ring and a thienothiazole ring represented by general formulas (h)-(l) are particularly preferable. In case B₄₁ is a thiophene ring represented by (h) and C₄₁ has a structure represented by the general formula (4-C), the general formula (4) corresponds to the general formula (4-B).

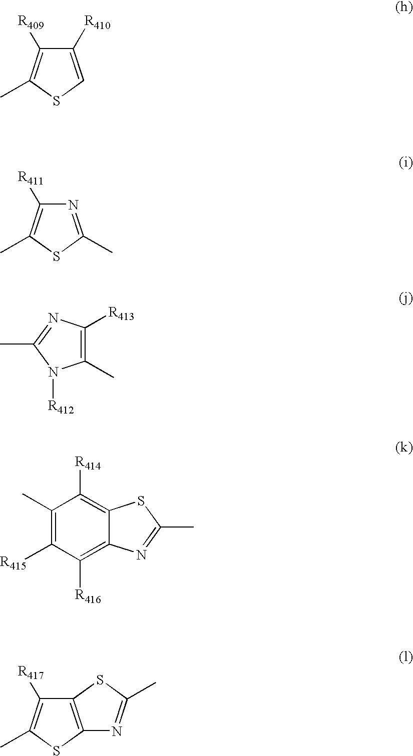

In the general formulas (h) to (l), R₄₀₉ to R₄₁₇ represent substituents same as G₄, R₄₁ and R₄₂ in the general formula (4-A).

Among the dyes represented by the general formula (4-B), a particularly preferable structure is represented by a general formula (4-D).

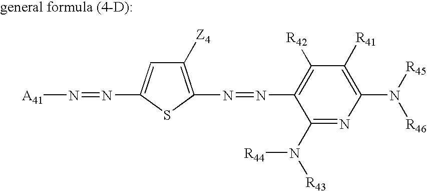

In the formula, Z₄ represents an electron attracting group with Hammett's substituent constant σp of 0.20, or higher. Z₄ is preferably an electron attracting group with σp of 0.30 or higher, more preferably an electron attracting group with σp of 0.45 or higher, and particularly preferably an electron attracting group with σp of 0.60 or higher, but σp preferably does not exceed 1.0.

More specifically, examples of the electron attracting group with Hammett's substituent constant σp of 0.60 or higher include a cyano group, a nitro group, an alkylsulfonyl group (such as methylsulfonyl group) or an arylsulfonyl group (such as phenylsulfonyl group).

Examples of the electron attracting group with Hammett's substituent constant σp of 0.45 or higher include, in addition to those in the foregoing, an acyl group (such as acetyl group), an alkoxycarbonyl group (such as dodecyloxycarbonyl group), an aryloxycarbonyl group (such as m-chlorophenoxycarbonyl), an alkylsulfinyl group (such as n-propysulfinyl), an arylsulfinyl group (such as phenylsulfinyl), a sulfamoyl group (such as N-ethylsulfamoyl or N,N-dimethylsulfamoyl), and a halogenated alkyl group (such as trifluoromethyl).

Examples of the electron attracting group with Hammett's substituent constant σp of 0.30 or higher include, in addition to those in the foregoing, an acyloxy group (such as acetoxy), a carbamoyl group (such as N-ethylcarbamoyl or N,N-dibutylcarbamoyl), a halogenated alkoxy group (such as trifluoromethyloxy), a halogenated aryloxy group (such as pentafluorophenyloxy), a sulfonyloxy group (such as methylsulfonyloxy group), a halogenated alkylthio group (such as difluoromethylthio), an aryl group substituted with two or more electron attracting groups with σp of 0.15 or higher (such as 2,4-dinitrophenyl, or pentachlorophenyl), and a heterocycle (such as 2-benzoxazolyl, 2-benzothiazolyl or 1-phenyl-2-benzimidazolyl).

Examples of the electron attracting group with Hammett's substituent constant σp of 0.20 or higher include, in addition to those in the foregoing, a halogen atom.

Z₄ is preferably, among those in the foregoing, an acyl group with 2 to 20 carbon atoms, an alkyloxycarbonyl group with 2 to 20 carbon atoms, a nitro group, a cyano group, an alkylsulfonyl group with 1 to 20 carbon atoms, an arylsulfonyl group with 6 to 20 carbon atoms, a carbamoyl group with 1 to 20 carbon atoms or a halogenated alkyl group with 1 to 20 carbon atoms. It is particularly preferably a cyano group, an alkylsulfonyl group with 1 to 20 carbon atoms or an arylsulfonyl group with 6 to 20 carbon atoms, and most preferably a cyano group.

R₄₁, R₄₂, R₄₅ and R₄₆ in the general formula (4-D) have the same meaning as in the general formula (4-A). R₄₃ and R₄₄ each independently represents a hydrogen atom, an aliphatic group, an aromatic group, a heterocyclic group, an acyl group, an alkoxycarbonyl group, an aryloxycarbonyl group, a carbamoyl group, an alkyl- or aryl-sulfonyl group, or a sulfamoyl group. Among these, a hydrogen atom, an aromatic group, a heterocyclic group, an acyl group, or an alkyl- or aryl-sulfonyl group is preferable, and a hydrogen atom, an aromatic group, or a heterocyclic group is particularly preferable.

Each group explained in the general formula (4-D) may further have a substituent. In case such group further has a substituent, such substituent can be those explained in the general formula (4-A), groups cited for G₄, R₄₁ and R₄₂, or an ionic hydrophilic group.

In a particularly preferred combination of the substituents in the azo dye represented by the general formula (4-B), R₄₅ and R₄₆ each is preferably a hydrogen atom, an alkyl group, an aryl group, a heterocyclic group, a sulfonyl group or an acyl group, more preferably a hydrogen atom, an aryl group, a heterocyclic group, or a sulfonyl group, and most preferably a hydrogen atom, an aryl group, or a heterocyclic group. However, R₄₅ and R₄₆ do not become hydrogen atoms at the same time.

G₄ is preferably a hydrogen atom, a halogen atom, an alkyl group, a hydroxy group, an amino group, or an acylamino group, more preferably a hydrogen atom, a halogen atom, an amino group, or an acylamino group, and most preferably a hydrogen atom, an amino group, or an acylamino group.

A₄₁ is preferably a pyrazole ring, an imidazole ring, an isothiazole ring, a thiadiazole ring or a benzothiazole ring, further preferably a pyrazole ring or an isothiazole ring, and most preferably a pyrazole ring.

B₄₂ and B₄₃ each represents ═CR₄₁— or —CR₄₂═, and R₄₁ and R₄₂ each can preferably be a hydrogen atom, an alkyl group, a halogen atom, a cyano group, a carbamoyl group, a carboxyl group, a hydroxyl group, an alkoxy group, or an alkoxycarbonyl group, more preferably a hydrogen atom, an alkyl group, a carboxyl group, a cyano group or a carbamoyl group.

As to a preferred combination of the substituents in the aforementioned azo dye, there is preferred a compound in which at least one of the various substituents is the aforementioned preferable group, more preferably a compound in which a larger number of the various substituents are the aforementioned preferable groups, and most preferably a compound in which all the substituents are the aforementioned preferable groups.

In the following, specific examples of the azo dye represented by the general formula (4) are shown, but the invention is not limited to such examples. Also the carboxyl group, the phosphono group or the sulfo group may be in a state of a salt, and a counter ion forming the salt can be an ammonium ion, an alkali metal ion (such as lithium ion, sodium ion, or potassium ion), or an organic cation (such as tetramethylammonium ion, tetramethylguanidium ion or tetramethylphosphonium ion). Among these, a lithium ion is most preferable.

A—N═N—B—N═N—C

| | A | B | C |
|---|---|---|---|
| (A-1) | 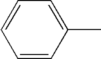 | 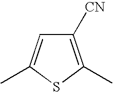 | 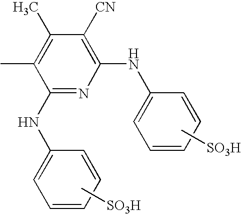 |
| (A-2) | 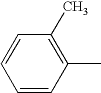 | 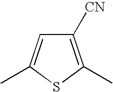 | 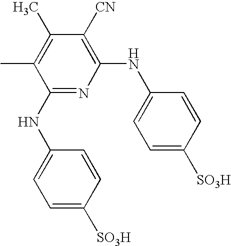 |
| (A-3) | 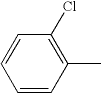 | 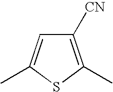 | 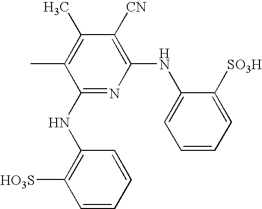 |
| (A-4) | 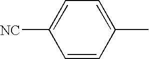 | 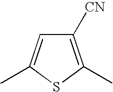 | 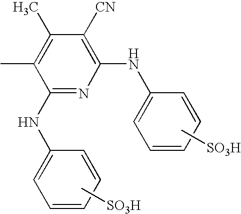 |
| (A-5) | 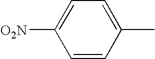 | 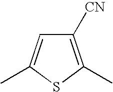 | 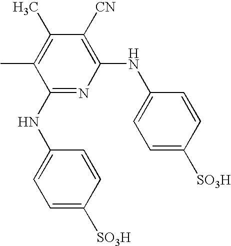 |
| (A-6) | 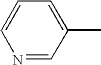 | 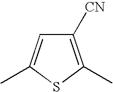 | 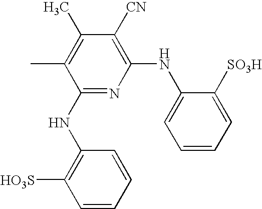 |
| (B-1) | 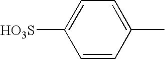 | 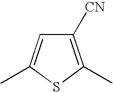 | 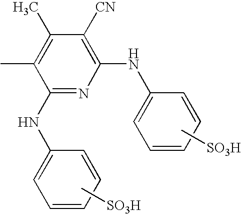 |
| (B-2) | 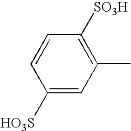 | 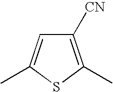 | 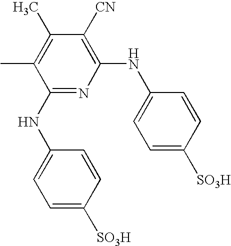 |
| (B-3) | 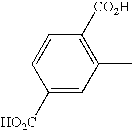 | 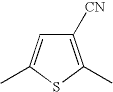 | 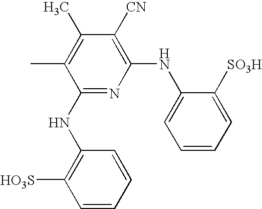 |
| (B-4) | 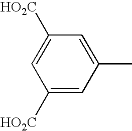 | 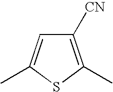 | 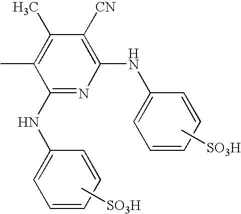 |
| (B-5) | 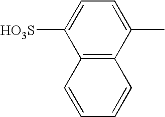 | 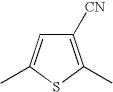 | 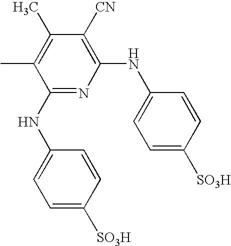 |
| (B-6) | 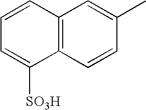 | 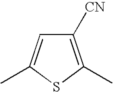 | 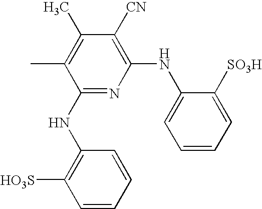 |
| (B-7) | 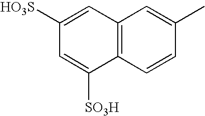 | 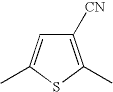 | 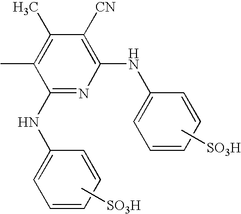 |
| (C-1) | 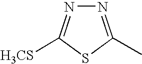 | 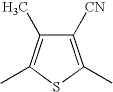 | 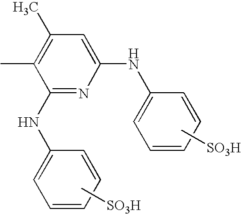 |
| (C-2) | 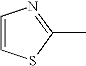 | 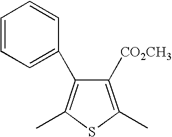 | 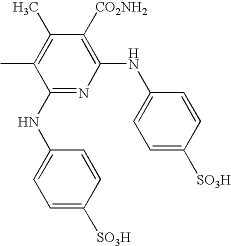 |
| (C-3) | 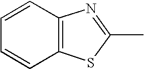 | 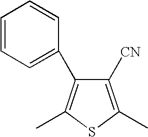 | 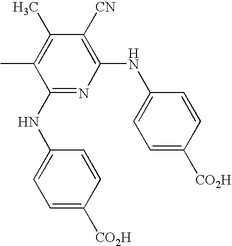 |
| (C-4) | 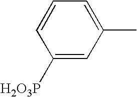 | 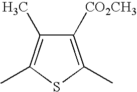 | 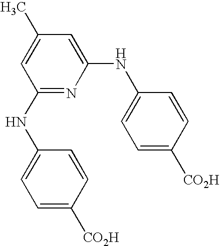 |
| (C-5) | 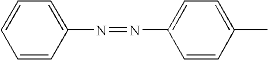 | 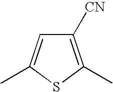 | 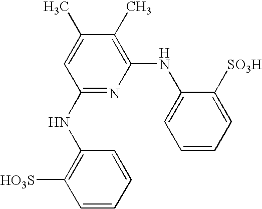 |
| (D-1) | 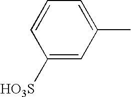 | 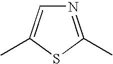 | 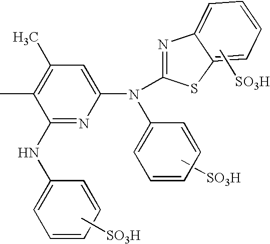 |
| (D-2) | 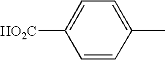 | 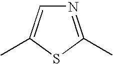 | 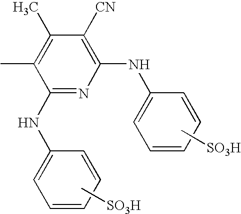 |
| (D-3) | 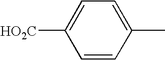 | 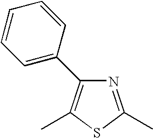 | 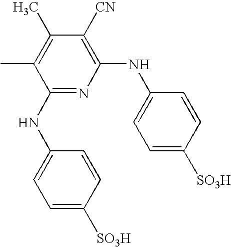 |
| (D-4) | 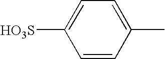 | 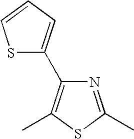 | 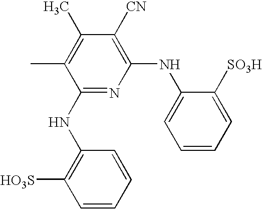 |
| (D-5) | 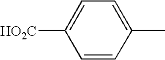 | 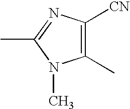 | 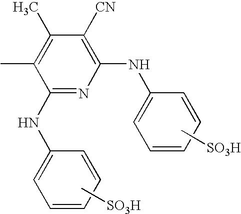 |
| (D-6) | 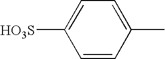 | 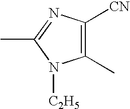 | 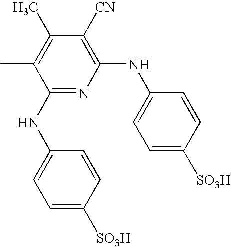 |
| (E-1) | 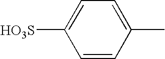 | 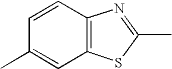 | 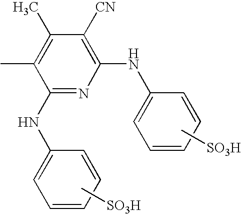 |
| (E-2) | 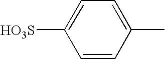 | 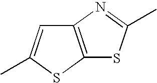 | 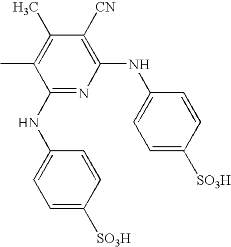 |
| (F-1) | 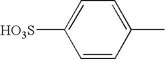 | 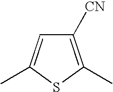 | 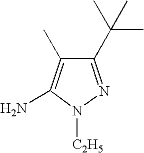 |
| (F-2) | 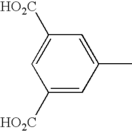 | 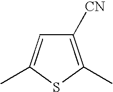 | 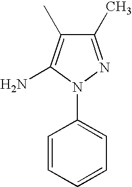 |
| (F-3) | 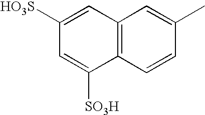 | 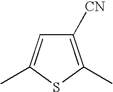 | 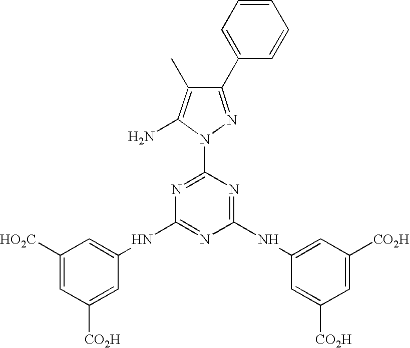 |
| (F-4) | 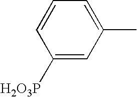 | 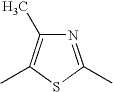 | 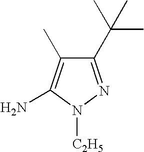 |

The azo dye represented by the general formulas (4), (4-A), (4-B) and (4-D) can be synthesized by a coupling reaction of a diazo component and a coupling component. A principal synthesizing method is described in Japanese Patent Application No. 2002-113460.

As a dye (S) having λmax within a range of 350 to 500 nm, a yellow dye and a yellow pigment to be explained later can be employed advantageously.

The azo dye represented by the general formula (4) is preferably used with a content in the ink of 0.2 to 20 mass %, preferably 0.5 to 15 mass %.

In the ink of the invention, another dye may be used in combination with the aforementioned dyes, in order to obtain a full-color image or to regulate the color hue. Examples of the dye usable in combination are shown in the following.

A yellow dye can be, for example, an aryl or heteryl azo dye having, as a coupling component, a phenol, a naphthol, an aniline, a pirazolone, a pyridone or an open-chain-active methylene compound; an azomethine dye having, as a coupling component, an open-chain active methylene compound; a methine dye such as a benzylidene dye or a monomethine oxonol dye; or a quinone dye such as a naphthoquinone dye or an anthraquinone dye, and other usable dyes include a quinophthalone dye, a nitro/nitroso dye, an acrylidine dye, an acrylidinone dye and the like. Such dye may provide yellow color only after dissociation of a part of the chromophore, and a counter cation in such case may be an inorganic cation such as alkali metal or ammonium, an organic cation such as a pyridinium or a quaternary ammonium salt, or a polymer cation having these cations in a partial structure.

A magenta dye can be, for example, an aryl or heteryl azo dye having, as a coupling component, a phenol, a naphthol, or an aniline; an azomethine dye having, as a coupling component, a pirazolone or a pirazolotriazole; a methine dye such as an arylidene dye, a styryl dye, a melocyanine dye, or an oxonole dye; a carbonium dye such as a diphenylmethane dye, a triphenylmethane dye or a xanthene dye; or a quinone dye such as naphthoquinone, anthraquinone or anthrapyridone, or a condensed polycyclic dye such as a dioxadine dye. Such dye may show magenta color only after dissociation of a part of the chromophore, and a counter cation in such case may be an inorganic cation such as alkali metal or ammonium, an organic cation such as a pyridinium or a quaternary ammonium salt, or a polymer cation having these cations in a partial structure.

A cyan dye can be, for example, an azomethine dye such as an indoaniline dye, or an indophenol dye; a polymethine dye such as a cyanine dye, an oxonole dye, or a melocyanine dye; a carbonium dye such as a diphenylmethane dye, a triphenylmethane dye, or a xanthene dye; a phthalocyanine dye; an anthraquinone dye; an aryl or heteryl azo dye having, as a coupling component, a phenol, a naphthol, or an aniline; or an indigo/thioindigo dye. Such dye may show cyan color only after dissociation of a part of the chromophore, and a counter cation in such case may be an inorganic cation such as alkali metal or ammonium, an organic cation such as a pyridinium or a quaternary ammonium salt, or a polymer cation having these cations in a partial structure.

Also a black dye such as a polyazo dye may also be employed.

It is also possible to use, in combination, a water-soluble dye such as a direct dye, an acid dye, a food dye, a basic dye, or a reactive dye. Examples of particularly preferred ones include:

C.I. Direct Red 2, 4, 9, 23, 26, 31, 39, 62, 63, 72, 75, 76, 79, 80, 81, 83, 84, 89, 92, 95, 111, 173, 184, 207, 211, 212, 214, 218, 21, 223, 224, 225, 226, 227, 232, 233, 240, 241, 242, 243, 247;

C.I. Direct Violet 7, 9, 47, 48, 51, 66, 90, 93, 94, 95, 98, 100, 101;

C.I. Direct Yellow 8, 9, 11, 12, 27, 28, 29, 33, 35, 39, 41, 44, 50, 53, 58, 59, 68, 86, 87, 93, 95, 96, 98, 100, 106, 108, 109, 110, 130, 132, 142, 144, 161, 163;

C.I. Direct Blue 1, 10, 15, 22, 25, 55, 67, 68, 71, 76, 77, 78, 80, 84, 86, 87, 90, 98, 106, 108, 109, 151, 156, 158, 159, 160, 168, 189, 192, 193, 194, 199, 200, 201, 202, 203, 207, 211, 213, 214, 218, 225, 229, 236, 237, 244, 248, 249, 251, 252, 264, 270, 280, 288, 289, 291;

C.I. Direct Black 9, 17, 19, 22, 32, 51, 56, 62, 69, 77, 80, 91, 94, 97, 108, 112, 113, 114, 117, 118, 121, 122, 125, 132, 146, 154, 166, 168, 173, 199;

C.I. Acid Red 35, 42, 52, 57, 62, 80, 82, 111, 114, 118, 119, 127, 128, 131, 143, 151, 154, 158, 249, 254, 257, 261, 263, 266, 289, 299, 301, 305, 336, 337, 361, 396, 397;

C.I. Acid Violet 5, 34, 43, 47, 48, 90, 103, 126;

C.I. Acid Yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, 227;

C.I. Acid Blue 9, 25, 40, 41, 62, 72, 76, 78, 80, 82, 92, 106, 112, 113, 120, 127:1, 129, 138, 143, 175, 181, 205, 207, 220, 221, 230, 232, 247, 258, 260, 264, 271, 277, 278, 279, 280, 288, 290, 326;

C.I. Acid Black 7, 24, 29, 48, 52:1, 172;

C.I. Reactive Red 3, 13, 17, 19, 21, 22, 23, 24, 29, 35, 37, 40, 41, 43, 45, 49, 55;

C.I. Reactive Violet 1, 3, 4, 5, 6, 7, 8, 9, 16, 17, 22, 23, 24, 26, 27, 33, 34;

C.I. Reactive Yellow 2, 3, 13, 14, 15, 17, 18, 23, 24, 25, 26, 27, 29, 35, 37, 41, 42;

C.I. Reactive Blue 2, 3, 5, 8, 10, 13, 14, 15, 17, 18, 19, 21, 25, 26, 27, 28, 29, 38;

C.I. Reactive Black 4, 5, 8, 14, 21, 23, 26, 31, 32, 34;

C.I. Basic Red 12, 13, 14, 15, 18, 22, 23, 24, 25, 27, 29, 35, 36, 38, 39, 45, 46;

C.I. Basic Violet 1, 2, 3, 7, 10, 15, 16, 20, 21, 25, 27, 28, 35, 37, 39, 40, 48;

C.I. Basic Yellow 1, 2, 4, 11, 13, 14, 15, 19, 21, 23, 24, 25, 28, 29, 32, 36, 39, 40;

C.I. Basic Blue 1, 3, 5, 7, 9, 22, 26, 41, 45, 46, 47, 54, 57, 60, 62, 65, 66, 69, 71; and

C.I. Basic Black 8.

It is also possible to use a pigment in combination.

The pigment usable in the ink of the invention can be, in addition to those commercially available, known ones described in various references. The references include “Color Index” (edited by The Society of Dyers and Colourists), “Kaitei Shimpan Ganryo Binran” edited by Japanese Pigment Technology Society (1989), “Saishin Ganryo Ouyou Gijutu” CMC (1986), “Printing Ink Technology” CMC (1984), and W. Herbst and K Hunger, “Industrial Organic Pigments” (VCH Verlagsgesellschaft, 1993). Specific examples of an organic pigment include an azo pigment (such as azo rake pigment, insoluble azo pigment, condensed azo pigment, and chelate azo pigment), a polycyclic pigment (such as phthalocyanine pigment, anthraquinone pigment, perylene or perynone pigment, indigo pigment, quinachrydone pigment, dioxadine pigment, isoindolinone pigment, quinophthalone pigment and diketopyrrolopyrrole pigment), a mordant rake pigment (such as a rake pigment of acid or basic dye), and an azine pigment, and those of inorganic pigment include a yellow pigment for example C.I. Pigment Yellow 34, 37, 42, 53 etc., a red pigment for example C.I. Pigment Red 101, 108 etc., a blue pigment for example C.I. Pigment Blue 27, 29, 17:1 etc., a black pigment for example C.I. Pigment Black 7 or magnetite, and a white pigment for example C.I. Pigment White 4, 6, 18, 21 and the like.

As a pigment having a preferable hue for image formation, preferred ones include, for a blue to cyan pigment, a phthalocyanine pigment, an indanthrone pigment of anthraquinone type (such as C.I. Pigment Blue 60), or a triarylcarbonium pigment of mordant rake pigment type, and most preferably a phthalocyanine pigment (preferably a copper phthalocyanine such as C.I. Pigment Blue 15:1, 15:2, 15:3, 15:4, 15:6, a monochloro or low-chloro copper phthalocyanine, an aluminum phthalocyanine pigment described in EP No. 860475, a metal-free phthalocyanine such as C.I. Pigment Blue 16, and a phthalocyanine having a metal center of Zn, Ni or Ti, among which most preferred are C.I. Pigment Blue 15:3, 15:4 and aluminum phthalocyanine).

For a red to violet pigment, preferred ones include an azo dye (preferred examples include C.I. Pigment Red 3, 5, 11, 22, 38, 48:1, 48:2, 48:3, 48:4, 49:1, 52:1, 53:1, 57:1, 63:2, 144, 146, and 184, among which particularly preferred ones are C.I. Pigment Red 57:1, 146 and 184), a quinachrydone pigment (preferred examples include C.I. Pigment Red 122, 192, 202, 207, 209, and C.I. Pigment Violet 19, 42, among which particularly preferred one is C.I. Pigment Red 122), a triarylcarbonium pigment of mordant rake pigment type (preferred examples include xanthene type C.I. Pigment Red 81:1, C.I. Pigment Violet 1, 2, 3, 27, and 39), a dioxadine pigment (for example C.I. Pigment Violet 23, and 37), a diketopyrrolopyrrole pigment (for example C.I. Pigment Red 254), a perylene pigment (for example C.I. Pigment Violet 29), an anthraquinones pigment, (for example C.I. Pigment Violet 5:1, 31, 33), and a thioindigo pigment (for example C.I. Pigment Red 38, 88).

For a yellow pigment, preferred ones include an azo pigment (preferred examples include a monoazo pigment C.I. Pigment Yellow 1, 3, 74, 98, a disazo pigment C.I. Pigment Yellow 12, 13, 14, 16, 17, 83, a composite azo pigment C.I. Pigment Yellow 93, 94, 95, 128, 155, a benzimidazolone C.I. Pigment Yellow 120, 151, 154, 156, 180, among which most preferred ones are those utilizing benzidine as the raw material), an isoindoline/isoindolinone type pigment (preferred examples include C.I. Pigment-Yellow 109, 110, 137, 139), a quinophthalone pigment (preferred examples include C.I. Pigment Yellow 138) and a flavanthlone pigment (for example C.I. Pigment Yellow 24).

Preferred examples for the black pigment include an inorganic pigment (preferably carbon black or magnetite) and aniline black.

In addition, there may also be employed an orange pigment (such as C.I. Pigment Orange 13, or 16), or a green pigment (such as C.I. Pigment Green 7).

The pigment usable in the ink of the invention may be an unprocessed pigment as described above, or a pigment subjected to a surface treatment. The method of surface treatment can be a method of surfacially coating resin or wax, a method of attaching a surfactant, or a method of coupling a reactive substance (such as a silane coupling agent, an epoxy compound, a polyisocyanate, or a radical generated from a diazonium salt) to the pigment surface, and is described in the following references and patents:
[1] Property and Application of Metal Soaps (Saiwai Shobo);
[2] Insatsu Ink Insatsu (CMC, 1984);
[3] Saishin Ganryo Ouyou Gijutsu (CMC, 1986);
[4] U.S. Pat. Nos. 5,554,739 and 5,571,311;
[5] JP-A Nos. 9-151342, 10-140065, 10-292143 and 11-166145.

In particular, a self-dispersible pigment prepared by reacting a diazonium salt, described in the USP [4] with carbon black, and an encapsulated pigment prepared by a method described in patents [5] are effective as dispersion stability can be obtained without utilizing an additional dispersant in the ink.

In the ink of the invention, the pigment may be dispersed by utilizing a dispersant. The dispersant can be of various known types according to the pigment to be used, such as a low-molecular dispersant of surfactant type, or a high-molecular dispersant. Examples of the dispersant include those described in JP-A No. 3-69949 and EP No. 549486. Also at the use of a dispersant, a pigment derivative called a synergist may be added for promoting adsorption of dispersant to the pigment.

The pigment usable in the ink of the invention preferably has a particle size after dispersion within a range of 0.01 to 10 μm, more preferably 0.05 to 1 μm.

For dispersing the pigment, there can be utilized a known dispersing technology employed in ink manufacture or toner manufacture. A dispersing apparatus can be a vertical or horizontal agitator mill, an attriter, a colloid mill, a ball mill, a three-roll mill, a pearl mill, a super mill, an impeller, a disperser, a KD mill, a dynatron, or a pressurized kneader. Details are described in Saishin Ganryo Ouyou Gijutsu (CMC, 1986).

In the following, there will be explained a surfactant that can be contained in the ink for ink jet recording of the present invention.

A surfactant may be added to the ink for ink jet of the present invention to regulate the physical properties of the ink liquid thereby improving the discharge stability of the ink and attaining excellent effects such as an improvement in the water resistance of the image and a prevention of blotting of the printed ink.

Examples of the surfactant includes an anionic surfactant such as sodium dodecylsulfonate, sodium dodecyloxysulfonate or sodium alkylbenzenesulfonate, a cationic surfactant such as cetylpyridinium chloride, trimethylcetylpyridinium chloride, or tetrabutylammonium chloride, or a nonionic surfactant such as polyoxyethylenenonyl phenyl ether, polyoxyethylene naphthyl ether, or polyoxyethyleneoctyl phenyl ether. Among these, a nonionic surfactant is employed preferably.

The surfactant is preferably used in a content to the ink of 0.001 to 20 mass %, preferably 0.005 to 10 mass % and further preferably 0.01 to 5 mass %.

The ink for ink jet of the present invention can be prepared by dissolving or dispersing the aforementioned dye and preferably a surfactant in an aqueous medium. In the invention, “aqueous medium” means water or a mixture of water and a small amount of water-miscible organic solvent, to which an additive such as a moistening agent, an stabilizer or an antiseptic is added if necessary.

In the preparation of the ink liquid of the invention, in case of a water-soluble dye, it is preferable to at first dissolve it in water. Thereafter various solvents and additives are added, dissolved and agitated to obtain a uniform ink liquid.

For such dissolving, various methods can be utilized such as a dissolution by agitation, a dissolution by ultrasonic irradiation or a dissolution by vibration. Among these, a vibrating method is employed preferably. For agitation, there can be utilized various methods utilizing for example a flow agitation known in the art, or utilizing a shear force by an inversion agiter or a dissolver. On the other hand, an agitation method utilizing a shear force with a bottom of a container, such as utilizing a magnetic stirrer.

Examples of the water-miscible organic solvent that can be employed in the invention include an alcohol (such as methanol, ethanol, propanol, isopropanol, butanol, isobutanol, sec-butanol, t-butanol, pentanol, hexanol, cyclohexanol or benzyl alcohol), a polyhydric alcohol (such as ethylene glycol, diethylene glycol, triethylene glycol, polyethylene glycol, propylene glycol, dipropylene glycol, polypropylene glycol, butylenes glycol, hexanediol, pentandiol, glycerin, hexanetriol, or thiodiglycol), a glycol derivative (such as ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, or ethylene glycol monophenyl ether), an amine (such as ethanol amine, diethanol amine, triethanol amine, N-methyldiethanol amine, N-ethyldiethanol amine, morpholine, N-ethylmorpholine, ethylenediamine, diethylenetriamine, triethylenetetramine, polyethylenimine, or tetramethylpropylene diamine), and other polar solvents (such as formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidine, acetonitrile or acetone). The water-miscible organic solvent may be employed in a combination of two or more kinds.

In case the aforementioned dye is an oil-soluble dye, the ink can be prepared by dissolving the oil-soluble dye in a high-boiling organic solvent and emulsifying it in an aqueous medium.

The high-boiling organic solvent employed in the invention has a boiling point of 150° C. or higher, preferably 170° C. or higher.

Specific examples include a phthalate ester (such as dibutyl phthalate, dioctyl phthalate, dicyclohexyl phthalate, di-2-ethylhexyl phthalate, decyl phthalate, bis(2,4-di-tert-amylphenyl)isophthalate, or bis(1,1-diethylpropyl)phthalate), a phosphorate or phosphone ester (such as diphenyl phosphate, triphenyl phosphate, tricresyl phosphate, 2-ethylhexyldiphenyl phosphate, dioctylbutyl phosphate, tricyclohexyl phosphate, tri-2-ethylhexyl phosphate, tridodecyl phosphate or di-2-ethylhexylphenyl phosphate), a benzoate ester (such as 2-ethylhexyl benzoate, 2,4-dichlorobenzoate, or dodecyl benzoate, 2-ethylhexyl-p-hydroxy benzoate), an amide (such as N,N-diethyldodecanamide, or N,N-diethyllaurylamide), an alcohol or a phenol (such as isostearyl alcohol or 2,4-di-tert-amylphenyl), an aliphatic ester (such as dibutoxyethyl succinate, di-2-ethylhexyl succinate, 2-hexyldecyl tetradecanoate, tributyl citrate, diethyl azelate, isostearyl lactate, or trioctyl citrate), an aniline derivative (such as N,N-dibutyl-2-butoxy-5-tert-octylaniline), a chlorinated paraffin (such as paraffin with a chlorine content of 10-80%), a trimesate ester (such as tributyl trimesate), dodecylbenzene, diisopropylnaphthalene, a phenol (such as 2,4-di-tert-aminophenol, 4-dodecyloxyphenol, 4-dodecyloxycarbonylphenol, or 4-(4-dodecyloxyphenylsulfonyl)phenol), a carboxylic acid (such as 2-(2,4-di-tert-amylphenoxybutyric acid or 2-ethoxyoctadecanoic acid), and an alkylphosphoric acid (such as di-2-(ethylhexyl)phosphoric acid or diphenylphosphoric acid). The high boiling organic solvent is used in a mass ratio to the oil-soluble dye of 0.01 to 3 times, preferably 0.01 to 1.0 time.

These high boiling organic solvents may be employed singly or in a mixture of plural kinds (for example tricresyl phosphate and dibutyl phthalate, trioctyl phosphate and di(2-ethylhexyl)sebacate, or dibutyl phthalate and poly(N-t-butylacrylamide).

Examples of the high boiling organic solvent employable in the invention, other than those described above and synthesizing methods of such high boiling organic solvents are described, for example, in U.S. Pat. Nos. 2,322,027, 2,533,514, 2,772,163, 2,835,579, 3,594,171, 3,676,137, 3,689,271, 3,700,454, 3,748,141, 3,764,336, 3,765,897, 3,912,515, 3,936,303, 4,004,928, 4,080,209, 4,127,413, 4,193,802, 4,207,393, 4,220,711, 4,239,851, 4,278,757, 4,353,979, 4,363,873, 4,430,421, 4,430,422, 4,464,464, 4,483,918, 4,540,657, 4,684,606, 4,728,599, 4,745,049, 4,935,321, 5,013,639, EP Nos. 276,319A, 286,253A, 289,820A, 309,158A, 309,159A, 309,160A, 509,311A, 510,576A; East Germany Patent Nos. 147,009, 157, 147, 159, 573, 225,240A, BP No. 2,091,124A, JP-A Nos. 48-47335, 50-26530, 51-25133, 51-26036, 51-27921, 51-27922, 51-149028, 52-46816, 53-1520, 53-1521, 53-15127, 53-146622, 54-91325, 54-106228, 54-118246, 55-59464, 56-64333, 56-81836, 59-204041, 61-84641, 62-118345, 62-247364, 63-167357, 63-214744, 63-301941, 64-9452, 64-9454, 64-68745, 1-101543, 1-102454, 2-792, 2-4239, 2-43541, 4-29237, 4-30165, 4-232946 and 4-346338.

Such high boiling organic solvent is used in a mass ratio to the oil-soluble dye of 0.01 to 3.0 times, preferably 0.01 to 1.0 time.

In the invention, the oil-soluble dye and the high boiling organic solvent are emulsified in an aqueous medium. At the emulsification, the a low boiling organic solvent may be employed in certain cases in consideration of the emulsifying property. Such low boiling organic solvent is an organic solvent having a boiling point of about 30° C. to 150° C. under a normal pressure. Preferred examples include an ester (such as ethyl acetate, butyl acetate, ethyl propionate, β-ethoxyethyl acetate or methyl cellosolve acetate), an alcohol (such as isopropyl alcohol, n-butyl alcohol, or sec-butyl alcohol), a ketone (such as methyl isobutyl ketone, methyl ethyl ketone or cyclohexanone), an amide (such as dimethylformamide or N-methylpyrrolidone), and an ether (such as tetrahydrofuran or dioxane), but these examples are not restrictive.

The emulsification is executed by dispersing an oil phase, formed by dissolving a dye in a high boiling organic solvent or eventually a mixture thereof with a low boiling organic solvent, in an aqueous phase principally constituted of water, in order to form minute oil drops of the oil phase. In this operation, it is possible to add, if necessary, additives such as a surfactant, a humidifying agent, a dye stabilizer, an emulsion stabilizer, an antiseptic, an antimold agent etc. to be explained later into the aqueous phase and/or the oil phase.

The emulsification is usually conducted by adding the oil phase into the aqueous phase, but so-called inverted-phase emulsification in which the aqueous phase is dropwise added into the oil phase can also be employed advantageously. The aforementioned emulsifying method can be employed also in case the dye used in the invention is water soluble and the additive is oil soluble.

At the emulsification, various surfactants can be employed, and there is preferred an anionic surfactant such as a fatty acid salt, an alkylsulfonate ester salt, an alkylbenzenesulfonate salt, an alkylnaphthalenesulfonate salt, a dialkylsulfosuccinate salt, an alkylphophate ester salt, a naphthalenesulfonic acid-formaline condensate, or a polyoxyethylenealkylsulfonate ester salt, a nonionic surfactant such as polyoxyethylene alkyl ether, polyoxyethylene alkylallyl ether, a polyoxyethylene fatty acid ester, a sorbitan fatty acid ester, a polyoxyethylenesorbitan fatty acid ester, polyoxyethylene alkylamine, a glycerin fatty acid ester, or an oxyethylene-oxypropylene copolymer. There are also preferably employed Surfynols (Air Products & Chemicals Co.) which are acetylene-type polyoxyethylene oxide surfactants. There is also preferred an amphoteric surfactant such as N,N-dimethyl-N-alkylamine oxide. There can also be employed surfactants described in JP-A No. 59-157,636, pages 37-38, and Research Disclosure No. 308119 (1989).

Also in order to achieve stabilization immediately after the emulsification, a water-soluble polymer may be added in combination with the aforementioned surfactant. The water-soluble polymer is preferably polyvinyl alcohol, polyvinylpyrrolidone, polyethylene oxide, polyacrylic acid, polyacrylamide or a copolymer thereof. It is also preferably to employ a natural water-soluble polymer such as polysaccharides, casein or gelatin. It is also possible, for stabilizing the dye dispersion, to use in combination a polymer that is substantially not dissolved in the aqueous medium, such as polyvinyl, polyurethane, polyester, polyamide, polyurea, or polycarbonate, obtained by polymerization of an acrylate ester, a methacrylate ester, a vinyl ester, an acrylamide, a methacrylamide, an olefin, a styrene, a vinyl ether, an acrylonitrile. These polymers preferably include —SO₃— or —COO⁻. In case such polymer, that is substantially insoluble in the aqueous medium, is used in combination, it is employed in an amount of 20 mass % or less with respect to the high boiling organic solvent, more preferably 10 mass % or less.

In case of forming an aqueous ink by dispersing the oil-soluble dye and the high boiling organic solvent by emulsification, the control of the particle size is particularly important. In order to increase the purity and the density of the color, in case of forming an image by an ink jet method, it is essential to reduce an average particle size. A volume-averaged particle size is preferably 1 μm or less, more preferably 5 to 100 nm.

The volume-averaged particle size and the particle size distribution of the dispersed particles can be easily measured by a known method such as a static light scattering method, a dynamic light scattering method, a centrifugal precipitation method, or a method described in Jikken Kagaku Koza, 4th edition, pages 417-418. For example, a measurement can be easily achieved, by diluting the ink with distilled water so as to obtain a particle concentration of 0.1-1 mass % and utilizing a commercially available volume-averaged particle size measuring instrument (for example Microtrak UPA (manufactured by Nikkiso Co.)). Also the dynamic light scattering method utilizing a laser Doppler effect is particularly preferable as it allows a particle size measurement to a small particle size.

The volume-averaged particle size is a particle size weighted by the volume of the particles, and is obtained, in a group of particles, by dividing a sum of a product of a diameter of each particle and a volume thereof by a total volume of the particles. The volume-averaged particle size is described in “Chemistry of polymer latex” (Soichi Muroi, published by Kobunshi Kankokai), p. 119.

It is clarified also that the presence of coarse particles has a significant effect on the printing ability. A clogging of a head nozzle or even a stain therein caused by such coarse particles is found to induce a discharge failure or a deviated discharge of the ink, thus giving a significant effect on the printing ability. In order to prevent such defects, it is important to maintain the number of particles of 5 μm or larger at 10 or less and the number of particles of 1 μm or larger at 1000 or less in 1 μl of ink.

Such coarse particles can be eliminated by a known method such as centrifuging or micro filtration. Such separation may be executed immediately after the emulsification, or, immediately before a filling into a cartridge after addition of various additives such as a humidifying agent and a surfactant to the emulsion.

As effective means for reducing the average particle size and eliminating the coarse particles, a mechanical emulsifying apparatus can be utilized.

As the emulsifying apparatus, there can be utilized various known apparatuses for example a mill of a simple stirrer type, an impeller agitator type, an in-line agitator type, or a colloid mill, or an ultrasonic apparatus, and a high pressure homogenizer is particularly preferable.

The high pressure homogenizer is detailedly described in U.S. Pat. No. 4,533,254 and JP-A No. 6-47264, and is commercially available as Gaulin homogenizer (manufactured by A. P. V. Gaulin Inc.), Microfluidizer (manufactured by Microfuidix Inc.) and Altimizer (manufacture by Sugino Machine Co.).

Also a high pressure homogenizer equipped with a mechanism of forming fine particles in an ultra high pressure jet stream, as described in U.S. Pat. No. 5,720,551, is particularly effective for the emulsification of the invention. The emulsifying apparatus utilizing such ultra high pressure jet stream is commercially available, for example, as DeBEE2000 (manufactured by Bee International Ltd.).

The emulsification in a high pressure emulsifying apparatus is executed at a pressure of 50 MPa or higher, preferably 60 MPa or higher and further preferably 180 MPa or higher.

It is particularly preferable to utilize two or more emulsifying apparatuses in combination, for example executing emulsification in an agitating emulsifier and then passing a high pressure homogenizer. It is also preferable to execute emulsification in such emulsifying apparatus, then add additives such as a humidifying agent and a surfactant, and to pass a high pressure homogenizer again during an ink filling into a cartridge.

In case a low boiling organic solvent is contained in addition to a high boiling organic solvent, it is preferable to remove the low boiling organic solvent in consideration of the stability of the emulsion and of hygienic safety. The elimination of the low boiling solvent can be achieved by various known methods depending on the type of the solvent, such as an evaporation, an evaporation under a reduced pressure, an ultra filtration or the like. The eliminating step for the low boiling organic solvent is preferably executed as soon as possible after the emulsification.

A method of preparing an ink for ink jet is described in detail in JP-A Nos. 5-148436, 5-295312, 7-97541, 7-82515 and 7-118584, and can also be utilized for preparing the ink for ink jet recording of the present invention.

In the preparation of the ink for ink jet of the present invention, an ultrasonic vibration may be applied for example in a dissolving step for additives such as a dye.

The ultrasonic vibration is to apply an ultrasonic energy, equal to or higher than the energy applied in a recording head, in the course of preparation of the ink for eliminating bubbles, in order to prevent bubble generation by a pressure applied in the recording head to the ink.

The ultrasonic vibration is an ultrasonic wave usually of a frequency of 20 kHz or higher, preferably 40 kHz or higher and more preferably 50 kHz or higher. Also an energy applied to the liquid by the ultrasonic vibration is usually 2×10⁷ J/m³ or higher, preferably 5×10⁷ J/m³ or higher, and more preferably 1×10⁸ J/m³ or higher. Also the ultrasonic vibration is usually applied for 10 minutes to 1 hour.

A step of applying the ultrasonic vibration is effective at any time after the charging of the dye into the medium. It is also effective to apply the ultrasonic vibration after a completed ink is once stored. However it is preferable to apply the ultrasonic vibration at the dissolving and/or dispersion of the dye into the medium, since such application shows a larger effect of bubble elimination and the ultrasonic vibration accelerates dissolution and/or dispersion of the dye into the medium.

Thus the aforementioned step of at least applying the ultrasonic vibration may be executed during or after a step of dissolving and/or dispersing the dye into the medium. Stated differently, the step of at least applying the ultrasonic vibration may be executed, arbitrarily at least once, after the preparation of the ink and before a product is completed.

In an embodiment, it is preferable that the step of dissolving and/or dispersing the dye into the medium includes a step of dissolving the aforementioned dye into a part of the entire medium and a step of mixing the remaining medium, that an ultrasonic vibration is applied in at least either of such steps, and more preferable that at least an ultrasonic vibration is applied in the step of dissolving the aforementioned dye into a part of the entire medium.

The aforementioned step of mixing the remaining medium may be executed in a single step or in plural steps.

It is also preferable, in the preparation of the ink of the invention, to apply degassing under heating or under a reduced pressure, in order to enhance the effect of bubble elimination from the ink. A degassing step under heating or vacuum is preferably executed simultaneous with or after the step of mixing the remaining medium.

For generating ultrasonic wave in the step of applying the ultrasonic vibration, a known apparatus such as an ultrasonic disperser can be utilized.

In the preparation of the ink for ink jet of the invention, a step of eliminating solid dusts by filtration, to be executed after the liquid preparation, is important. For this operation, there is employed a filter, which has an effective pore size of, 1 μm or less, preferably 0.3 to 0.05 μm, particularly preferably 0.3 to 0.25 μm. Filters of various materials can be used for this purpose, but, in case of an ink containing a water-soluble dye, a filter designed for an aqueous solvent is preferable. In particular, a filter prepared with a polymer material, which hardly generates dusts, is preferable. The filtration may be executed by passing the liquid through the filter, and a filtration under pressurizing and a filtration under suction can be utilized.

After the filtration, the solution tends to involve the air. Since bubbles resulting from such air often causes a perturbation in the image in an ink jet recording, a debubbling step as mentioned above is preferably provided separately. Such debubbling can be achieved by various methods, such as letting the solution after the filtration to stand still or by ultrasonic debubbling or vacuum debubbling utilizing commercial apparatuses. An ultrasonic debubbling is preferably executed for 30 seconds to 2 hours, more preferably 5 minutes to 1 hour.

These operations are preferably executed in a space such as a clean room or a clean bench, in order to prevent dust inclusion at the operation. In the invention, these operations are preferably executed in a space of a cleanness of class 1000 or lower. The “cleanness” is a value measured by a dust counter.

In the ink for ink jet of the invention, there may be employed, in suitable amounts, additives such as a drying preventing agent for preventing a clogging of an ink discharge port by drying, a penetration promoting agent for enhancing ink penetration in the paper, an ultraviolet absorbing agent, an antioxidant, a viscosity regulating agent, a surface tension regulating agent, a dispersant, a dispersion stabilizing agent, an antimold agent, an antirusting agent, a pH regulating agent, a defoaming agent, or a chelating agent.

A drying preventing agent to be employed in the invention is preferably a water-soluble organic solvent having a vapor pressure lower than that of water. Specific examples include a polyhydric alcohol such as ethylene glycol, propylene glycol, diethylene glycol, polyethylene glycol, thiodiglycol, dithiodiglycol, 2-methyl-1,3-propanediol, 1,2,6-hexanetriol, an acetylene glycol derivative, glycerin, or trimethylolpropane, a lower alkyl ether of a polyhydric alcohol such as ethylene glycol monomethyl (or ethyl) ether, diethylene glycol monomethyl (or ethyl) ether, or triethylene glycol monoethyl (or butyl) ether, a heterocyclic compound such as 2-pyrrolidone, N-methyl-2-pyrrolidone, 1,3-dimethyl-2-imidazolidinone, or N-methylmorpholine, a sulfur-containing compound such as sulfolane, dimethyl sulfoxide or 3-sulfolene, a polyfunctional compound such as diacetone alcohol or diethanolamine, and an urea derivative. Among these, a polyhydric alcohol such as glycerin or diethylene glycol is more preferable. The aforementioned drying preventing agent may be employed singly or in a combination of two or more kinds. Such drying preventing agent is preferably used in a content of 10 to 50 mass % in the ink.

A penetration promoting agent to be employed in the invention can be an alcohol such as ethanol, isopropanol, butanol, di(tri)ethylene glycol monobutyl ether, or 1,2-hexanetriol, sodium laurylsulfonate, sodium oleate or a nonionic surfactant. Such material provides a sufficient effect in a content of 10 to 30 mass % in the ink, and is preferably used within an extent not causing a blotting of print, or a print-through on the paper.

As an ultraviolet absorber to be employed in the invention for improving the storage property of the image, there can be employed a benzotriazole compound described for example in JP-A Nos. 58-185677, 61-190537, 2-782, 5-197075, and 9-34057, a benzophenone compound described for example in JP-A Nos. 46-2784, 5-194483 and U.S. Pat. No. 3,214,463, a cinnamate compound described for example in JP-B Nos. 48-30492, 56-21141 and JP-A No. 10-88106, a triazine compound described for example in JP-A Nos. 4-298503, 8-53427, 8-239368, 10-182621 and JP-T No. 8-501291, a compound described in Research Disclosure No. 24239, or a compound absorbing ultraviolet light and emitting fluorescence, so-called fluorescent whitening agent represented by stilbene and benzoxazole compounds.

As an antioxidant to be used in the invention for improving storability of the image, there can be employed various antifading agents of organic type and metal complex type. The organic antifading agent includes a hydroquinone, an alkoxyphenol, a dialkoxyphenol, a phenol, an aniline, an amine, an indane, a chroman, an alkoxyaniline, and a heterocyclic compound, and the metal complex includes a nickel complex and a zinc complex. More specifically, there can be employed compounds described in patents cited in Research Disclosure No. 17643, VII, items I to J, No. 15162, No. 18716, page 650, left column, No. 36544, page 527, No. 307105, page 872, and No. 15162, and compounds contained in general formulas of representative compounds and compound examples described in JP-A No. 62-215272, pages 127-137.

An antimold agent to be employed in the invention can be sodium dehydroacetate, sodium benzoate, sodium pyridinethione-1-oxide, ethyl p-hydroxybenzoate, 1,2-benzisotliazolin-3-one and a salt thereof. Such material is preferably used in an mount of 0.02 to 5.0 mass % in the ink.

Details of these materials are described for example in Bokin-bokunzai Jiten (edited by Japan Antibacterial-antimold Society, Dictionary Editing Committee).

Also an antirusting agent can be, for example, an acidic sulfite salt, sodium thiosulfate, ammonium thioglycolate, diisopropylammonium nitrite, tetranitrate pentaerthritol, dicyclohexylammonium nitrite, or benzotriazole. Such material is preferably used in an amount of 0.02 to 5.00 mass % in the ink.

A pH regulating agent employed in the invention can be advantageously used for regulating pH and for providing dispersion stability, and the pH of the ink is preferably regulated at 8 to 11 at 25° C. A pH value less than 8 reduces the solubility of dye thereby tending to cause nozzle clogging, while a pH value exceeding 11 tends to deteriorate the durability. The pH regulating agent can be an organic base or an inorganic alkali as a basic substance, or an organic acid or an inorganic acid as an acidic substance.

The basic compound can be an inorganic compound such as sodium hydroxide, potassium hydroxide, sodium carbonate, potassium carbonate, sodium phosphate, or sodium hydrogencarbonate; or an organic base such as ammonia, methylamine, ethylamine, diethylamine, triethanolamine, ethanolamine, diethanolamine, triethanolamine, ethylenediamine, piperidine, diazacyclooctane, diazacycloundecene, pyridine, quinoline, picoline, lutidine, or corydine.

Also the acidic compound can be an inorganic compound such as hydrochloric acid, sulfuric acid, phosphoric acid, boric acid, sodium hydrogensulfate, potassium hydrogensulfate, potassium dihydrogenphosphate, or sodium dihydrogenphosphate; or an organic acid such as acetic acid, tartaric acid, benzoic acid, trifluoroacetic acid, methanesulfonic acid, ethanesulfonic acid, benzenesulfonic acid, p-toluenesulfonic acid, saccharic acid, phthalic acid, picolinic acid or quinolinic acid.

The ink of the invention has a conductivity within a range of 0.01 to 10 S/m, preferably 0.05 to 5 S/m.

The conductivity can be measured by an electrode method utilizing a commercially available saturated potassium chloride.

The conductivity can be controlled principally by an ion concentration in the aqueous solution. In case of a high salt concentration, salts can be removed by an ultra filtration membrane. Also in case of regulating the conductivity by adding salts or the like, there can be utilized various organic and inorganic salts.

There can be utilized an inorganic compound such as potassium halide, sodium halide, sodium sulfate, potassium sulfate, sodium hydrogensulfate, potassium hydrogensulfate, sodium nitrate, potassium nitrate, sodium hydrogencarbonate, potassium hydrogencarbonate, sodium phosphate, sodium hydrogenphosphate, boric acid, potassium dihydrogenphosphate, or sodium dihydrogenphosphate, or an organic compound such as sodium acetate, potassium acetate, potassium tartarate, sodium tartarate, sodium benzoate, potassium benzoate, sodium p-toluenesulfonate, potassium saccharate, potassium phthalate or sodium picolinate.

The conductivity can also be regulated by selecting components of other additives.

The ink of the invention has a viscosity of 1-20 mPa·s at 25° C., further preferably 2-15 mPa·s and particularly preferably 2-10 mPa·s. A viscosity exceeding 30 mPa·s decreases a fixing speed for a recorded image and deteriorates an ink discharging property. A viscosity less than 1 mPa·s causes a blotting of the recorded image, thereby deteriorating the image quality.

The viscosity can be arbitrarily regulated by an amount of addition of the ink solvent. The ink solvent can be, for example, glycerin, diethylene glycol, triethanolamine, 2-pyrrolidone, diethylene glycol monobutyl ether, or triethylene glycol monobutyl ether.

Also a viscosity regulating agent may be employed. The viscosity regulating agent can be a cellulose a water-soluble polymer such as polyvinyl alcohol, or a nonionic surfactant. It is described in more details, for example in “Viscosity regulating technology” (Gijutsu Joho Kyokai, 1999), Chapter 9, and “Ink jet printer chemicals (98 addition edition), Survey on trend and forecast on material development” (CMC, 1997), pages 162-174.

Measurement of viscosity of a liquid is described in detail in JIS Z8803, and can be easily achieved by a commercially available viscosimeter. In a rotary type, for example, viscosimeters of B type and E type are available from Tokyo Keiki Co. In the invention, the measurement was executed with a vibration type instrument VM-100A-L manufacture by Yamaichi Denki Co. at 25° C. The viscosity is represented by Pascal-sec (Pa·s), usually by milli Pascal-sec (mPa·s).

The ink of the invention has a surface tension, both dynamic surface tension and static surface tension, preferably 20-50 mN/m at 25° C., more preferably 20-40 mN/m. A surface tension exceeding 50 mN/m deteriorates the discharge stability and the image quality for example by a blotting or the like at color mixing. Also a surface tension less than 20 mN/m may result in a printing failure for example by an ink deposition on a surface of the hardware.

For the purpose of regulating the surface tension, the aforementioned cationic, anionic or nonionic surfactant may be added. The surfactant is preferably employed within a range of 0.01 to 20 mass % with respect to the ink for ink jet, more preferably 0.1 to 10 mass %. Also the surfactant may be used in combination of two or more kinds.

The static surface tension can be measured for example by a capillary method, a dripping method, a suspended ring method etc., but a vertical plate method is employed in the present invention.

When a thin glass or platinum plate is suspended vertically and immersed partially in a liquid, the surface tension of the liquid exerts a downward force along a contact portion of the liquid surface and the plate. The surface tension can be measured by balancing such force with an upward force.

Also for measuring the dynamic surface tension, “Shin-Jikken Kagaku Koza, Vol. 18, Interface and Colloids” (published by Maruzen Co., p. 69-90(1977)) describes a vibration jet method, a meniscus drop method, a maximum bubble pressure method etc., and JP-A No. 3-2064 describes a liquid membrane breaking method. The present invention employs, for measuring the dynamic surface tension, a differential bubble pressure method, of which measuring principle and process will be explained in the following.

When a bubble is generated in a uniform solution in agitation, a new gas-liquid interface is generated and surfactant molecules in the solution gather to the liquid surface at a constant speed. By a change in a bubble rate (bubble generating speed) to a lower rate, a larger number of the surfactant molecules gather to the bubble surface, whereby a maximum bubble pressure immediately before a bubble breakage becomes smaller and the maximum bubble pressure (surface tension) can be measured as a function of the bubble rate. In a preferred method for measuring the dynamic surface tension, large and small probes are used for generating bubbles in the solution, and a pressure difference at the maximum bubble pressures of the two probes is measured to calculate the dynamic surface tension.

In the ink of the invention, a non-volatile component is preferably 10 to 70 mass % of the entire ink amount for improving the discharge stability of the ink, the print image quality and the durability properties of the image and for reducing the image blotting and the stickiness after printing, and more preferably 20 to 60 mass % for improving the discharge stability of the ink and for reducing the image blotting after printing.

The non-volatile component means liquid, solid and high molecular weight components having a boiling point of 150° C. or higher under the atmospheric pressure. The non-volatile component in the ink for ink jet recording includes a dye, a high-boiling solvent and other additives according to the necessity, such as a polymer latex, a surfactant, a dye stabilizer, an antimold agent, a buffer and the like, and such non-volatile component often deteriorates the dispersion stability of the ink, except for the dye stabilizer, and also remains on an ink jet image receiving medium even after the printing, thus hindering the stabilization of the dye by association on the image receiving medium and deteriorating the fastness of the image and the image blotting under a high humidity condition.

In the invention, a high molecular compound may also be included. The high molecular compound means all the polymer compounds present in the ink and having a number-averaged molecular weight of 5000 or higher. Such polymer compound can be a water-soluble polymer compound substantially soluble in an aqueous medium, a water-dispersible polymer compound such as a polymer latex or a polymer emulsion, or an alcohol-soluble polymer compound soluble in a polyhydric alcohol employed as an auxiliary solvent, and any substance uniformly soluble or dispersible in the ink liquid is included in the high molecular compound in the invention.

Specific examples of the water-soluble polymer include water-soluble polymers such as polyvinyl alcohol, silanol-denatured polyvinyl alcohol, carboxymethyl cellulose, hydroxyethyl cellulose, polyvinylpyrrolidone, polyalkylene oxide such as polyethylene oxide or polypropylene oxide, or a polyalkylene oxide derivative, natural water-soluble polymers such as polysaccharides, cationated starch, casein or gelatin, an aqueous acrylic resin such as polyacrylic acid, polyacrylamide or copolymers thereof, an aqueous alkyd resin, and water-soluble polymers including —SO₃— or —COO⁻ in the molecule and substantially soluble in an aqueous medium.

Also the polymer latex can be a styrene-butadiene latex, a styrene-acryl latex or a polyurethane latex, and the polymer emulsion can be an acryl emulsion.

Such water-soluble polymer compound can be employed singly or in a combination of two or more kinds.

The water-soluble polymer compound is used, as explained in the foregoing, as a viscosity regulating agent for regulating the ink viscosity within a range of satisfactory discharge property, but a large amount of addition increases the ink viscosity, thus deteriorating the discharge stability of the ink liquid and causing the nozzle clogging by precipitate when the ink is stored over a time.

The polymer compound employed as the viscosity regulating agent is employed in an amount of 0 to 5 mass % of the entire ink amount, preferably 0 to 3 mass % and more preferably 0 to 1 mass %, though dependent on the molecular weight of the added compound (amount becoming smaller for a higher molecular weight).

In the invention, in addition to the surfactant mentioned above, a nonionic, cationic or anionic surfactant is employed as a surface tension regulating agent. Examples include an anionic surfactant such as a fatty acid salt, an alkylsulfonate ester salt, an alkylbenzenesulfonate salt, an alkylnaphthalenesulfonate salt, a dialkylsulfosuccinate salt, an alkylphophate ester salt, a naphthalenesulfonic acid-formaline condensate, or a polyoxyethylenealkylsulfonate ester salt, a nonionic surfactant such as polyoxyethylene alkyl ether, polyoxyethylene alkylallyl ether, a polyoxyethylene fatty acid ester, a sorbitan fatty acid ester, a polyoxyethylenesorbitan fatty acid ester, polyoxyethylene alkylamine, a glycerin fatty acid ester, or an oxyethylene-oxypropylene copolymer. There are also preferably employed Surfynols (Air Products & Chemicals Co.) which are acetylene-type polyoxyethylene oxide surfactants. There is also preferred an amphoteric surfactant such as N,N-dimethyl-N-alkylamine oxide. There can also be employed surfactants described in JP-A No. 59-157,636, pages 37-38, and Research Disclosure No. 308119 (1989).

Also in the invention, there can be utilized, if necessary, the cationic, anionic or nonionic surfactant as a dispersant or a dispersion stabilizer, a fluorinated or silicone compound as a defoaming agent, and a chalating agent represented by EDTA.

[Image Receiving Material]

An image receiving material to be employed in the invention is a recording paper and a recording film, which are reflective media to be explained in the following.

A substrate for a recording paper or a recording film can be constituted of a chemical pulp such as LBKP or NBKP, a mechanical pulp such as GP, PGW, RMP, TMP, CTMP, CMP, or CGP, a recycled pulp such as DIP with known additives such as a pigment, a binder, a sizing agent, a fixing agent, a cationic agent, a paper strengthening agent etc. if necessary and milled in a long screen paper mill or a cylindrical screen paper mill. In addition to such substrate, there can also be employed a synthetic paper or a plastic film sheet, and such substrate preferably has a thickness of 10 to 250 μm and a basis weight of 10 to 250 g/m².

An image receiving material for the ink of the invention may be prepared by providing the substrate with an image receiving layer and a back coat layer, or by providing an image receiving layer and a back coat layer after forming an anchor coat layer with starch or polyvinyl alcohol in a size press. Also the substrate may be subjected to a flattening process by a calendering apparatus, such as a machine calender, a TG calender, or a soft calender.

In the present invention, there is more preferably employed a paper or a plastic film, which is laminated on both surface with polyolefin (such as polyethylene, polystyrene, polybutene or copolymers thereof) or polyethylene terephthalate. The polyolefin is preferably added with a white pigment (such as titanium oxide or zinc oxide) or a coloring dye (such as cobalt blue, Prussian blue or neodymium oxide).

The image receiving layer provided on the substrate contains a porous material and an aqueous binder. Also the image receiving layer preferably includes a pigment, which is preferably a white pigment. Examples of the white pigment include an inorganic white pigment such as calcium carbonate, caolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc oxide, or zinc carbonate, and an organic pigment such as a styrenic pigment, an acrylic pigment, urea resin, or melamine resin. In particular, a porous white inorganic pigment is preferred, and a synthetic amorphous silica with a large pore surface area is particularly preferable. As the synthetic amorphous silica, there can be employed anhydrous silicic acid obtained by a dry (gaseous phase) process or hydrous silicic acid obtained by a wet process.

As a recording paper containing the aforementioned pigment in the image receiving layer, those described in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777 and 2001-301314 may be employed advantageously.

An aqueous binder to be contained in the image receiving layer can be, for example, a water-soluble polymer such as polyvinyl alcohol, silanol-denatured polyvinyl alcohol, starch, caolinated starch, casein, gelatin, carboxymethyl cellulose, hydroxyethyl cellulose, polyvinylpyrrolidone, polyalkylene oxide or a polyalkylene oxide derivative, and a water-dispersible polymer such as styrene-butadiene latex or acryl emulsion. Such aqueous binder may be employed singly or in a combination of two or more kinds. In the invention, polyvinyl alcohol or silanol-denatured polyvinyl alcohol is preferable among these, in consideration of the adhesion property to the pigment and the peeling resistance of the ink receiving layer.

The image receiving layer may contain, in addition to the pigment and the aqueous binder, a mordant, a water resistant agent, a light fastness improving agent, a gas resistance improving agent, a surfactant, a hardening agent and the like.

A mordant to be added in the image receiving layer is preferably immobilized. For this reason, a polymer mordant is preferably employed.

Specific examples of the polymer mordant are described for example in JP-A Nos. 48-28325, 54-74430, 54-124726, 55-22766, 55-142399, 60-23850, 60-23851, 60-23852, 60-23853, 60-57836, 60-60643, 60-118834, 60-122940, 60-122941, 60-122942, 60-235134, 1-161236, U.S. Pat. Nos. 2,484,430, 2,548,564, 3,148,061, 3,309,690, 4,115,124, 4,124,386, 4,193,800, 4,273,853, 4,282,305 and 4,450,224. An image receiving material containing a polymer mordant described in JP-A No. 1-161236, pages 212-215, is particularly preferable. The polymer mordant described in this patent reference provides an image of an excellent image quality and improves the light fastness of the image.

A water resistant agent is effective for rendering the image resistance to water, and a cationic resin is desirable for this purpose. Such cationic resin can be, for example, polyamidepolyamine epichlorohydrin, polyethylenimine, polyaminesulfone, a dimethyldiallylammonium chloride polymer, or cationic polyacrylamide. Such cationic resin is preferably employed in an amount of 1-15 mass % with respect to the total solid of the ink receptive layer, more preferably 3-10 mass %.

Agents for improving the light fastness and the gas resistance can be, for example, a phenol compound, a hindered phenol compound, a thioether compound, a thiourea compound, a thiocyanate compound, an amine compound, a hindered amine compound, a tempo compound, a hydrazine compound, a hydrazide compound, an amidine compound, a vinyl group-containing compound, an ester compound, an amide compound, an ether compound, an alcohol compound, a sulfinic acid compound, a sugar, a water-soluble reducing compound, an organic acid, an inorganic acid, a hydroxyl group-containing organic acid, a benzotriazole compound, a benzophenone compound, a triazine compound, a heterocyclic compound, a water-soluble metal salt, an organometallic compound or a metal complex.

Specific examples of the compounds are described in JP-A Nos. 10-182621, 2001-260519, 2000-260519, JP-B Nos. 4-34953, 4-34513, 4-34512, JP-A Nos. 11-170686, 60-67190, 7-276808, 2000-94829, JP-T No. 8-512258 and JP-A No. 11-321090.

The surfactant functions as an auxiliary coating agent, a peeling improving agent, a lubricant or an antistatic. The surfactant is described in JP-A Nos. 62-173463 and 62-183453.

An organic fluorinated compound may be employed instead of the surfactant. The organic fluorinated compound is preferably hydrophobic. The organic fluorinated compound includes, for example, a fluorinated surfactant, an oily fluorinated compound (such as fluorinated oil), and a solid fluorinated compound (such as tetrafluoroethylene resin). The organic fluorinated compound is described in JP-B No. 57-9053 (columns 8-17) and JP-A Nos. 61-20994 and 62-135826.

As a film hardening agent, there can be employed materials described for example in JP-A No. 1-161236, page 222, JP-A Nos. 9-263036, 10-119423 and 2001-310547.

Other additives added to the image receiving layer include a pigment dispersant, a viscosifier, a defoaming agent, a dye, a fluorescent whitening agent, an antiseptic, a pH regulating agent, a matting agent and a film hardening agent. The ink receiving layer may be constituted of a single layer or two layers.

The recording paper or the recording film may also be provided with a back coating layer, and components that can be added to such back coating layer include a white pigment, an aqueous binder, and other components.

Examples of the white pigment contained in the back coating layer include an inorganic white pigment such as light calcium carbonate, heavy calcium carbonate, caolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo boehmite, aluminum hydroxide, alumina, lithopone, zeolite, hydrated halloycite, magnesium carbonate, or magnesium hydroxide, and an organic pigment such as a styrenic plastic pigment, an acrylic plastic pigment, polyethylene, microcapsules, urea resin, or melamine resin.

An aqueous binder to be contained in the back coating layer can be, for example, a water-soluble polymer such as a styrene/maleate salt copolymer, a styrene/actylate salt copolymer, polyvinyl alcohol, silanol-denatured polyvinyl alcohol, starch, caolinated starch, casein, gelatin, carboxymethyl cellulose, hydroxyethyl cellulose, or polyvinylpyrrolidone, or a water-dispersible polymer such as styrene-butadiene latex or acryl emulsion. Other components that can be contained in the back coating layer include a defoaming agent, an antifoaming agent, a dye, a fluorescent whitening agent, an antiseptic, and a water resistant agent.

A layer (including back coating layer) constituting the ink jet recording paper or the recording film may include a polymer fine particle dispersion. Such polymer fine particle dispersion is used for improvements of film properties, such as stabilization of dimension, curl prevention, prevention of adhesion and prevention of film cracking. The polymer fine particle dispersion is described in JP-A Nos. 62-245258, 62-1316648, and 62-110066. An addition of a polymer fine particle dispersion of a low glass transition temperature (40° C. or lower) to a layer containing mordant allows to prevent cracking or curling of the layer. Also an addition of a polymer fine particle dispersion of a high glass transition temperature to the back allows to prevent curling.

[Ink Jet Recording]

In the invention, a droplet volume of the ink deposited on the recording material is preferably 0.1 to 100 pl, more preferably 0.5 to 50 pl and particularly preferably 2 to 50 pl.

In the invention, the ink jet recording method is not limited, and can be any known method such as a charge control method in which an electrostatic attractive force is utilized for discharging ink, a drop-on-demand method (pressure pulse method) in which an oscillation pressure of a piezo element is utilized, an acoustic ink jet method in which an electrical signal is converted into an acoustic beam which irradiates the ink to discharge the ink by an irradiation pressure, or a thermal ink jet (bubble jet) in which an ink is heated to generate a bubble and a resulting pressure is utilized.

The ink jet recording method includes a method of discharging a plurality of a low-density ink called photo ink with a small volume, a method of improving the image quality utilizing plural inks of a substantially same hue having different densities, and a method of utilizing a colorless transparent ink. The ink droplet volume is controlled principally by a print head.

For example in case of a thermal ink jet method, the droplet volume can be controlled by a structure of the print head. More specifically, a droplet of a desired volume can be formed by changing sizes of an ink chamber, a heating portion and a nozzle. Also in such thermal ink jet method, droplets of plural sizes can be realized by utilizing plural print heads different in the size of the heating portion and the nozzle.

In a drop-on-demand method utilizing a piezo element, the droplet volume can be changed by the structure of the print head as in the thermal ink jet method, but it is also possible, as will be explained later, to form droplets of plural sizes in a print head of a same structure, by controlling a waveform of a drive signal for driving the piezo element.

In the invention, a discharge frequency for discharging droplets to the recording material is preferably 1 kHz or higher.

As shown in the accompanying photograph, it is necessary, in order to record an image of a high image quality, to adopt a droplet density of 600 dpi (number of dots per inch) or higher for the purpose of reproducing an image of a high sharpness with small ink droplets.

On the other hand, in depositing ink droplets with a head having plural nozzles, a number of simultaneously drivable nozzles is tens to about 200 in a recording system in which the recording paper and the head move in mutually perpendicular directions, and is limited to several hundred also in a recording system having a fixed line head. This is because many nozzles cannot be driven simultaneously because of a restriction in the driving electric power and a heat generation in the head affects the formed image. Therefore, a recording with an increased droplet density tends to reduce the recording speed, but the recording speed can be elevated by increasing the drive frequency.

In the thermal ink jet method, the frequency of the droplets can be controlled by a frequency control of a drive signal for heating the head.

In the piezo ink jet method, the frequency can be controlled by a frequency control of a drive signal for driving the piezo element.

Now the driving of a piezo head will be explained. Based on an image signal to be printed, a printer control unit determines a droplet size, a droplet speed and a droplet frequency and prepares a piezo driving signal, which is supplied to the print head. The piezo driving signal controls a droplet size, a droplet speed and a droplet frequency. The droplet size and the droplet speed are determined by a shape and an amplitude of the driving waveform, and the frequency is determined by a repeating cycle of the signal.

When the droplet frequency is set at 10 kHz, the head is driven at every 100 microseconds, and a recording of a line is completed in 400 microseconds. A moving speed of the recording paper by 1/600 inch, or about 42 microns, per 400 microseconds realizes a printing at a rate of one sheet in every 1.2 seconds.

As to a printing apparatus or a printer utilizing the ink of the invention, a structure as shown in JP-A No. 11-170527 is preferable. Also as to a cartridge, a structure as shown in JP-A No. 5-229133 is preferable. As to a suction and a cap or the like employed for covering a print head 28, a structure as shown in JP-A No. 7-276671 is preferable. It is also preferable to provide, in the vicinity of the head, a filter for eliminating bubbles as shown in JP-A No. 9-277552.

Also the nozzle surface is preferably subjected to a water repellent treatment as described in Japanese Patent Application No. 2001-16738. Such structures may be applied to a printer connected to a computer, or an apparatus specifically designed for printing a photograph.

The ink for ink jet of the invention preferably has an average droplet speed, at the discharge to the recording material, of 2 m/sec or higher, preferably 5 m/sec or higher.

The droplet speed can be controlled by a control of a shape and an amplitude of the head driving waveform.

Also by utilizing plural driving waveforms, it is possible to obtain droplets of plural sizes in a same head.

[Application of Ink Jet]

The ink of the invention for ink jet may also be utilized for an application other than ink jet recording. It can be used for example as a material for an image display, a material for forming an image for indoor decoration, and a material for forming an image for outdoor decoration.

An image display material includes a poster, a wallpaper, a decorative article (ornament or doll), a commercial advertising pamphlet, a packaging paper, a wrapping material, a paper bag, a plastic bag, a packaging material, a sign board, an image drawn or attached on a side wall of a traffic vehicle (automobile, bus or train), clothes with a logo, etc. In case the dye of the invention is used as a material for forming a display image, such image includes all the patterns recognizable by human being, not only an image of narrow sense, but also an abstract design, a character, a geometrical pattern etc.

An indoor decoration material includes a wallpaper, a decorative article (ornament or doll), a component of an illuminating instrument, a component of a furniture, a design component of a floor or a ceiling, etc. In case the dye of the invention is used as a material for indoor decoration, such image includes all the patterns recognizable by human being, not only an image of narrow sense, but also an abstract design, a character, a geometrical pattern etc.

An outdoor decoration material includes a wall material, a roofing material, a sign board, a gardening material, an outdoor decorative article (ornament or doll), a component of an illuminating instrument etc. In case the dye of the invention is used as a material for outdoor decoration, such image includes all the patterns recognizable by human being, not only an image of narrow sense, but also an abstract design, a character, a geometrical pattern etc.

In these applications, media on which a pattern is formed include paper, fiber, cloth (including non-woven cloth), plastics, metal, ceramics etc. The dyeing can be achieved by mordanting, pattern dyeing or by fixing the dye in the form of a reactive dye by introducing a reactive group. Among these, dyeing by mordanting is preferable.

### EXAMPLES

In the following, the present invention will be explained by examples, but the invention is not limited by such examples.

### Example 1

Deionized water of a resistance of 18 megaΩ or higher was added to following components to make 1 liter, and was agitated for 1 hour under heating at 30-40° C. Then the mixture was filtered under a reduced pressure with a microfilter of an average pore size of 0.25 μm to obtain a magenta ink M-101.

[Formulation of Magenta Ink LM-101]

| (solids) | | |
|---|---|---|
| following magenta dye A | 30 | g/l |
| urea (UR) | 30 | g/l |
| benzotriazole (BTZ) | 0.08 | g/l |
| PROXEL XL2 (PXL) | 3.5 | g/l |
| (liquid components) | | |
| triethylene glycol (TEG) | 120 | g/l |
| glycerin (GR) | 150 | g/l |
| triethylene glycol monobutyl ether (TGB) | 130 | g/l |
| 2-pyrrolidone (PRD) | 60 | g/l |
| triethanol amine (TEA) | 7 | g/l |
| Surfynol STG (SW) | 10 | g/l |

A

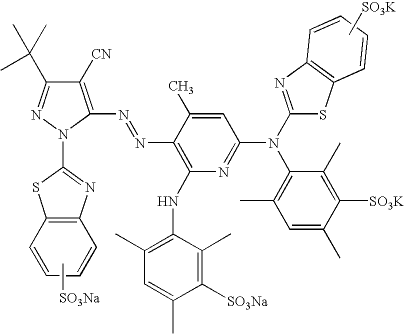

The aforementioned dye of the invention, when subjected to a potential measurement in a 1 mmol/l aqueous solution by a polarograph of mercury electrode method, showed a potential of 1.2 V higher than that of SCE.

Also inks M-102 to 107 were prepared of a same composition except for the addition of following additives.

TABLE 1

| Ink | Additive |
|---|---|
| M-101 (Comp. Ex.) | none |
| M-102 (Comp. Ex.) | tetraburylammonium chloride 30 g/l |
| M-103 (Comp. Ex.) | gelatin 30 g/l |
| M-104 (Invention) | polyallylamine 30 g/l |
| M-105 (Invention) | polyvinylimidazole 30 g/l |
| M-106 (Invention) | polydimethyldiallylammonium chloride 30 g/l |
| M-107 (Invention) | following polymer A 30 g/l |

Polymer A

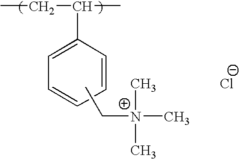

Each ink, filled in a cartridge for black ink of an EPSON ink jet printer CL-760C, was used to print an image pattern with stepwise changed densities with a magenta single color, and a magenta image containing 24-point white characters “fuji shashin film”. An ink jet photo luster paper “Kassai” manufactured by Fuji Photo Film Co. Ltd. was used as an image receiving sheet to print an image, and was subjected to evaluations of an image storability, an ozone resistance and a water resistance.

(Evaluation Test)

<Evaluation of Ozone Resistance>

Ozone resistance was evaluated by causing a sample to stand in a box set at an ozone gas concentration of 5 ppm for 5 days, measuring the image density of the pattern S before and after the standing in the ozone gas with a reflective densitometer X-Rite 310 and determining a dye remaining rate.

The ozone gas concentration in the box was set with an ozone gas monitor (model OZG-EM-01, manufactured by APPLICS Co.).

The result was evaluated as A in case the magenta dye remaining rate was 90% or higher, B in case the dye remaining rate was 80-90%, and C in case the dye remaining was less than 80%.

<Evaluation of Water Resistance>

The water resistance of the image was evaluated by printing the aforementioned image patterns on a plain paper, then immersing the printed sample in water for 30 seconds and evaluating a perturbation on the image when the sample was taken out.

A sample in which the characters became illegible by blotting was classified as C, a sample showing significant blotting though the characters were legible was classified as B, and a sample which showed no perturbation of the image with clear characters even after water immesion was classified as A.

Results of evaluation are shown in the following table.

TABLE 2

| No. | ozone resistance | water resistance |
|---|---|---|
| M-101 (Comp. Ex.) | B | C |
| M-102 (Comp. Ex.) | B | B |
| M-103 (Comp. Ex.) | B | C |
| M-104 (Invention) | A | A |
| M-105 (Invention) | A | A |
| M-106 (Invention) | A | A |
| M-107 (Invention) | A | A |

As shown in Table 2, an improvement in the ozone resistance was not obtained in case of employing a water-soluble compound having an anionic dissociable group as the dye and (1) not adding additives (M-101), (2) adding a quaternary ammonium salt (M-102) and (3) adding a nonionic additive (M-103).

On the other hand, an image with a satisfactory ozone resistance could be obtained in case of (4) adding a polymer having an amino group (M-104), (5) adding a polymer having an imidazole group (M-105), (6) adding a polymer having a quaternary ammonium salt (M-106, M-107).

### INDUSTRIAL APPLICABILITY

The present invention can provide an ink for ink jet, a method for producing an ink for ink jet, an ink set for ink jet, and an ink jet recording method, showing an excellent ozone resistance and not easily causing a blotting when wetted with water after a printing on a plain paper.

The entire disclosure of each and every foreign patent application from which the benefit of foreign priority has been claimed in the present application is incorporated herein by reference, as if fully set forth.

1. An ink for ink jet comprising:
a water-soluble dye having an anionic dissociable group;
at least one of water and a water-soluble organic solvent; and
at least one kind of cationic polymer capable of forming an ion pair with the anionic dissociable group.

2. An ink for ink jet according to claim 1, wherein the cationic polymer is a water-soluble polymer.

3. A method for producing an ink for ink jet, the method comprising:
mixing in advance: a water-soluble dye having an anionic dissociable group; and at least one cationic polymer capable of forming an ion pair with the anionic dissociable group, in water, to form a resulting salt; and
preparing the ink after desalting the resulting salt.

4. An ink for ink jet according to claim 1, wherein the ink is provided by:
mixing in advance: said at least one kind of cationic polymer; and the water-soluble dye having the anionic dissociable group, in water, to form a resulting salt; and
preparing the ink after desalting the resulting salt.

5. An ink for ink jet according to claim 1,
wherein said at least one kind of cationic polymer has a cation derived from a nitrogen atom.

6. An ink for ink jet according to claim 1, wherein the water-soluble dye comprises at least one of compounds represented by general formulas (1) to (4):
(A₁₁-N═N—B₁₁)ₙ-L general formula (1)
in the general formula (1), A₁₁ and B₁₁ each independently represents a heterocyclic group that may be substituted; n represents 1 or 2; L represents a substituent bonded in an arbitrary position with one of A₁₁ and B₁₁, and represents a hydrogen atom in case n=1, a single bond or a divalent connecting group in case n=2; 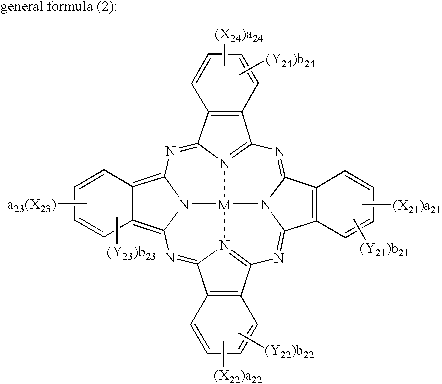
In the general formula (2), X₂₁, X₂₂, X₂₃ and X₂₄ each independently represents —SO-Z₂, —SO₂-Z₂, —SO₂NR₂₁R₂₂, a sulfo group, —CONR₂₁R₂₂, or —COOR₂₁; Z₂ each independently represents a substituted or non-substituted alkyl group, a substituted or non-substituted cycloalkyl group, a substituted or non-substituted alkenyl group, a substituted or non-substituted aralkyl group, a substituted or non-substituted aryl group or a substituted or non-substituted heterocyclic group; and R₂₁ and R₂₂ each independently represents a hydrogen atom, a substituted or non-substituted alkyl group, a substituted or non-substituted cycloalkyl group, a substituted or non-substituted alkenyl group, a substituted or non-substituted aralkyl group, a substituted or non-substituted aryl group or a substituted or non-substituted heterocyclic group;
Y₂₁, Y₂₂, Y₂₃ and Y₂₄ each independently represents a monovalent substituent;
a₂₁ to a₂₄ and b₂₁ to b₂₄ represent numbers of substituents respectively on X₂₁ to X₂₄ and Y₂₁ to Y₂₄; a₂₁ to a₂₄ each independently represents a number of 0 to 4, and at least one of a₂₁ to a₂₄ is not zero; b₂₁ to b₂₄ each independently represents a number of 0 to 4; and, in case any of a₂₁ to a₂₄ and b₂₁ to b₂₄ represents a number equal to or larger than 2, plural ones in X₂₁ to X₂₄ and Y₂₁ to Y₂₄ may be mutually same or different;
M represents a hydrogen atom, a metal atom, an oxide of the metal atom, a hydroxide of the metal atom, or a halide of the metal atom; 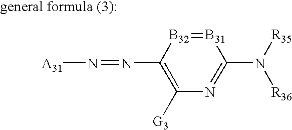
in the general formula (3), A₃₁, represents a 5-membered heterocyclic ring;
B₃₁ and B₃₂ each represents ═CR₃₁— or —CR₃₂═, or either one represents a nitrogen atom while the other one represents ═CR₃₁— or —CR₃₂═;
R₃₅ and R₃₆ each independently represents a hydrogen atom, an aliphatic group, an aromatic group, a heterocyclic group, an acyl group, an alkoxycarbonyl group, an aryloxycarbonyl group, a carbamoyl group, an alkyl- or arylsulfonyl group, or a sulfamoyl group, each of which may further have a substituent;
G₃, R₃₁ and R₃₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including an arylamino group and a heterocyclic amino group), an acylamino group, an ureido group, a sulfamoylamino group, an alkoxycarbonylamino group, an aryloxycarbonylamino group, an alkyl- or aryl sulfonylamino group, a heterocyclic sulfonylamino group, a nitro group, an alkyl- or arylthio group, an alkyl- or arylsulfonyl group, a heterocyclic sulfonyl group, an alkyl- or arylsulfinyl group, a heterocyclic sulfinyl group, a sulfamoyl group, a sulfo group or a heterocyclic thio group, each of which may be further substituted;
R₃₁ and R₃₅, or R₃₅ and R₃₆ may be bonded to form a 5- or 6-membered ring; and
A₄₁-N═N—B₄₁—N═N—C₄₁ general formula (4)
in the general formula (4), A₄₁, B₄₁ and C₄₁ each independently represents an aromatic group or a heterocyclic group, each of which may be further substituted.

7. An ink for ink jet according to claim 1, wherein the dye represented by the general formula (2) is a dye represented by general formula (5): 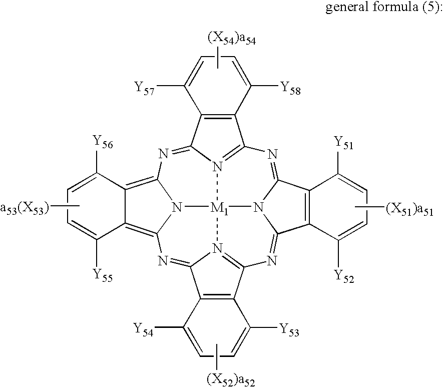
in the general formula (5), X₅₁ to X₅₄, Y₅₁ to Y₅₈ and M₁ respectively have same meanings as X₂₁ to X₂₄, Y₂₁ to Y₂₄ and M in the general formula (2); and a₄₁ to a₅₄ each independently represents an integer 1 or 2.

8. An ink set for ink jet comprising an ink according to claim 1.

9. An ink jet recording method comprising executing an image recording on one of a plain paper and an ink jet exclusive paper with an ink jet printer by using at least one of: an ink according to claim 1; and an ink set for ink jet according to claim 8.

10. An ink jet recording method comprising executing an image recording on one of a plain paper and an ink jet exclusive paper with an ink jet printer by using an ink set for ink jet according to claim 8.
